(19) United States
(12) Patent Application Publication
(10) Pub. No.: US 2022/0304358 A1
(43) Pub. Date: Sep. 29, 2022

(54) Fasting Mimicking Diet

(71) Applicant: L-NUTRA INC., Plano, TX (US)

(72) Inventors: Valter D. Longo, Plano, TX (US); William Hsu, Plano, TX (US); Joseph Antoun, Plano, TX (US); Fabrizio Schirano, Plano, TX (US)

(73) Assignee: L-Nutra Inc., Plano, TX (US)

(21) Appl. No.: 17/646,718

(22) Filed: Dec. 31, 2021

Related U.S. Application Data
(63) Continuation-in-part of application No. 15/432,803, filed on Feb. 14, 2017, now Pat. No. 11,284,640.
Application No. 15/432,803 is a continuation-in-part of application No. 17/009,382, filed on Sep. 1, 2020.

(51) Int. Cl. A23L 33/00; A23L 25/00; A23L 23/00; A23L 33/12; A23F 3/40; A23L 33/105; A23L 33/155; A23L 33/16; A23L 19/00

(52) U.S. Cl. CPC A23L 33/30; A23L 25/20; A23L 23/00; A23L 33/12; A23F 3/405; A23L 33/105; A23L 33/155; A23L 33/16; A23L 19/00; A23V 2002/00

(57) ABSTRACT

A fasting mimicking diet package providing breakfast, lunch, and dinner meal portions for consumption during a one-day or single day fast. The one-day fasting mimicking diet package includes breakfast, lunch, and dinner meal portions for the one-day fast. The FMD package includes a breakfast meal portion having a first nut-containing nutrition bar composition, a micronutritional vegetable powder composition including vitamin and mineral supplements, an algal oil composition, a lunch meal portion that incorporates a first soup composition and a kale cracker composition, and a dinner meal portion having a second soup composition, one of either the kale cracker composition or an olive containing composition, and a second nut containing nutrition bar composition.

### PRIORITY

Priority is claimed to U.S. patent application Ser. No. 17/009,382, filed Sep. 1, 2020 and granted as U.S. Pat. No. ______ on ______, and to U.S. patent application Ser. No. 15/432,803, filed Feb. 14, 2017, and granted as U.S. Pat. No. ______ on ______, each of which is incorporated by reference herein in their entirety.

### TECHNICAL FIELD

The present invention, in general, relates to compositions that mimic fasting while still providing nutrients to a subject.

### BACKGROUND

Recently, fasting mimicking diets have been found to provide a number of health benefits. For example, fasting mimicking diets (FMDs) have been found to be useful in alleviating symptoms of chemotherapy, diabetes, hypertension, and metabolic syndrome. Such fasting mimicking diets have also been found useful to promote regeneration, apoptosis of senescent cells, and other therapeutic benefits. Many categories of fasting type diets have become popular. These include generally behavioral fasting, physiologic fasting, molecular or cellular fasting, and combinations thereof.

Behavioral fasting requires no consumption of food and nutrients, but often may include water consumption. Behavioral fasting can have harmful effects on a subject that result from loss of nutrition, which among other issues, may result in loss of lean muscle mass and bone density, and other possibly detrimental effects.

Physiologic fasting involves attempts to simulate fasting by adjusting food intake to restrict carbohydrates, which induces ketosis in the body. This is accomplished by limiting carbohydrate intake, while consuming protein and high amounts of fat. Ketosis is a metabolic state characterized by elevated levels of ketone bodies in the blood or urine (1). Physiologic ketosis results from low glucose availability, which occurs when carbohydrates are limited.

Ketones are always present in blood, and levels of Ketones increase when glucose reserves are low, which signals the liver to shift from metabolizing primarily carbohydrates to metabolizing fatty acids (2). When the liver begins to metabolize fatty acids into acetyl-Coenzyme A, and some acetyl-CoA molecules are converted into ketone bodies that include acetoacetate, beta-hydroxybutyrate, and acetone (2, 3).

These ketone bodies thereafter function as an energy source that replaces the lowered and/or unavailable glucose that is usually derived from carbohydrates (4). The ketone bodies are released from the liver and into the blood for use by peripheral tissues including the brain (3). Some refer to such physiologic fasting, which is based upon ketosis resulting from low-carbohydrate, high-fat, and moderate protein food consumption, as a ketogenic or keto diet. However, such physiologic fasting is not actual fasting, because if too much protein is consumed, gluconeogenesis occurs and cells will recognize the protein as nutrient, and will not enter a fasting state (5, 6, 7).

The third general type of fasting is known as molecular and/or cellular fasting. This provides a precisely engineered nutrient profile to sustain the body during a prolonged fast of one or more days. Such cellular molecular fasting provides nutrients to a subject to prevent loss of muscle and bone mass, but which constrains such nutrients to levels that are undetected by cells of a subject such that cellular molecular fasting is induced. The FMD is based upon this approach, and includes many variations that enable the many therapeutic benefits that result from time restricted, intermittent fasting, without the potentially undesired discomfort or detrimental loss of bone density or lean muscle mass (6, 7, 50, 51, 52).

Metabolic syndrome is defined by co-occurrence of 3 out of 5 of the following conditions: abdominal obesity, elevated fasting glucose, elevated blood pressure, high serum triglycerides, and low levels of high-density cholesterol (HDL) (8). Affecting 47 million Americans (9), it is associated with a major increase in the risk of cardiovascular disease, and all-cause mortality (10). Although prolonged fasting or very low calorie fasting-mimicking diets (FMDs) can ameliorate the incidence of diseases such as cancer and multiple sclerosis in mice (11-13), randomized trials to assess fasting's ability to reduce risk factors for aging and major age-related diseases have not been carried out (14-16). Prolonged fasting, in which only water is consumed for 2 or more days, reduces pro-growth signaling and activates cellular protection mechanisms in organisms ranging from single cell yeast to mammals (17). This is achieved in part by temporarily reducing glucose and circulating insulin-like growth factor 1 (IGF-1), a hormone well-studied for its role in metabolism, growth, and development, as well as for its association with aging and cancer (18-23). In fact, severe growth hormone receptor and IGF-1 deficiencies are associated with a reduced risk of cancer, diabetes and overall mortality in humans (24, 25).

Mice fed periodically with the FMD show extended health-span and multi-system regeneration, reduced inflammation and cancer incidence, and enhanced cognitive performance (12). Despite its potential for disease prevention and treatment, prolonged fasting is difficult to implement in human subjects and may exacerbate pre-existing nutritional deficiencies, making it not feasible and/or safe for children, the elderly, frail individuals, and even for the majority of healthy adults.

Accordingly, there is a need for the development of additional diet protocols that may be useful in treating human diseases.

### SUMMARY

Against this prior art background, a fasting mimicking diet (hereafter “FMD”) is provided. The FMD molecular and/or cellular fasting products and methods are enabled by a precisely engineered nutrient profile that sustains the body during such fasting, which prevents loss of muscle and bone mass, over any duration of fasting contemplated herein.

These novel molecular cellular fasting products enable a subject to benefit from a single day fast and/or an intermittent fast accomplished during a 24-hour period of time. FMDs that incorporate such precision engineered products that have the predetermined nutrient profiles disclosed herein, enable time-restricted and/or intermittent fasts over the 24-hour time period, as well as during fasts performed over hourly, daily, weekly, and other time periods.

Such a precision engineered FMD-supplied profile of carbohydrates, protein, fats, and nutrients are precisely adjusted to predetermined ratios and levels. These ratios and levels as described in detail elsewhere herein are engineered to fall below the detection threshold of the nutrient sensors in the cells. This causes the cells to enter into a true fasting state that is nearly identical to when they are exposed to a water only, behavioral type of fast. The precise formulation of specific ratios and levels of carbohydrates, protein, fats, and nutrients establishes the precision engineered food constituents provided by the FMD and FMD portions and packages, which enables sustainable molecular and/or cellular fasting without detrimental consequences.

The fasting mimicking diet (FMD) is found to be more practical and safer than fasting while providing ingredients at levels expected to enhance the effects of fasting to affect markers or risk factors for aging and diseases. The FMD is based on a diet previously tested in animals and designed to achieve effects similar to those caused by fasting on IGF-1, IGFBP1, glucose, and ketone bodies but not restricted to those (24). To prevent nutrient deficiency, the FMD provides between 3000 kilojoules (hereafter “kJ”) and 4600 kJ per day, as well as high micronutrient nourishment, to each human subject (12). The safety and feasibility of this intervention had been previously evaluated in 19 study participants who consumed 3 monthly cycles of this type of FMD lasting 5 days each (12).

In an embodiment, a fasting mimicking diet package providing daily meal portions for a predetermined number of days is provided. The fasting mimicking diet package includes a kale cracker composition, a first vegetable broth composition, a mushroom soup composition, a tomato soup composition, a quinoa-containing minestrone soup composition, a bean-containing minestrone soup composition, and a pumpkin soup composition. Characteristically, the daily meal portions are packaged into meal servings or into a total daily serving to be divided into meals.

In another embodiment, another fasting mimicking diet package providing daily meal portions for a predetermined number of days is provided. The fasting mimicking diet package includes a nut-containing nutrition bar, a cocoa-containing nutrition bar, a first olive-containing composition, a kale cracker composition, a vegetable soup composition, and a first vegetable broth composition, a tea composition that includes spearmint, an energy drink composition, a micronutritional composition, and an algal oil composition. Characteristically, the daily meal portions are packaged into meal servings or into a total daily serving to be divided into meals.

An additionally contemplated fasting mimicking diet package provides a one-day FMD that includes three meal portions to be consumed over a single day period of fasting. In one arrangement the FMD package includes breakfast, lunch and dinner meal portions. The breakfast meal portion includes a nut containing nutrition bar composition, two micronutritional vegetable powder with vitamin and mineral supplements, and two algal oil composition nutritional supplements. The lunch meal portion includes a soup composition and a kale cracker composition. The dinner meal portion that completes the one-day FMD package includes another soup composition, an olive containing composition, and ½ of another nutrition bar composition.

At least one of the breakfast, lunch, and dinner meal portions may also optionally include an energy drink composition and a tea composition that includes spearmint, hibiscus, and/or lemon or other constituents. Another variation may include alternative nutrition bars and/or soups as described elsewhere herein.

Advantageously, the fasting mimicking diet packages set forth herein can be used to alleviate symptoms of chemotherapy, promote cell regeneration, alleviate symptoms of aging, treat or prevent diabetes, treat or prevent metabolic disorder, treat or prevent hypertension, induce senescent cell apoptosis, and help prevent cancer when administered to a subject identified has having symptoms of these ailments.

### DRAWINGS

FIG. 1A is a schematic illustration of a fasting mimicking diet package.

FIG. 1B. Consort Diagram. Consort Diagram of 102 contacted subjects of which 100 were enrolled into the study two arms. Arm 1 (N=48), the “Control” group, maintained their normal caloric intake for a three months monitoring period. Data were collected at enrollment and again after 3 months. Participants in arm 2 (N=52) started the fasting-mimicking diet (FMD) after randomization. The FMD is provided for 5 days/month for 3 consecutive cycles. Data were collected at enrollment, immediately after completion of the 1^{st} FMD cycle but before resuming normal dietary intake, and on average 5 days after subjects resumed their normal diet after the final FMD cycle. After the initial 3 month period, subjects in arm 1 then also started the FMD. An optional follow-up visit in the clinic for analysis was offered to all participants approximately 3 months after the completion of the third FMD cycle.

FIGS. 2A, 2B, 2C, 2D, 2E, 2F, 2G, 2H, 2I, 2J, 2K, 2L, 2M, 2N, and 20. Change analysis of metabolic variables during the randomization. Effects on aging/disease markers and risk factors in all subjects that completed the randomized analysis in either the control arm or in the FMD arm (5-7 days after the third cycle of FMD). The A change represents a comparison to baseline. All data are presented as mean±SD. Between-arm comparisons were calculated using two-tailed two-sample equal variance t-tests. For some of the 100 enrolled participants, the nurses were unable to collect all the samples/measurements from all subjects. We therefore excluded subjects with incomplete measurements from a particular marker group. See Table 2 for details.

FIGS. 3A, 3B, 3C, 3D, 3E, 3F, 3G, 3H, 3I, and 3J. Post-hoc analysis of metabolic variables in subgroups identified by severity of risk factors. Subjects from both study arms who completed three FMD cycles were post-hoc stratified based on being either in normal-risk or at-risk subgroups for factors associated with age-related diseases and conditions. The A change shown represents comparisons to baseline. All data are presented as mean±SD. Between-arm comparisons were calculated using two-tailed two-sample equal variance t-tests. One-way analysis of variance was used for the BMI groups. See Table 4 for details.

FIG. 4. Subject self-reported adverse effects based on Common Terminology Criteria for Adverse Effects.

FIG. 5. Comparison of participants that completed the trial vs. dropouts.

FIGS. 6A through 6J. Baseline to 3 months before/after comparison of individual subjects in the control cohort and all subjects that completed the FMD.

FIGS. 7A through 7H. Nutritional Information of nutritional bar constituents of the Fasting Mimicking Diet.

FIG. 8 is Table 1, which provides the baseline characteristics of the Subjects.

FIG. 9 is Table 2, which provides study arm-specific biomarkers of adherence and changes in risk factors.

FIG. 10 is Table 3, which provides comparisons of changes in risk factors by baseline subgroups.

FIG. 11 is Table 4, which provides post hoc analysis of risk factors for age-related diseases and conditions, diabetes and cardio-vascular disease in at-risk subjects.

FIG. 12 is Table 5, which provides a Complete Metabolic Panel.

FIGS. 13A and 13B are Table 6 which provides Arm-specific Markers of Adherence and Changes in Risk factors, including Arm 1 after Cross-over to FMD, and Summary of FMD Arm 1 and 2.

FIG. 14 is Table 7, which provides Changes in Risk factors and Metabolic markers of Adherence after the first FMD.

FIG. 15 is Table 8, which provides Changes in Risk factors and Metabolic markers of Adherence 3 months after Intervention.

FIG. 16 is another illustration of a one-day fasting mimicking diet package.

FIGS. 17A through 17G. Nutritional Information of nut containing nutritional bar compositions of the Fasting Mimicking Diet providing alternative variations of FIG. 7E.

FIG. 18 illustrates Nutritional Information of micronutritional vegetable powder with vitamin and mineral supplements of the FMD, which are modified from that of FIG. 7H.

FIG. 19 depicts a variation of the FMD algal oil composition nutritional supplement of FIG. 7G.

FIG. 20 provides Nutritional Information for a modified kale cracker composition of the FMD, similar to that of FIG. 7F.

FIGS. 21A through 21I. Nutritional Information of soup composition constituents of the Fasting Mimicking Diet providing alternative variations of the soup compositions of FIGS. 7A, 7B, and 7C.

FIGS. 22 and 23 show Nutritional Information for olive containing compositions of the FMD.

FIG. 24 provides examples of tea composition that include spearmint, hibiscus, and/or lemon or other constituents.

FIGS. 25 and 26 depict Nutritional Information of energy drink compositions of the FMD, as alternative examples of that shown in FIG. 7D.

FIG. 27 is a table of results of a one-day fast meal plan protocol directed to test subjects consuming an FMD breakfast, lunch, and dinner, for a single day, and being tested at predetermined times to measure their respective blood glucose and ketone levels.

FIG. 28 reflects average blood ketone level measurements of test subjects at predetermined, selected times during the one-day fast protocol of FIG. 27.

FIG. 29 shows average blood glucose level measurements of the same test subjects of FIGS. 26 and 27 and at the same selected times.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The term “subject” refers to a human or animal, including all mammals such as primates (particularly higher primates), sheep, dog, rodents (e.g., mouse or rat), guinea pig, goat, pig, cat, rabbit, and cow.

The term “fasting mimicking and enhancing diet” means a diet that mimics the effects of fasting typically by providing a subject with at most 50-75% of their normal caloric intake, but with a nutritional component so that fasting is mimicked while a subject is not completely starved. However, if the fasting mimicking diet composition is maintained, based on our current and previous findings, partial disease prevention and treatment effects are anticipated even if 100% of the normal caloric intake is provided to subjects. The term “fasting mimicking and enhancing diet” is sometimes simply referred to as a “fasting mimicking diet.”

Typically, such a fasting mimicking diet is ketogenic since it causes an increase in ketone bodies and stimulates ketone body-based metabolism, so it can also be referred to as a ketogenic FMD. In particular and among other benefits, FMD affects IGF-1, AKT and TOR signaling by regulation of growth hormone signaling upstream of IGF-1. It also affects the levels of glucose, the release of insulin, and the levels of the hunger hormone leptin. Low levels of IGF-1, leptin, insulin, and glucose, and higher levels of ketone bodies and IGFBP1 cooperate to promote the beneficial effects of the FMD.

Examples of useful fasting mimicking and enhancing diets and methods for monitoring the effects of these diets on markers such as IGF-1 and IGFBP1 in the context of the present invention are set forth in U.S. patent application Ser. No. 14/273,946 filed May 9, 2014; Ser. No. 14/497,752 filed Sep. 26, 2014; Ser. No. 12/910,508 filed Oct. 22, 2010; Ser. No. 13/643,673 filed Oct. 26, 2012; Ser. No. 13/982,307 filed Jul. 29, 2013; Ser. No. 14/060,494 filed Oct. 22, 2013; Ser. No. 14/178,953 filed Feb. 12, 2014; Ser. No. 14/320,996 filed Jul. 1, 2014; Ser. No. 14/671,622 filed Mar. 27, 2015; the entire disclosure of these patent applications is hereby incorporated by reference. The fasting mimicking diet set forth in U.S. patent application Ser. Nos. 14/060,494 and 14/178,953 are found to be particularly useful in the present invention.

Additionally informative examples of FMD diets are also found in U.S. patent application Ser. No. 15/148,251 and WIPO Pub. No. WO2011/050302 and WIPO Pub. No. WO2011/050302; the entire disclosures of which are hereby incorporated by reference.

In an embodiment of the present invention, a diet package for administering a fasting mimicking diet is provides. The fasting mimicking diet package provides daily meal portions for a predetermined number of days. Typically, the predetermined number of days is from 1 to 10 days (i.e., 1, 2, 3, 4, 5, 6, 7, 8, 9, or 10 days). In a particularly useful variation, the predetermined number of days is 5 or 6 days. In some variations, the fasting mimicking diets set forth herein provide a subject at most, in increasing order of preference, 75%, 50%, 40%, 30%, or 10% of the subject's normal caloric intake or the daily recommended caloric intake for a subject. In a refinement, the fasting mimicking diet provides at least, in increasing order of preference, 5%, 10%, or 20% of the subject's normal caloric intake or the daily recommended caloric intake for a subject.

However, if the fasting mimicking diet composition is maintained, based on our current and previous findings, partial disease prevention and treatment effects are anticipated even if 100% of the normal caloric intake is provided to subjects. The subject's normal caloric intake is the number of kilocalories (hereafter “kcal”) that the subject consumes to maintain his/her weight. The subject's normal caloric intake may be estimated by interviewing the subject or by consideration of a subject's weight. As a rough guide, subject's normal caloric intake is on average 2600 kcal/day for men and 1850 kcal/day for women. In certain instances, the fasting mimicking diet provides the subject with 700 to 1200 kcal/day. In a particularly useful refinement, the fasting mimicking diet provides a male subject of average weight with about 1100 kcal/day and a female subject of average weight with 900 kcal/day. In some variation, the diet from the diet package is administered on consecutive days. In another variation, the daily meal portions provided for only one day a week for at least a month.

In one embodiment, the fasting mimicking diet package provides daily meal portions for a predetermined number of days as set forth above. The fasting mimicking diet package includes a kale cracker composition, a first vegetable broth composition, a mushroom soup composition, a tomato soup composition, a quinoa-containing minestrone soup composition, a bean-containing minestrone soup composition, and a pumpkin soup composition. Characteristically, the daily meal portions are packaged into meal servings or into a total daily serving to be divided into meals. In a refinement, the fasting mimicking diet package further includes a nut-containing nutrition bar, a cocoa-containing nutrition bar, a first olive-containing composition, a first vegetable broth composition, a tea composition that includes spearmint, an energy drink composition, a micronutritional composition, and an algal oil composition. In a further refinement, the fasting mimicking diet package further includes a second olive-containing composition, a second vegetable broth composition, a tea composition that includes spearmint and lemon, and a tea composition that includes hibiscus.

In a variation of the embodiments set forth above, the fasting mimicking diet package includes daily meal portions that provide less than 40 grams of sugar for day 1, less than 30 grams of sugar for days 2 to 5 and any remaining days, less than 28 grams of protein for day 1, less than 18 grams of protein for days 2 to 5 and any remaining days, 20-30 grams of monounsaturated fats or more to reach the desired caloric intake (i.e., a predetermined caloric intake) for day 1, 6-10 grams of polyunsaturated fats or more to reach the desired caloric intake for day 1, 2-12 grams of saturated fats or more to reach the desired caloric intake for day 1, 10-15 grams of monounsaturated fats or more to reach the desired caloric intake for days 2 to 5 and any remaining days, 3-5 grams of polyunsaturated fats or more to reach the desired caloric intake for days 2 to 5 and any remaining days, 1-6 grams of saturated fats or more to reach the desired caloric intake for days 2 to 5, or any remaining days, and a micronutrient composition on each day and any remaining days.

In another variation of the embodiments set forth above, the fasting mimicking diet package includes daily meal portions 8-10 kcal per kilogram body weight for each diet day. In this variation, the fasting mimicking diet provides less than 30 grams of sugar for each diet day, less than 18 grams of protein for each diet day, 9-15 grams of monounsaturated fats or more to reach the desired caloric intake for each diet day, and 2.5-4.5 grams of polyunsaturated fats or more to reach the desired caloric intake for each diet day and 1-5.5 grams of saturated fats or more to reach the desired caloric intake for each diet day. Higher levels of the fats listed above can be provided for higher FMD formulation providing up to 100% of the normal caloric intake to subjects.

In still another variation of the embodiments set forth above, the fasting mimicking diet package includes daily meal portions that provide 5-8 kcal per kilogram body weight for each diet day. In this variation, the fasting mimicking diet provides less than 20 grams of sugar for each diet day, less than 12 grams of protein for each diet day, and 6.5-10 grams of monounsaturated fats or more to reach the desired caloric intake for each diet day, 2.5-4.5 grams of polyunsaturated fats or more to reach the desired caloric intake for each diet day and 1.5-4 grams of saturated fats or more to reach the desired caloric intake for each diet day.

In still another variation of the embodiments set forth above, the fasting mimicking diet package includes daily meal servings that provide 0-3 kcal per kilogram body weight for each diet day. In this variation, the fasting mimicking diet provides less than 5 grams of sugar for each diet day, less than 3 grams of protein for each diet day, and less than 2.5 grams of monounsaturated fats for each diet day, less than 1 grams of polyunsaturated fats for each diet day and less than 1 grams of saturated fats for each diet day.

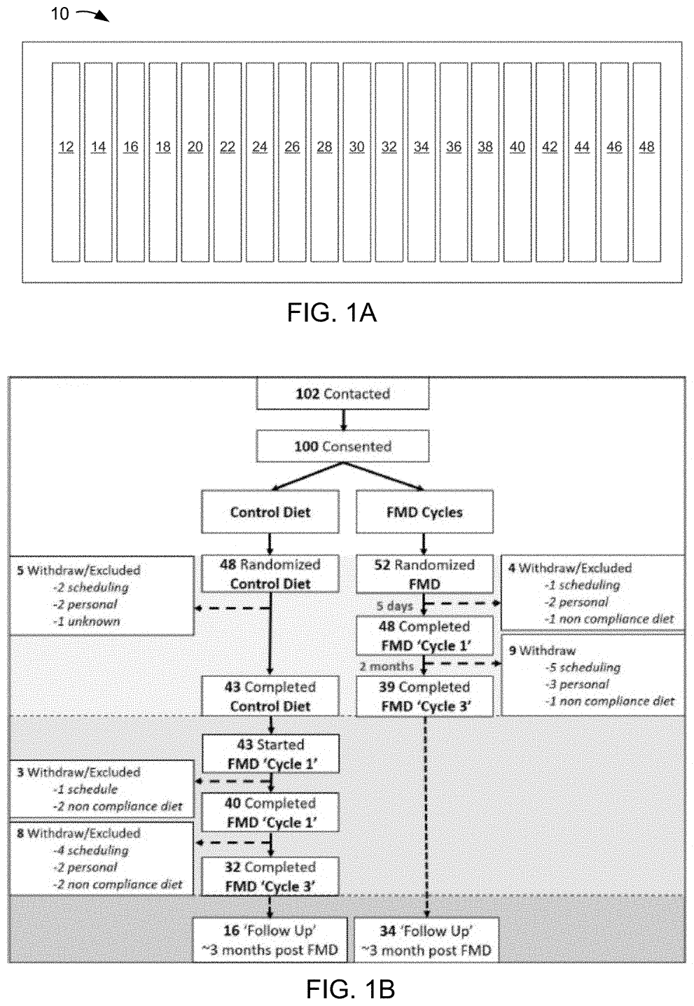

In an embodiment, the nutritional requirements for the fasting mimicking diet set forth above can be realized by a diet package with certain specific meal components. In one variation as depicted in FIG. 1A, the fasting mimicking diet package 10 provides daily meal portions for a predetermined number of days are set forth above (e.g., 1, 2, 3, 4, 5, 6, 7, 8, 9, or 10 days). The fasting mimicking diet package 10 includes a kale cracker composition (item 12), a first vegetable broth composition (item 14), a mushroom soup composition (item 16), a tomato soup composition (item 18), a quinoa-containing minestrone soup composition (item 20), a bean-containing minestrone soup composition (item 22), and a pumpkin soup composition (item 24).

Characteristically, the daily meal portions are packaged into meal servings or into a total daily serving to be divided into meals. In a refinement, the fasting mimicking diet package further includes a nut-containing nutrition bar (item 26), a cocoa-containing nutrition bar (item 28), a first olive-containing composition (item 30), a first vegetable broth composition (item 32), a tea composition that includes spearmint (item 34), an energy drink composition (item 36), a micronutritional composition (item 38), and a algal oil composition (item 40). In a further refinement, the fasting mimicking diet package further includes a second olive-containing composition (item 42), a second vegetable broth composition (item 44), a tea composition that includes spearmint and lemon (item 46), and a tea composition that includes hibiscus (item 48). It should be appreciated that each of the soup, broth, tea and energy compositions set forth herein are designed to have added water when consumed.

In another variation of a fasting mimicking diet package, diet package 10 includes a nut-containing nutrition bar (item 26), a cocoa-containing nutrition bar (item 28), a first olive-containing composition (item 30), a kale cracker composition (item 12), a vegetable soup composition (item 14), a first vegetable broth composition (item 14), a tea composition that includes spearmint (item 34), an energy drink composition (item 36), a micronutritional composition (item 38), and a algal oil composition (item 40). Characteristically, the daily meal portions are packaged into meal servings or into a total daily serving to be divided into meals. This diet package also includes daily meal portions for a predetermined number of days as set forth above with the daily meal portions being packaged into meal servings or into a total daily serving to be divided into meals. In a refinement, the fasting mimicking diet package further includes a mushroom soup composition (item 16), a tomato soup composition (item 18), a quinoa-containing minestrone soup composition (item 20), and a pumpkin soup composition. In a further refinement, the fasting mimicking diet package further includes a second olive-containing composition (item 42), a second vegetable broth composition (item 44), a bean-containing minestrone soup composition (item 22), a tea composition that includes spearmint and lemon (item 46), and a tea composition that includes hibiscus (item 48).

As set forth above, the fasting mimicking diet packages includes specific meal components. Typically, compositions are as follows. The nut-containing nutrition bar includes almond meal and macadamia nuts. The cocoa-containing nutrition bar includes almond butter, almonds, and brown rice crispy (e.g., brown puffed rice). The mushroom soup composition includes brown rice powder, carrots, inulin, and mushrooms. The bean-containing minestrone soup composition includes white beans, cabbage, and potatoes. The first vegetable broth composition includes carrots, maltodextrin, celery, spinach, and tomatoes. The second vegetable broth composition includes carrots, maltodextrin, celery, spinach, soy lecithin, and tomatoes. The energy drink composition includes glycerin and water. The algal oil composition includes schizocatrium algae oil. The micronutrient composition includes beet root powder, calcium carbonate, carrots, collard leaf, kale leaf, and tomatoes. In a refinement, the micronutrient composition includes Vitamin A (hereafter “Vit”), Vit C, Ca, Fe, Vit D3, Vit E, Vit K, Vit B1, Vit B2, Vit B3, Vit B5, Vit B6, Vit B7, Vit B9, Vit B12, Cr, Cu, I, Mg, Mn, Mo, Se, and Zn.

In a refinement, the nut-containing nutrition bar (L-Bar Nut based, available from L-Nutra Inc.) includes almond meal and macadamia nuts. In a refinement, the nut-containing nutrition bar (L-Bar Nut based) includes almond meal preferably in an amount of 20 to 35 weight %; coconut preferably in an amount of 2 to 10 weight %; coconut oil preferably in an amount of 1 to 8 weight %; flax seed meal preferably in an amount of 1 to 8 weight %; honey preferably in an amount of 10 to 30 weight %; macadamia nuts preferably in an amount of 10 to 30 weight %; pecans preferably in an amount of 10 to 25 weight %; salt preferably in an amount of 0.1 to 0.8 weight %; and optionally vanilla preferably in an amount of 0.3 to 1.5 weight %.

In a refinement, the cocoa-containing nutrition bar (L-Bar ChocoCrisp, available from L-Nutra Inc.) includes almond butter, almonds, and brown rice crispy (PGP10235). In a refinement, the cocoa-containing nutrition bar (L-Bar ChocoCrisp) includes almond butter preferably in an amount of 10 to 25 weight %; almonds preferably in an amount of 3 to 12 weight %; brown rice crispy (PGP10235) preferably in an amount of 10 to 25 weight %; brown rice syrup preferably in an amount of 2 to 8 weight %; chocolate liquor preferably in an amount of 1 to 4 weight %, cocoa butter preferably in an amount of 0.4 to 1.6 weight %; cocoa powder preferably in an amount of 4 to 12 weight %; fiber syrup SF75 preferably in an amount of 18 to 38 weight %, flax seed oil preferably in an amount of 1 to 3 weight %; salt preferably in an amount of 0.1 to 0.4 weight % and sugar preferably in an amount of 1 to 6 weight %.

In a refinement, the first olive-containing composition (sea salt version) incudes olives, olive oil, and sea salt. In a refinement, the first olive-containing composition (sea salt) includes lactic acid preferably in an amount of 0.3 to 1 weight %; oil (olive) preferably in an amount of 2 to 6 weight %; olives (raw, green pitted) preferably in an amount of 50 to 97 weight %; salt (reg., kosher, sea salt) preferably in an amount of 0.8 to 3 weight %; and thyme preferably in an amount of 0.1 to 0.5 weight %.

In a refinement, the second olive-containing composition (garlic version) incudes olives, olive oil, and garlic. In a refinement, the second olive-containing composition (garlic) includes garlic preferably in an amount of 0.1 to 0.6 weight %; lactic acid preferably in an amount of 0.3 to 1 weight %; oil (olive) preferably in an amount of 2 to 6 weight %; olives (raw, green pitted) preferably in an amount of 50 to 97 weight %; salt (reg., kosher, sea salt) preferably in an amount of 0.8 to 3 weight %; thyme preferably in an amount of 0.1 to 0.5 weight %.

In a refinement, the kale cracker composition includes kale, almonds, tapioca flour, and optionally sesame seeds. In another refinement, the kale cracker composition includes almonds preferably in an amount of 15 to 40 weight %; black pepper preferably in an amount of 0.1 to 0.4 weight %; chia seeds preferably in an amount of 3 to 10 weight %; chili pepper preferably in an amount of 0.4 to 1.2 weight %; cumin seeds preferably in an amount of 0.3 to 0.9 weight %; flax seeds preferably in an amount of 3 to 10 weight %; garlic preferably in an amount of 0.02 to 0.04 weight %; kale preferably in an amount of 2 to 6 weight %; oil (sun flower) preferably in an about of 2 to 7 weight %; onion (powder, minced) typically in an amount of 0.3 to 0.9 weight %; oregano preferably in an amount of 0.01 to 0.06 weight %; salt preferably in an amount of 1 to 4 weight %; sesame seeds preferably in an amount of 15 to 35 weight %; sugar (coconut) preferably in an amount of 1 to 5 weight %; tapioca flour preferably in an amount of 10 to 30 weight %; vinegar (coconut) preferably in an amount of 1 to 4 weight %; water (purified) preferably in an amount of 2 to 12 weight %; and yeast extract preferably in an amount of 0.3 to 1 weight %.

In another refinement, the kale cracker composition includes kale, flax seeds golden, sesame seeds, and sunflower seeds. In another refinement, the apple cider vinegar preferably in an amount 1 to 3 weight %; black pepper preferably in an amount of 0.4 to 1.3 weight %; cashews preferably in an amount of 4 to 13 weight %; dill weed preferably in an amount of 0.4 to 1.3 weight %; flax seeds golden preferably in an amount of 13 to 40 weight %; hemp seeds preferably in an amount of 0.7 to 2 weight %; kale preferably in an amount of 14 to 42 weight %; onion, white, dried, (powder, minced) preferably in an amount of 0.5 to 1.6 weight %; pumpkin seeds preferably in an amount of 0.7 to 2 weight %; salt (reg., kosher, sea salt) preferably in an amount of 0.7 to 2 weight %; Sesame seeds preferably in an amount of 2 to 8 weight %; sunflower seeds preferably in an amount of 10 to 30 weight %; and yeast extract preferably in an amount of 1 to 5 weight %.

In a refinement, the vegetable soup composition includes onions, tomatoes, spinach, green tree extract, optionally rice flour, optionally brown rice powder, optionally carrots, and optionally inulin, leeks. In a refinement, the vegetable soup composition includes basil (whole leaf, dried) preferably in an amount of 0.3 to 0.9 weight %; brown rice powder (whole grain) preferably in an amount of 3 to 12 weight %; carrot (dehydrated, puffed, powder, pieces) preferably in an amount of 4 to 14 weight %; green tea extract preferably in an amount of 0.02 to 0.06 weight %; inulin preferably in an amount of 5 to 15 weight %; leeks (granules −10+40) preferably in an amount of 1 to 5 weight %; oil (olive) preferably in an amount of 1 to 6 weight %; onion (powder, minced) preferably in an amount of 4 to 15 weight %; parsley preferably in an amount of 0.3 to 0.8 weight %; red bell peppers preferably in an amount of 1 to 5 weight %; rice flour preferably in an amount of 18 to 50 weight %; salt preferably in an amount of 2 to 7 weight %; spinach (leaf, powder) preferably in an amount of 0.4 to 1.5 weight %; tomatoes (fruit powder, sun dried, granules) preferably in an amount of 4 to 14 weight %; yeast extract preferably in an amount of 0.5 to 1.8 weight %. In the vegetable soup composition and any of the compositions set forth herein having rice flour, the rice flour can be glutinous or non-glutinous, milled or unmilled.

In another refinement, the vegetable soup composition includes carrots, inulin, leeks, onions and rice flour. In a refinement, the vegetable soup composition includes basil, whole leaf, dried preferably in an amount of 0.3 to 1 weight %; carrot (dehydrated, puffed, powder, pieces) preferably in an amount of 4 to 12 weight %; inulin preferably in an amount of 6 to 18 weight %; leeks in an amount of 1 to 5 weight %; oil (olive) preferably in an amount of 1 to 3 weight %; Onion, white, dried, (powder, minced) preferably in an amount of 10 to 30 weight %; parsley preferably in an amount of 0.3 to 1 weight %; potato preferably in an amount of 1 to 5 weight %; red pepper preferably in an amount of 1 to 6 weight %; rice flour in an amount of 13 to 40 weight %; salt (reg., kosher, sea salt) in an amount of 4 to 12 weight %; spinach (leaf, powder) preferably in an amount of 0.2 to 1 weight %; and tomatoes, (fruit powder, sun dried granules) preferably in an amount of 3 to 13 weight %.

In a refinement, the mushroom soup composition includes mushrooms, green tea extract, optionally brown rice powder, optionally carrots, and optionally inulin. In a refinement, the mushroom soup composition includes brown rice powder (whole grain) preferably in an amount of 10 to 30 weight %; carrot (dehydrated, puffed, powder, pieces) preferably in an amount of 3 to 12 weight %; green tea extract preferably in an amount of 0.02 to 0.06 weight %; inulin preferably in an amount of 3 to 12 weight %; mushrooms (European mix, powder, pieces) preferably in an amount of 6 to 18 weight %; oil (olive) preferably in an amount of 1 to 6 weight %; onion preferably in an amount of powder, minced) preferably in an amount of 3 to 12 weight %; parsley preferably in an amount of 0.1 to 0.5 weight %; rice flour preferably in an amount of 18 to 50 weight %; salt preferably in an amount of 2 to 8 weight %; yeast extract preferably in an amount of 0.5 to 1.5 weight %.

In another refinement, the mushroom soup composition includes carrots, inulin, mushrooms, onions, and rice flour. In another refinement, the mushroom soup composition includes carrot (dehydrated, puffed, powder, pieces) preferably in an amount of 7 to 22 weight %; inulin preferably in an amount of 7 to 22 weight %; mushrooms (European mix), (powder & pieces) dehydrated preferably in an amount of 7 to 22 weight %; oil (olive) preferably in an amount of 0.6 to 2 weight %; Onion, white, dried, (powder, minced) preferably in an amount of 7 to 22 weight %; parsley preferably in an amount of 0.3 to 0.9 weight %; potato preferably in an amount of 0.6 to 2 weight %; rice flour preferably in an amount of 15 to 45 weight %; salt (reg., kosher, sea salt) preferably in an amount of 6 to 18 weight %; and yeast extract preferably in an amount of 0.7 to 2.2 weight %.

In a refinement, the tomato soup composition includes tomatoes, green tea extract, optionally inulin, and optionally onions. In a refinement, the tomato soup composition (new) includes basil (whole leaf, dried) preferably in an amount of 0.2 to 0.7 weight %; brown rice powder (whole grain) preferably in an amount of 1 to 5 weight %; green tea extract preferably in an amount of 0.02 to 0.06 weight %; inulin preferably in an amount of 7 to 20 weight %; oil (olive) preferably in an amount of 3 to 9 weight %; onion preferably (powder, minced) preferably in an amount of 4 to 12 weight %; parsley preferably in an amount of 0.1 to 0.6 weight %; rice flour preferably in an amount of 18 to 50 weight %; salt preferably in an amount of 2 to 9 weight %; tomatoes (fruit powder, sun dried, granules) preferably in an amount of 12 to 36 weight %; and yeast extract preferably in an amount of 0.5 to 3 weight %.

In another refinement, the tomato soup composition includes tomatoes, inulin, olives, onions, potatoes, and rice flour. In still another refinement, the tomato soup composition includes basil, whole leaf, dried preferably in an amount of 0.3 to 1 weight %; inulin preferably in an amount of 6 to 18 weight %; oil (olive) preferably in an amount of 4 to 14 weight %; onion, white, dried, (powder, minced) preferably in an amount of 8 to 24 weight %; parsley preferably in an amount of 0.3 to 0.9 weight %; potato preferably in an amount of 6 to 18 weight %; rice flour preferably in an amount of 9 to 27 weight %; salt (reg., kosher, sea salt) preferably in an amount of 4 to 14 weight %; tomatoes, (fruit powder, sun dried granules) preferably in an amount of 8 to 24 weight %; and yeast extract preferably in an amount of 0.7 to 2.2 weight %.

In a refinement, the quinoa-containing minestrone soup composition includes quinoa, green tea extract, optionally olive oil, optionally cabbage, optionally potatoes, optionally rice flour, and optionally tomatoes and optionally no turmeric. In a refinement, the quinoa-containing minestrone soup composition includes basil (whole leaf, dried preferably in an amount of 0.7 to 2 weight %; broccoli powder preferably in an amount of 0.6 to 2 weight %; cabbage white (flakes) preferably in an amount of 3 to 10 weight %; carrot (dehydrated, puffed, powder, pieces) preferably in an amount of 3 to 10 weight %; celery preferably in an amount of 1 to 4 weight %; celery seeds (powder) preferably in an amount of 0.07 to 0.2 weight %; garlic preferably in an amount of 0.7 to 2 weight %; green tea extract preferably in an amount of 0.02 to 0.06 weight %; inulin preferably in an amount of 1 to 5 weight %; leeks (granules −10+40), preferably in an amount of 0.7 to 2 weight %; oil (olive) preferably in an amount of 0.6 to 2 weight %; onion (powder, minced) preferably in an amount of 2 to 8 weight %; peas preferably in an amount of 3 to 10 weight %; potato preferably in an amount of 7 to 20 weight %; quinoa preferably in an amount of 7 to 20 weight %; rice flour preferably in an amount of 7 to 20 weight %; salt, preferably in an amount of 1 to 6 weight %; spinach (leaf, powder) preferably in an amount of 0.5 to 2 weight %; tomatoes (fruit powder, sun dried, granules) preferably in an amount of 2 to 6 weight %; yeast extract preferably in an amount of 0.6 to 2 weight %; zucchini (powder, diced) preferably in an amount of 2 to 8 weight %.

In another refinement, the quinoa-containing minestrone soup includes quinoa, cabbage, potatoes, and rice flour. In still another refinement, the quinoa-containing minestrone soup includes basil, whole leaf, dried preferably in an amount of 0.7 to 2.2 weight %; broccoli powder preferably in an amount of 0.7 to 2.2 weight %; cabbage white (flakes) preferably in an amount of 0.6 to 2.2 weight %; carrot (dehydrated, puffed, powder, pieces) preferably in an amount of 3 to 10 weight %; celeriac preferably in an amount of 2 to 6 weight %; celery seeds powder preferably in an amount of 0.6 to 1.8 weight %; garlic preferably in an amount of 1 to 3 weight %; Onion, white, dried, (powder, minced) preferably in an amount of 3 to 9 weight %; peas preferably in an amount of 3 to 10 weight %; potato preferably in an amount of 6 to 20 weight %; quinoa preferably in an amount of 8 to 23 weight %; rice flour preferably in an amount of 7 to 22 weight %; salt (reg., kosher, sea salt) preferably in an amount of 2 to 7 weight %; savoy cabbage preferably in an amount of 3 to 10 weight %; spinach (leaf, powder) preferably in an amount of 0.7 to 2.2 weight %; turmeric preferably in an amount of 0.6 to 1.8 weight %; yeast extract preferably in an amount of 3 to 10 weight %; and zucchini (powder, diced) preferably in an amount of 1 to 5 weight %.

In a refinement, the bean-containing minestrone soup composition includes white beans (e.g., great northern beans), great tea extract, optionally cabbage, and optionally potatoes. In a refinement, the bean-containing minestrone soup composition includes beans (great northern) preferably in an amount of 3 to 10 weight %; cabbage white (flakes) preferably in an amount of 2 to 8 weight %; carrot (dehydrated, puffed, powder, pieces) preferably in an amount of 2 to 8 weight %; celery preferably in an amount of 1 to 4 weight %; green tea extract preferably in an amount of 0.02 to 0.06 weight %; inulin preferably in an amount of 2 to 10 weight %; leeks (granules −10+40) preferably in an amount of 2 to 7 weight %; oil (olive) preferably in an amount of 2 to 7 weight %; onion (powder, minced) preferably in an amount of 2 to 7 weight %; parsley preferably in an amount of 0.2 to 1 weight %; peas preferably in an amount of 3 to 9 weight %; potato preferably in an amount of 15 to 45 weight %; rice flour preferably in an amount of 6 to 18 weight %; salt preferably in an amount of 2 to 8 weight %; spinach (leaf, powder) preferably in an amount of 0.5 to 1.5 weight %; tomatoes (fruit powder, sun dried, granules) preferably in an amount of 2 to 7 weight %; and yeast extract preferably in an amount of 0.5 to 1.5 weight %.

In a refinement, the bean-containing minestrone soup composition includes brown beans, carrots, peas, potato, and rice flour. In another refinement, the bean-containing minestrone soup composition includes carrot (dehydrated, puffed, powder, pieces) preferably in an amount of 4 to 14 weight %; celeriac preferably in an amount of 1 to 5 weight %; celery preferably in an amount of 0.5 to 1.6 weight %; leeks preferably in an amount of 2 to 8 weight %; oil (olive) preferably in an amount of 2 to 8 weight %; Onion, white, dried, (powder, minced) preferably in an amount of 3 to 10 weight %; parsley preferably in an amount of 0.5 to 1.5 weight %; peas preferably in an amount of 5 to 18 weight %; potato preferably in an amount of 8 to 24 weight %; rice flour preferably in an amount of 5 to 18 weight %; salt (reg., kosher, sea salt) preferably in an amount of 4 to 14 weight %; spinach (leaf, powder) preferably in an amount of 0.5 to 1.5 weight %; tomatoes, (fruit powder, sun dried granules) preferably in an amount of 0.9 to 2.8 weight %; turmeric preferably in an amount of 0.3 to 1.2 weight %; and yeast extract preferably in an amount of 0.5 to 1.5 weight %.

In a refinement, the pumpkin soup composition includes pumpkin, green tree extract, optionally rice flour, optionally carrots, and optionally brown rice powder. In a refinement, the pumpkin soup composition includes (new) includes brown rice powder (whole grain) preferably in an amount of 3 to 9 weight %; carrot (dehydrated, puffed, powder, pieces) preferably in an amount of 2 to 8 weight %; green tea extract preferably in an amount of 0.02 to 0.06 weight %; inulin preferably in an amount of 2 to 10 weight %; oil (olive) preferably in an amount of 1 to 7 weight %; onion (powder, minced) preferably in an amount of 1.0 to 3 weight %; pumpkin powder preferably in an amount of 20 to 60 weight %; rice flour preferably in an amount of 15 to 45 weight %; salt preferably in an amount of 2 to 10 weight %; and yeast extract preferably in an amount of 0.3 to 1 weight %.

In a refinement, the first vegetable broth includes carrots, maltodextrin, celery, spinach, and tomatoes. In a refinement, the first vegetable broth includes carrot (dehydrated, puffed, powder, pieces) preferably in an amount of 6 to 18 weight %; celery preferably in an amount of 3 to 10 weight %; garlic preferably in an amount of 3 to 10 weight %; maltodextrin preferably in an amount of 8 to 25 weight %; oil (canola) preferably in an amount of 0.5 to 2 weight %; onion (powder, minced) preferably in an amount of 6 to 18 weight %; parsley preferably in an amount of 3 to 10 weight %; potato preferably in an amount of 1 to 3 weight %; salt preferably in an amount of 7 to 21 weight %; spinach (leaf, powder) preferably in an amount of 3 to 10 weight %; tomatoes (fruit powder, sun dried, granules) preferably in an amount of 6 to 18 weight %; and yeast extract preferably in an amount of 1 to 6 weight %.

In a refinement, the second vegetable broth (chicken flavoring) includes carrots, chicken flavoring, maltodextrin, celery, spinach, soy lecithin, and tomatoes. In a refinement, the second vegetable broth composition includes carrot (dehydrated, puffed, powder, pieces) preferably in an amount of 3 to 10 weight %; celery preferably in an amount of 3 to 12 weight %; garlic preferably in an amount of 3 to 9 weight %; maltodextrin preferably in an amount of 8 to 25 weight %; oil (canola) preferably in an amount of 0.5 to 2 weight %; onion preferably in an amount of powder, minced) preferably in an amount of 3 to 12 weight %; parsley preferably in an amount of 3 to 10 weight %; potato preferably in an amount of 1 to 6 weight %; salt preferably in an amount of 8 to 25 weight %; soy lecithin preferably in an amount of 0.5 to 3 weight %; spinach (leaf, powder) preferably in an amount of 3 to 12 weight %; tomatoes (fruit powder, sun dried, granules) preferably in an amount of 6 to 18 weight %; xanthan gum preferably in an amount of 0.5 to 4 weight %; and yeast extract preferably in an amount of 4 to 12 weight %.

In a refinement, the energy drink composition includes glycerin preferably in an amount of 20 to 60 weight %; water (purified) preferably in an amount of 40 to 80 weight %.

In a refinement, the tea composition that includes spearmint includes spearmint leaves organic preferably in an amount of 70 to 100 weight %.

In a refinement, the tea composition that includes lemon and spearmint includes lemon myrtle organic preferably in an amount of 3 to 12 weight %; lemon peel organic preferably in an amount of 10 to 25 weight %; spearmint leaves organic preferably in an amount of 50 to 95 weight %.

In a refinement, the tea composition that includes hibiscus includes hibiscus tea leaves organic preferably in an amount of 80 to 100 weight %.

In a refinement, the algal oil composition includes schizocatrium algae oil (DHA Omega-3) preferably in an amount of 80 to 100 weight %.

In a refinement, the nutrient replenishment composition (NR-1) includes beet root powder, calcium carbonate, carrots, collard leaf, kale leaf, and tomatoes. In a refinement, the nutrient replenishment composition (NR-1) includes ascorbic acid preferably in an amount of 1 to 3 weight %; beet root powder preferably in an amount of 6 to 20 weight %; beta carotene preferably in an amount of 0.05 to 0.15 weight %; calcium carbonate preferably in an amount of 6 to 20 weight %; carrot (dehydrated, puffed, powder, pieces) preferably in an amount of 6 to 20 weight %; cholecaliciferol preferably in an amount of 0.00 weight %; chromium Picolinate preferably in an amount of 0.00 weight %; collard leaf powder preferably in an amount of 6 to 20 weight %; cupric sulfate preferably in an amount of 0.01 to 0.06 weight %; cyanocobalamin, 0.00; D1-alpha tocopherol acetate preferably in an amount of 0.3 to 1 weight %; ferrous fumarate preferably in an amount of 0.2 to 1 weight %; folic acid preferably in an amount of 0.00 weight %; kale leaf preferably in an amount of 6 to 20 weight %; magnesium stearate preferably in an amount of 1 to 6 weight %; manganese sulfate preferably in an amount of 0.04 to 0.08 weight %; niacinamide preferably in an amount of 0.3 to 1 weight %; pantothenic acid preferably in an amount of 0.1 to 0.6 weight %; phytonadione preferably in an amount of 0.00 weight %; potassium iodine preferably in an amount of 0 weight %; pyriodoxine HCl preferably in an amount of 0.03 to 0.1 weight %; riboflavin preferably in an amount of 0.02 to 0.1 weight %; sodium molybdate preferably in an amount of 0.00 weight %; sodium selenate preferably in an amount of 0.00 weight %; spinach (leaf, powder) preferably in an amount of 6 to 20 weight %; thiamine mononitrate preferably in an amount of 0.02 to 0.1 weight %; tomatoes (fruit powder, sun dried, granules) preferably in an amount of 6 to 20 weight %; tribasic calcium phosphate preferably in an amount of 0.5 to 2 weight %; and zinc oxide preferably in an amount of 0.2 to 0.8 weight %.)

In a variation, the each of the components of the fasting mimicking diet package and therefore the fasting mimicking diet, is substantially gluten free (e.g., each component has less than 20 ppm gluten) or very low gluten (e.g., each component has 20-100 ppm). In other variations, each of the components are provided in a serving size from 20 to 60 g. In other variations, the nut-containing nutrition bar is provided in a serving size from 30 to 60 g; cocoa-containing nutrition bar is provided in a serving size from 15 to 40 g; the olive containing composition (sea salt version) in a serving size from 10 to 20 g; the olive containing composition (garlic version) in a serving size from 10 to 20 g; kale cracker composition is provides in a serving size from 30 to 60 g; In another variation, the kale cracker compositions are provided in a serving size from 20 to 50 g; the vegetable soup compositions are provided in a serving size from 20 to 50 g; the mushroom soup compositions are provided in a serving size from 20 to 50 g; the tomato soup compositions are provided in a serving size from 20 to 50 g; the bean-containing minestrone soup compositions are provided in a serving size from 20 to 50 g; the quinoa-containing minestrone soup compositions are provided in a serving size from 20 to 50 g; the pumpkin soup compositions are provided in a serving size from 20 to 50; the first vegetable both compositions are provided in a serving size from 5 to 15; the second vegetable both compositions are provided in a serving size from 3 to 15; and Energy Drink composition is provided in serving size of 1 to 5 oz.

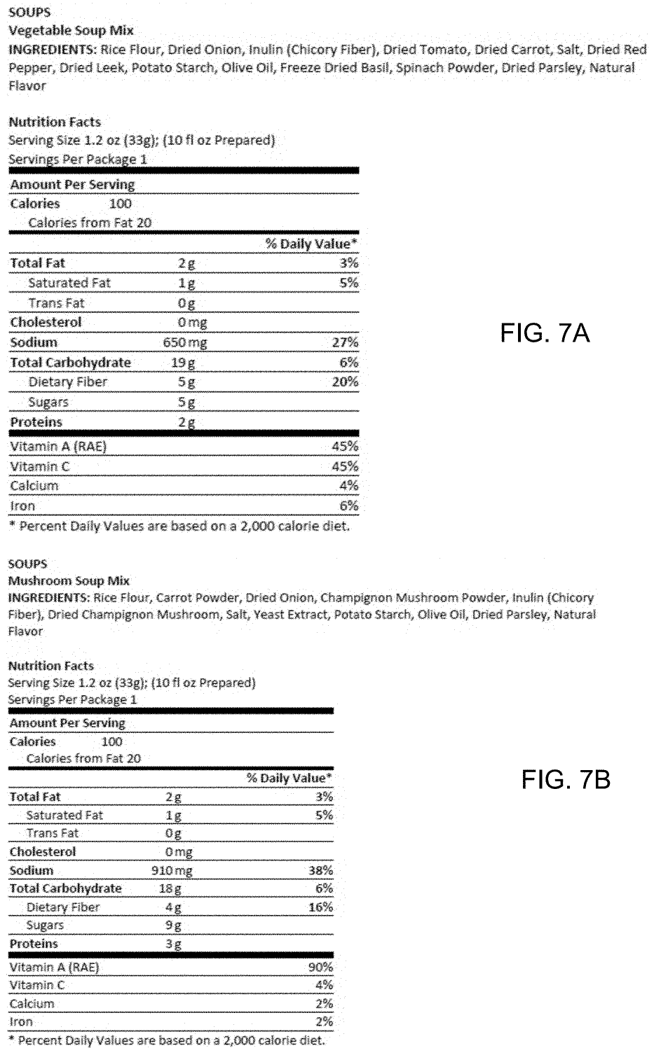

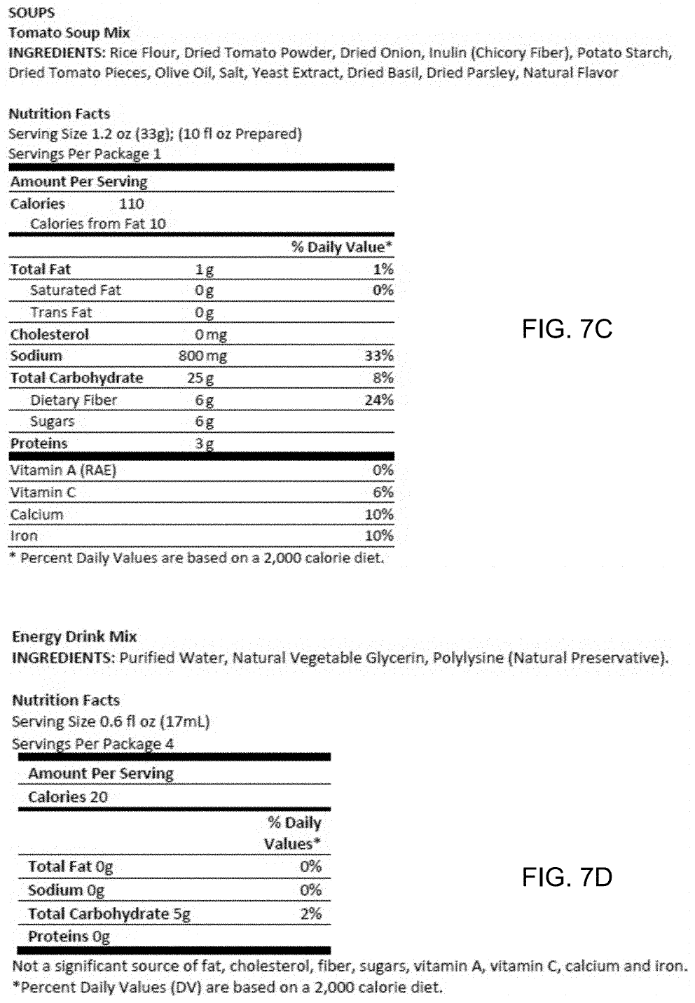

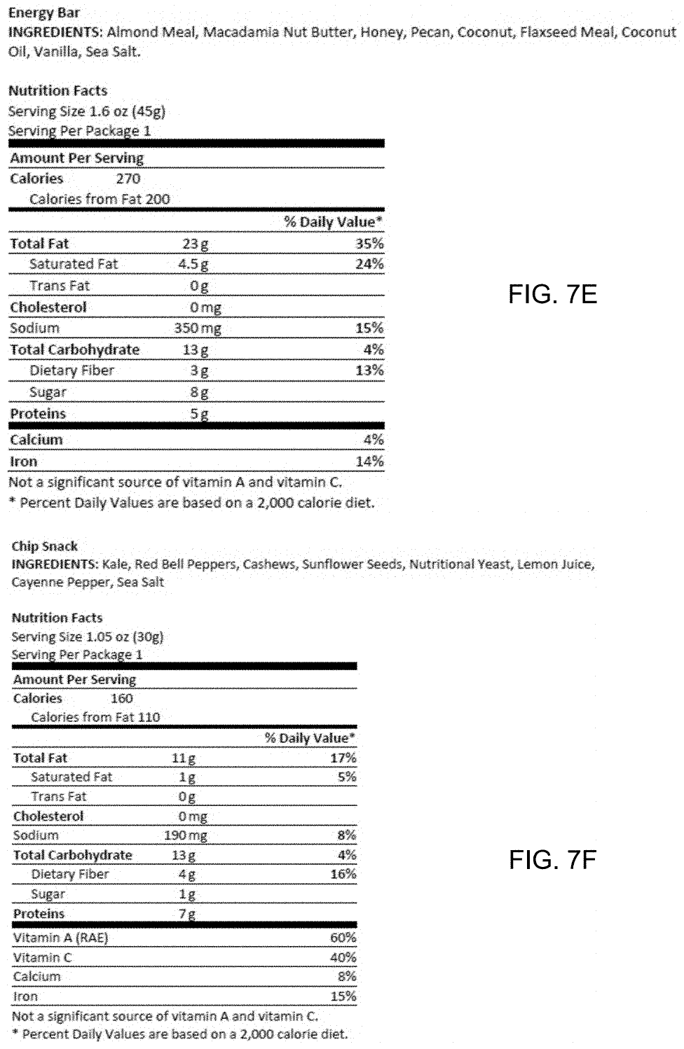

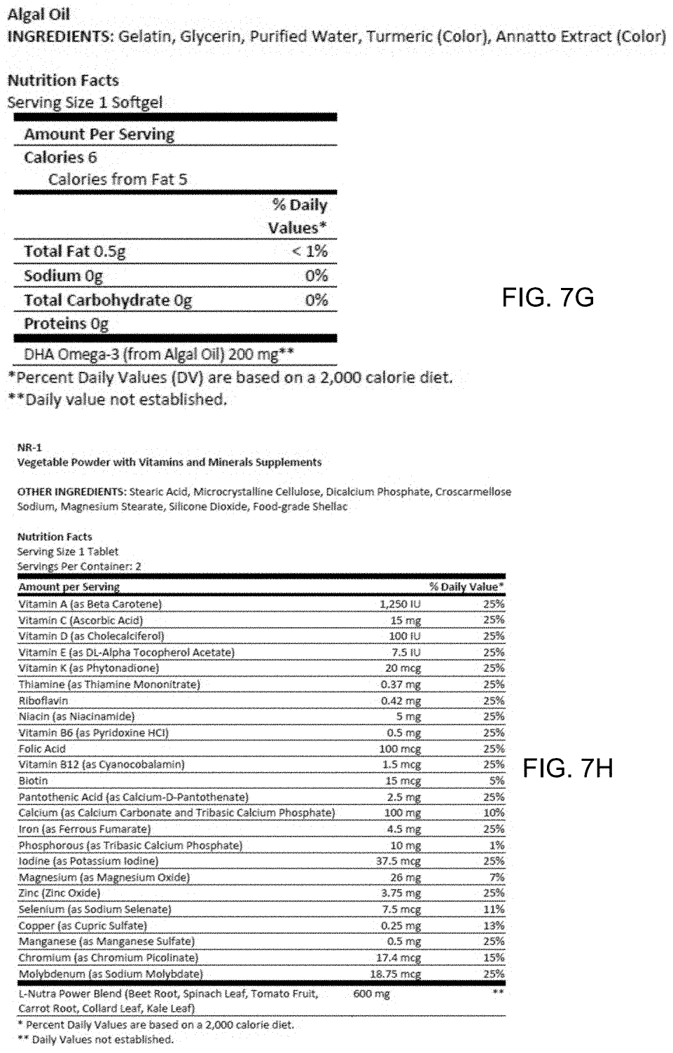

FIGS. 7A-H provide nutritional information for each of the meal components. It should be appreciated that variations of these values can vary by +/−30 percent. In other variations, the meal components are provided in sufficient amounts to meet the caloric and nutritional requirements in these figures.

The table set forth below provides a schedule of administration for two FMD meal plans to be administered to a subject. The Prolon® Meal plan (available from L-Nutra Inc.) is useful for weight loss, treating or preventing hypertension, metabolic disease, diabetes, and the like. The Chemolieve® (also available from L-Nutra Inc.) meal plan is useful for alleviating the side effect of chemotherapy. Therefore, the diet packages set forth herein can include instruction providing the schedules and instructions for administering the FMD to treat various conditions as set forth in the methods below.

Table of Meal Schedules

| | MEAL PLAN - PROLON US | | | | | MEAL PLAN CHEMOLIEVE US | | | | |
|---|---|---|---|---|---|---|---|---|---|---|
| COMPONENTS (single servings) | DAY 1 | DAY 2 | DAY 3 | DAY 4 | DAY 5 | DAY 1 | DAY 2 | DAY 3 | DAY 4 | DAY 5 |
| nut-containing nutrition bar | 2 | 1 | 1 | 1 | 1 | 1 | — | — | — | 1 |
| (L-Bar Nut based) | | | | | | | | | | |
| cocoa-containing nutrition bar | 1 | 1 | — | 1 | — | — | — | — | — | — |
| (L-Bar ChocoCrisp) - .83 oz. | | | | | | | | | | |
| First olive-containing | 1 | 1 | — | 1 | — | — | — | — | — | — |
| composition (Sea Salt) - 0.73 oz | | | | | | | | | | |
| Second olive-containing | — | 1 | — | 1 | — | — | — | — | — | — |
| composition (Garlic) - 0.73 oz | | | | | | | | | | |
| kale cracker composition, (35 g) | 1 | — | 1 | — | 1 | 1 | 1 | — | — | — |
| vegetable soap composition | — | — | — | 1 | — | 1 | — | — | 1 | — |
| mushroom soap composition | — | 1 | — | — | — | — | 1 | — | — | — |
| tomato soap composition | 1 | — | 1 | — | 1 | 1 | — | — | — | 1 |
| quinoa-containing minestrone | — | 1 | — | 1 | — | — | — | — | — | — |
| soup composition | | | | | | | | | | |
| bean-containing minestrone | 1 | — | 1 | — | 1 | — | — | — | — | — |
| soup composition | | | | | | | | | | |
| pumpkin soup composition, | — | — | — | — | — | — | — | 1 | — | — |
| First vegetable broth | — | — | — | — | — | — | — | 1 | — | 1 |
| composition | | | | | | | | | | |
| Second vegetable broth | — | — | — | — | — | — | 1 | — | 1 | — |
| composition (chicken) | | | | | | | | | | |
| Energy Drink | — | 1 | 1 | 1 | 1 | 1 | 1 | — | — | — |
| Tea - Spearmint | 1 | 1 | 1 | 1 | 1 | 1 | 1 | 1 | 1 | 1 |
| Tea - Lemon Spearmint | 1 | 1 | 1 | 1 | 1 | 1 | 1 | 1 | 1 | 1 |
| Tea - Hibiscus | — | 2 | 2 | 2 | 2 | — | — | — | — | — |
| Algal oil | 1 | — | — | — | 2 | 2 | — | — | — | 1 |
| NR-1 | 2 | 1 | 1 | 1 | 1 | 2 | 1 | 1 | 1 | 1 |

In another embodiment, a method for inducing differential effects on disease factors and markers associated with aging is provided. This method includes a step of identifying a subject in need of modifying disease factors and markers associated with aging. Expression of the factors and marker might be decreased or increased depending on which direct results in a health benefit. The fasting mimicking diet provided by the diet packages set forth above is administered to a subject for a predetermined period of time as set forth above. Examples of such disease factors and markers are insulin-like growth factor-1, blood glucose, systolic or diastolic blood pressure, insulin-like growth factor-1, blood glucose, systolic blood pressure, diastolic blood pressure, cholesterol, CRP, triglycerides, or abdominal/visceral fats.

In another embodiment, a method of promoting and inducing beneficial long-lasting effects on disease factors and markers associated with aging is provided. This method includes a step of identifying a subject in need of modifying disease factors and markers associated with aging. Expression of the factors and marker might be decreased or increased depending on which direct results in a health benefit. The fasting mimicking diet provided by the diet packages set forth above is administered to a subject for a predetermined period of time as set forth above. Examples of such disease factors and markers are insulin-like growth factor-1, blood glucose, systolic blood pressure, diastolic blood pressure, cholesterol, CRP, triglycerides, or abdominal/visceral fats.

In still another embodiment, a method for promoting and inducing stem-cell based regeneration of multiple organs and systems is provided. This method includes a step of identifying a subject in need of promoting and inducing stem-cell based regeneration of multiple organs and systems. The fasting mimicking diet provided by the diet packages set forth above is administered to a subject for a predetermined period of time as set forth above. Examples of stem-cell based regeneration of multiple organs and systems include, but are not limited to, neurogenesis, hematopoiesis, or promotion of pancreatic beta-cells.

In still another embodiment, a method for promoting and inducing stem cell-based rejuvenation of multiple organs and systems is provided. This method includes a step of identifying a subject in need of promoting and inducing stem-cell based rejuvenation of multiple organs and systems. The fasting mimicking diet provided by the diet packages set forth above is administered to a subject for a predetermined period of time as set forth above. Examples of stem cell-based regeneration of multiple organs and systems include, but are not limited to, neurogenesis, hematopoiesis, or promotion of pancreatic beta-cells.

The following examples illustrate the various embodiments of the present invention. Those skilled in the art will recognize many variations that are within the spirit of the present invention and scope of the claims.

We report the results of a randomized controlled trial of 100 subjects, 71 of whom completed 3 cycles of the FMD either in a randomized phase (N=39) or after being crossed over from a control diet group to the FMD group (N=32). We evaluated the effects of the FMD on risk factors and markers for aging, cancer, metabolic syndrome and cardiovascular diseases in generally healthy participants ranging from 20 to 70 years of age.

Baseline Data for all Subjects.

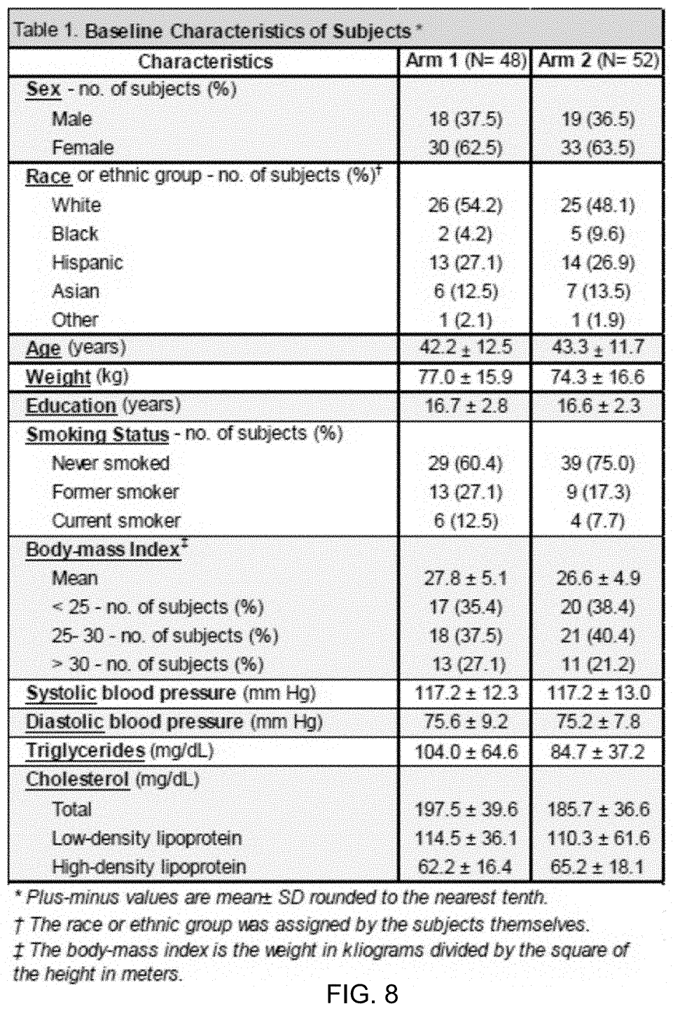

From April 2013 until July 2015, 100 study participants were randomized and assigned to either arm 1 (N=48) or arm 2 (N=52). At enrollment, independent of whether they completed the trial or not, subjects in the two arms were comparable for age, sex, race, and body weight (FIG. 8, Table 1). Hispanics (27%) were underrepresented in the study population in comparison to their representation (˜45%) in the greater Los Angeles area (California, USA) (49). The participants in control arm 1 were asked to continue their normal diet for 3 months, while participants in arm 2 started the FMD intervention. Two participants withdrew from arm 1 due to scheduling conflicts before completion of the informed consent. In the randomized comparison (FIG. 1B), 18 participants or 5 of 48 (10%) in the control arm and 13 of 52 participants in the FMD arm (25%), were excluded or withdrew from the study. Of the 48 subjects enrolled in the control arm, 2 withdrew because of scheduling conflicts, 2 due to unspecified personal issues, and one for unknown reasons. Six of the 52 subjects enrolled in the FMD arm withdrew from the study due to scheduling conflicts, 5 because of unspecified personal issues, and 2 participants were excluded from the study because of non-compliance to the FMD protocol.

Adverse Effects and Safety.

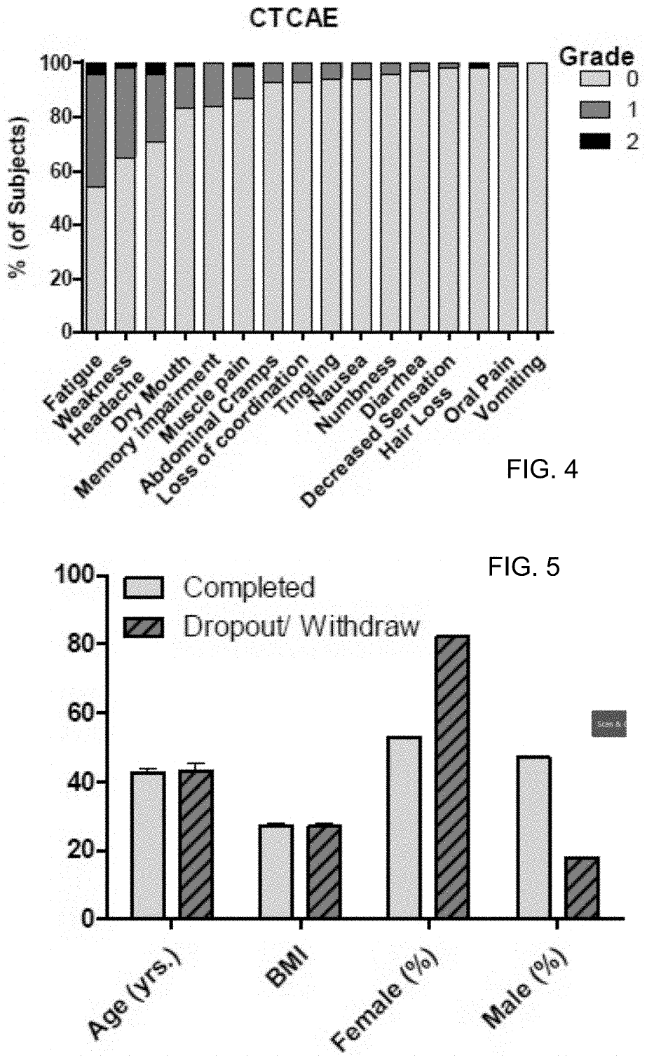

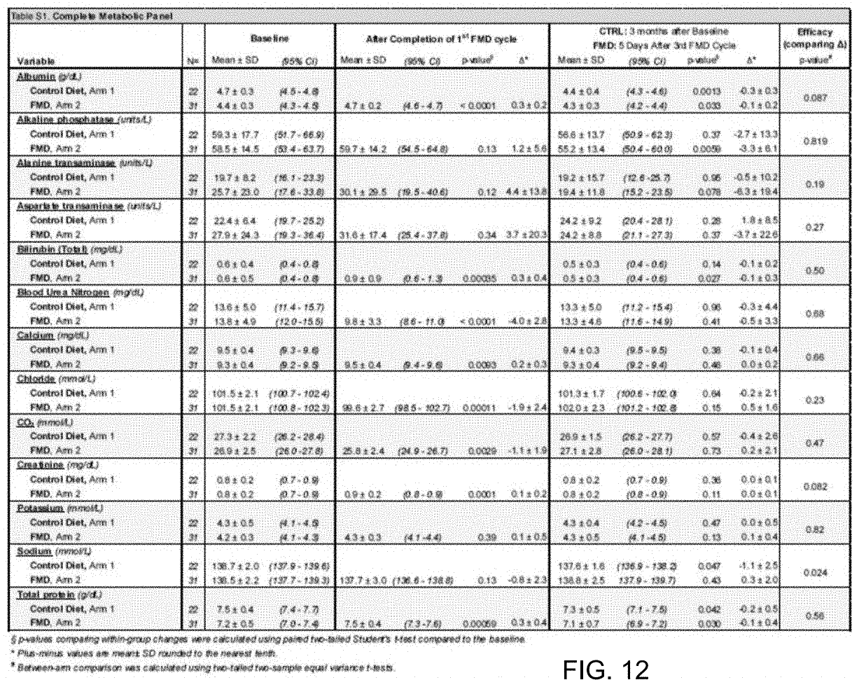

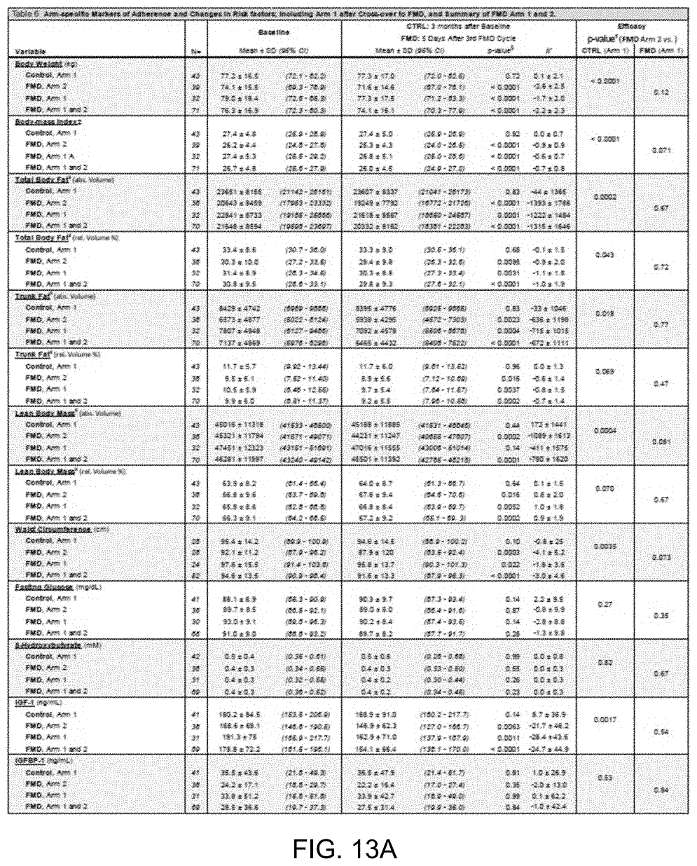

Following the Common Terminology Criteria for Adverse Events (CTCAE, v4.0), 54% to 100% (depending on the adverse event) of the participants reported no adverse effects during the FMD cycles (FIG. 4). The most common self-reported grade 1 (mild) or grade 2 (moderate) symptoms experienced by the participants were fatigue, weakness and headaches. No adverse effects of grade 3 or higher were reported. A comprehensive metabolic panel that measured changes in metabolic markers and liver and kidney function showed no negative effects of 3 cycles of the FMD (FIG. 12, Table 5). In summary, after 3 cycles of the FMD subjects reported only some mild and very few moderate side effects.

Baseline Risk Factors and Metabolic Markers: Comparison of Randomized Control and FMD Subjects Who Completed the Trial.

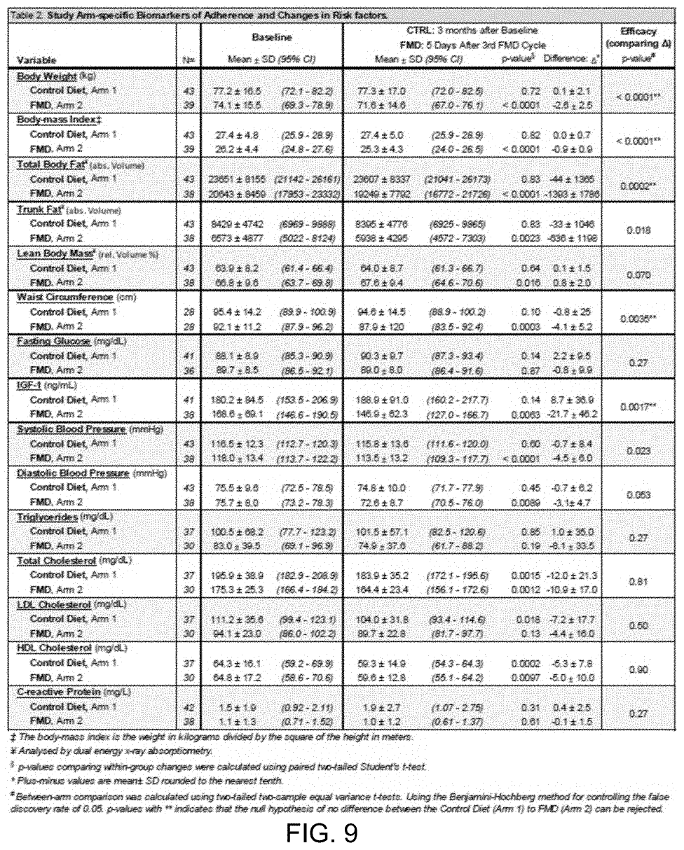

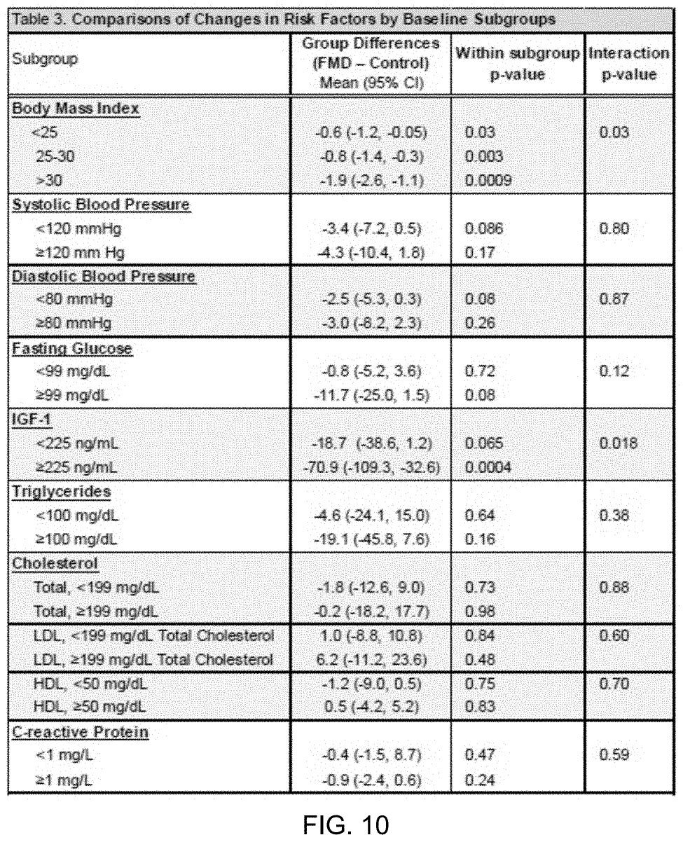

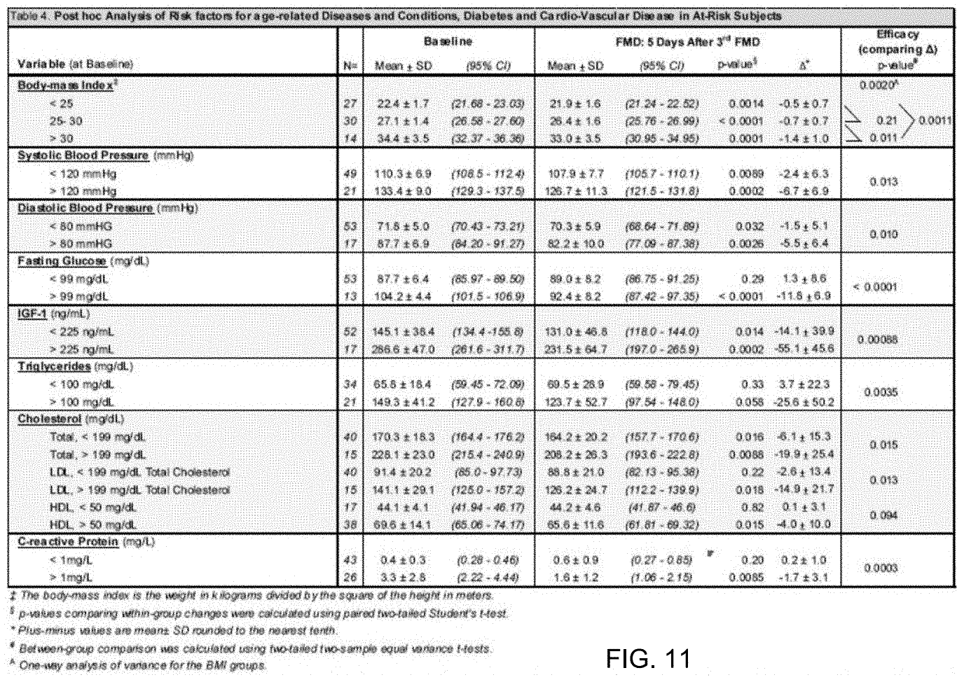

At baseline, there were no significant differences in metabolic markers or risk factors for age-related diseases and conditions between the subjects who successfully completed the randomized trial in arm 1 (normal diet) and arm 2 (FMD), including body weight (p=0.39), BMI (p=0.24), total body fat (p=0.11), trunk fat (p=0.087), lean body mass (p=0.15), waist circumference (p=0.34), fasting glucose (p=0.55), IGF-1 (p=0.51), systolic and diastolic blood pressure (p=0.60 and p=0.91, respectively), triglycerides (p=0.21) and C-reactive protein (p=0.28). The notable exception was that total cholesterol (p=0.014) and low-density lipoprotein (p=0.024), but not high-density lipoprotein (p=0.99), were significantly lower at baseline for subjects who were enrolled and completed arm 2 (FIG. 9, Table 2). In summary, the values for disease markers and risk factors at baseline were comparable between the control diet and FMD groups, with the exception of total and LDL cholesterol.

Changes in Risk Factors and Metabolic Markers: Comparison of Randomized Control and FMD Groups.

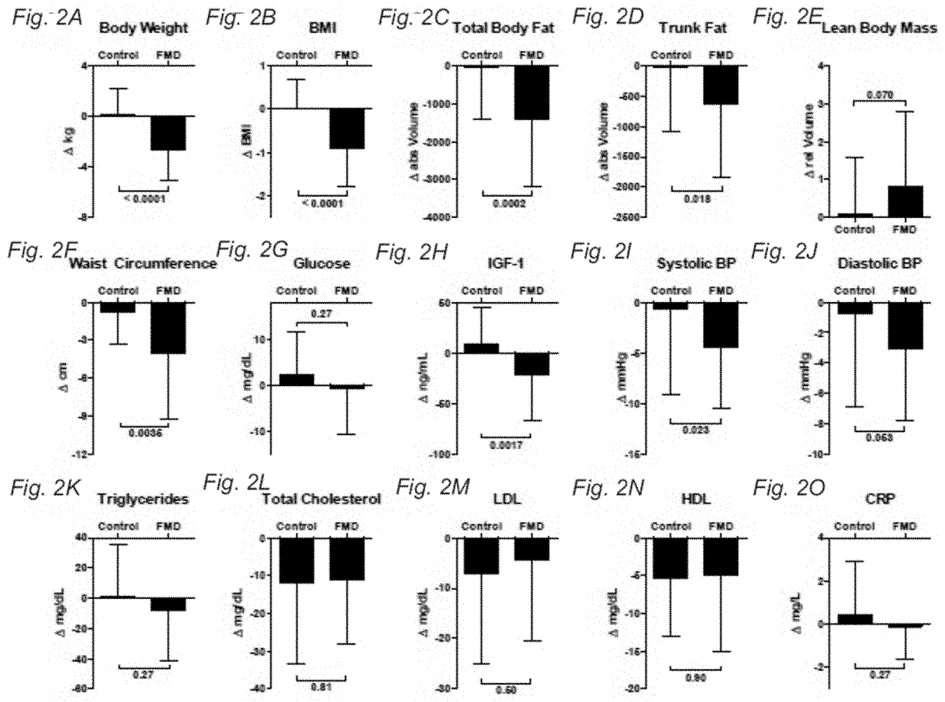

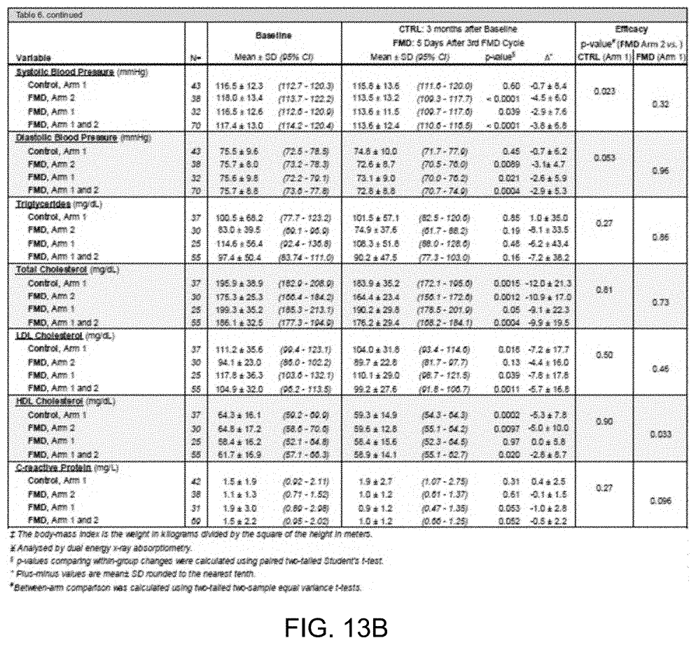

Next, we evaluated the effects of the FMD by assessing the changes in marker/risk factor values between baseline and 5-7 days following the end of the third cycle of the FMD and compared them to those occurring in the control arm within the same 3-months period (FIG. 2 and Tables 2 (FIG. 9) and 6 (FIG. 13)). Participants in the FMD arm (arm 2) lost on average 2.6±2.5 kg (±SD) (p<0.0001) of weight, which was accompanied by a reduction in total body fat (absolute values and relative volume % of total mass) and trunk fat (absolute values) (Tables 2 (FIG. 9), 6 (FIG. 13)). Subjects on the control diet did not lose body weight (0.1±2.1 kg). After controlling the false discovery rate of 0.05 between the control and FMD groups, no change in the percentage of lean body mass was observed (relative to the total mass; p=0.07), although absolute lean body mass was reduced in arm 2 (p=0.004) (Tables 2 (FIG. 9), Table 6 (FIG. 13)). Waist circumference measured after 3 FMD cycles was reduced by 4.1±5.2 cm (p=0.0035 between groups). The FMD cycles also resulted in a decrease in IGF-1 concentrations of 21.7±46.2 ng/mL (p=0.0017 between groups). Systolic blood pressure was reduced by 4.5±6.0 mmHg (p=0.023 between groups) and diastolic blood pressure was reduced by 3.1±4.7 mmHg (p=0.053 between groups). Fasting glucose (p=0.27), triglycerides (p=0.27), cholesterol (total p=0.81; LDL p=0.50; HDL p=0.90) and the acute-phase inflammatory marker C-reactive protein (CRP; p=0.27) did not differ significantly between groups. A graphical summary of these data is presented in FIG. 2. In conclusion, 3 cycles of the FMD reduced body weight, trunk and total body fat, blood pressure and IGF-1 in comparison to a standard diet.

Changes in Risk factors and Metabolic Markers of Age-related Diseases and Conditions: Observational Pre-Post FMD Comparison.

After 3 months, 43 subjects from the control arm were crossed over to the FMD intervention. 11 (26%) of these subjects withdrew before completing 3 FMD cycles (FIG. 1B). Five of these participants withdrew due to scheduling issues and 2 subjects opted to leave the trial for unspecific personal reasons. We also excluded 4 participants based on non-adherence to the FMD protocol. The causes for withdrawal/exclusion were comparable between the arms. Considering both FMD treatment arms, 24 of the 95 participants (25%) were excluded or withdrew from the study prior to completion of the 3 FMD cycles (arm 2 N=13 FMD and arm 1 N=11 after FMD crossover) due to scheduling conflicts (total N=11; arm 2 N=6 FMD and arm 1 N=5 after FMD crossover), personal issues (total N=7; arm 2 N=5 FMD; arm 1 N=2 after FMD crossover), or dislike of the diet and/or non-adherence to the dietary protocol (total N=6; arm 2 N=2 FMD; arm 1 N=4 after FMD crossover) (FIG. 1B).

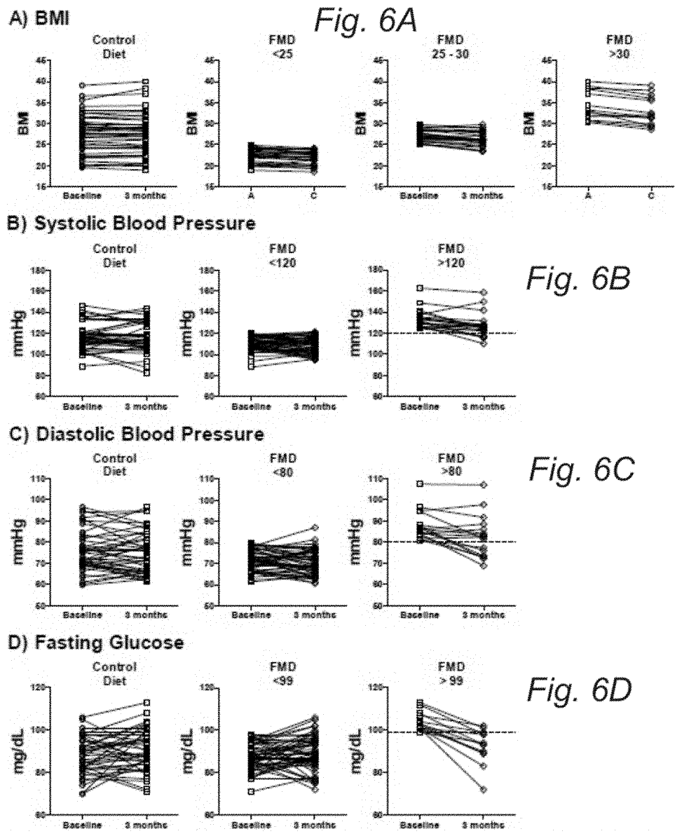

The 25% dropout rate for participants during the FMD is higher than the 10% dropout rate observed during control diet in arm 1, but this is expected considering that subjects in control diet group only dropped out because of scheduling conflicts since they were was allowed to remain on their own diet. 95 subjects (95%) completed 1 cycle and 71 (71%) completed 3 cycles of the FMD. Compared to the 71 participants who completed the 3 FMD cycles in arms 1 and 2, the 24 subjects who dropped out were not different in age (42.5±11.6 vs. 43.3±13.1 years) or BMI (27.1±4.9 vs. 26.9±4.7) but were mostly female (18% male vs. 82% female, p=0.0045 Fisher's exact test; FIG. 5).

Because the differential dropout rate during the FMD treatment period (25% in FMD in the randomized arm 2 and/or after arm 1 cross-over vs. 10% in the randomized arm 1 control) may have induced biases in estimates of the FMD treatment effect, we compared the changes in trial outcomes between the two groups who completed 3 FMD cycles (N=39 FMD randomized arm 2, N=32 after arm 1 crossover to FMD) using sensitivity-analysis. 3 FMD cycles had comparable effects between subjects in arm 1 (after cross over) and arm 2 (randomized) with the exception of HDL, which underwent a greater reduction in arm 2 (p=0.03) and the decrease in absolute lean body mass, which was observed in arm 2 but not arm 1 (Table 6 (FIG. 13)).

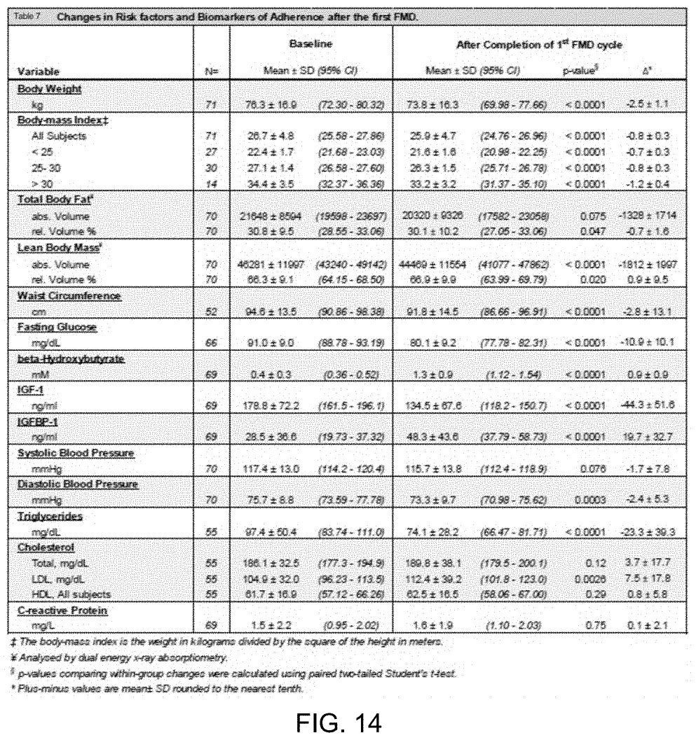

Because the FMD had similar effects in both arms, we combined the results from the two arms to assess the changes in metabolites and risk factors during the first FMD cycle (at day 5 of the FMD and before re-feeding, Table 7 (FIG. 14) and after completion of 3 FMD cycles (5-7 days after terminating the third FMD cycle, Table 6 (FIG. 13))).

At the end of the first FMD cycle and before resuming the normal diet, body weight (p<0.0001), BMI (p<0.0001), absolute lean body mass (p<0.0001), waist circumference (p<0.0001), fasting glucose (p<0.0001), IGF-1 (p<0.0001), diastolic blood pressure (p<0.0003), triglycerides (p<0.0001), and LDL (p<0.0026) were significantly reduced compared to baseline. In contrast, relative lean body mass (p=0.02), β-hydroxybutyrate (p<0.0001) and IGFBP-1 (p<0.0001) were increased. Both absolute and relative total body fat (p=0.075 and p=0.047, respectively), systolic blood pressure (p=0.076), as well as CRP (p=0.75) were not significantly changed after completion of the first FMD cycle compared to baseline (Table 7 (FIG. 14)). These results confirm that subjects did follow the dietary changes imposed by the FMD and responded to them as anticipated.

In subjects who completed 3 FMD cycles (combining both FMD arms) and who returned to the normal diet for 5-7 days, body weight (p<0.0001, N=71), BMI (p<0.0001, N=71), total body fat (absolute and relative p<0.0001, respectively, N=70), trunk fat (absolute p<0.001, relative p=0.0002, N=70), absolute lean body mass (p=0.0001, N=70), waist circumference (p<0.0001, N=52), IGF-1 (p<0.0001, N=69), systolic and diastolic blood pressure (p<0.0001 and p<0.0004, respectively, N=70), total cholesterol (p=0.004, N=55), LDL (p<0.0011, N=55) and HDL (p=0.02, N=55) were significantly reduced and relative lean body mass (p=0.0002, N=70) was increased. Fasting glucose (p=0.28, N=66), β-hydroxybutyrate (p=0.23, N=69), IGFBP-1 (p=0.84, N=69), triglycerides (p=0.16, N=55) and CRP (p=0.052, N=69) were not significantly changed 5-7 days after the third FMD cycle compared to baseline (Table 6 (FIG. 13)). In summary, the combined FMD groups from arm 1 and arm 2 confirmed that the FMD cycles promoted potent effects on many metabolic markers and disease risk factors, which are maintained after subjects return to their normal diet.

FMD Effects Stratified by Baseline Risk Factor Values: A Post-Hoc Observational Pre-Post FMD Comparison.

Age-related physiological changes that lead to increased risk factors occur before diseases can be diagnosed (26, 27). We utilized the aggregated FMD data of both study arms and performed a post hoc analysis of the FMD effect on risk factors for cardiovascular disease and metabolic syndrome, defined as 3 out of 5 of the following conditions: abdominal obesity, elevated fasting glucose, elevated blood pressure, high serum triglycerides, and low HDL cholesterol (8). We selected clinically relevant cut-offs and compared normal and at-risk subjects for each risk factor: total cholesterol >199 mg/dL and LDL cholesterol levels >130 mg/dL are associated with an increased risk of cardiovascular disease (CVD) (28), fasting glucose >99 mg/dL indicates impaired fasting glucose/pre-diabetes (29), triglyceride levels >100 mg/dL (30) as well as CRP >1 mg/L are associated with increased risk for CVD (31). For serum IGF-1, no clinically relevant risk level has been established but a number of epidemiological studies have associated IGF-1 levels above 200 ng/ml with various cancers (24, 32). We therefore compared the effect of FMD cycles on subjects in the highest quartile of IGF-1 expression (>225 ng/ml) with that on subjects with IGF-1 levels ≤225 ng/ml.

In a post hoc analysis, we tested how the changes in the FMD normal and at-risk sub-groups compared to those in the control diet normal and at-risk sub-groups, as defined by their baseline levels of various risk factors (Table 3). We saw a significant benefit of the FMD, but not the control diet, on BMI in all BMI subgroups (p-value for interaction=0.03), although the FMD was particularly beneficial among subjects who were obese (BMI>30) at baseline. The FMD-dependent reduction in IGF-1 was also significantly larger in persons with baseline IGF-1 ≥225 ng/mL (p-value for interaction=0.018) and it was not observed in the two control diet groups.

Next, we evaluated the effect size, i.e. efficacy in normal and at-risk subjects (Table 4) in subjects stratified by risk factor. Subjects with a BMI over 30 (obese) experienced a greater reduction in BMI by the end of the 3 FMD cycles than subjects with a BMI less than 25 (between-group p=0.011), and 25 to 30 (between-group p=0.0011). Systolic blood pressure was reduced by 2.4±6.3 mmHg in subjects with baseline systolic blood pressure ≤120 but by 6.7±6.9 mmHg in subjects with systolic blood pressure >120 (between-group p=0.013), and diastolic blood pressure was reduced by 1.5±5.1 mmHg in subjects with diastolic blood pressure ≤80 but by 5.5±6.4 mmHg in those with baseline levels above 80 (between-group p=0.01). Fasting glucose did not change from baseline levels for participants with baseline levels ≤99 mg/dl but was reduced by 11.8±6.9 mg/dL in participants with baseline fasting glucose over 99 mg/dl (between-group p<0.0001); notably this reduction brought glucose in these subjects within the healthy range. IGF-1 levels in subjects with baseline levels above 225 ng/ml were reduced by 55.1±45.6 ng/mL, nearly 4 times more (between-group p<0.001) than the 14.1±39.9 ng/mL reduction observed in participants with IGF-1 concentrations below 225 ng/ml. Triglyceride levels were reduced more in participants with baseline levels >100 mg/dL (between-group p=0.0035).

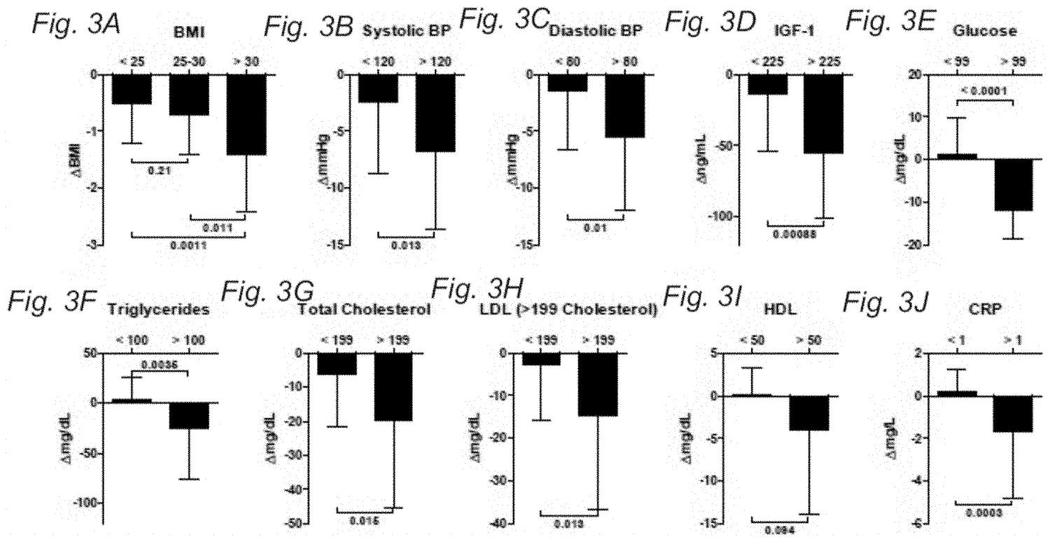

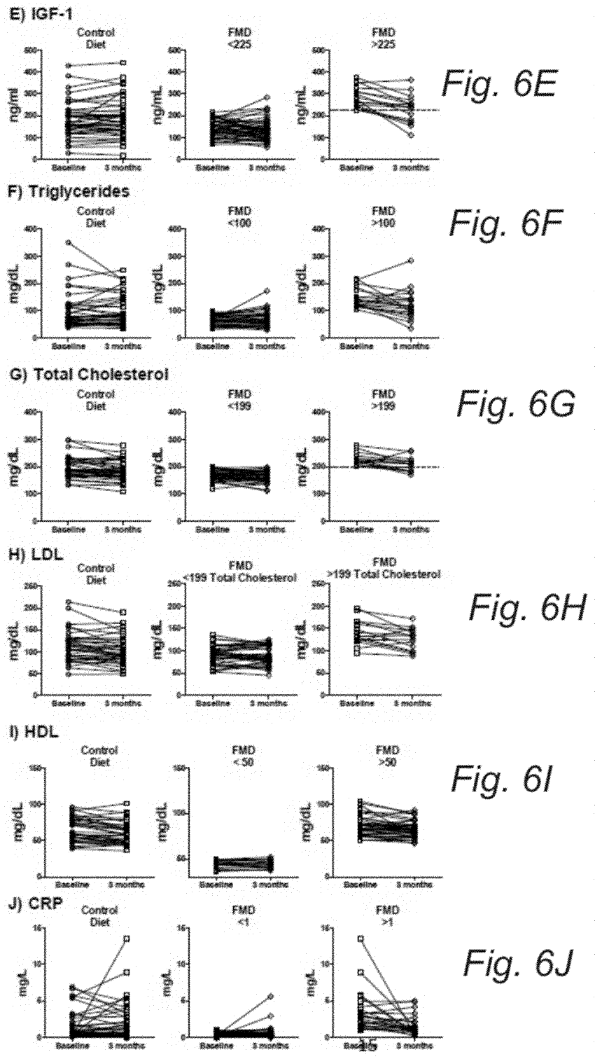

Total cholesterol was reduced significantly more in participants with total cholesterol higher than 199 mg/dL at baseline (between-group p=0.015). LDL was reduced by 14.9±21.7 mg/dL in those with total cholesterol baseline levels above 199 mg/dL but was not reduced by FMD cycles in normal-range subjects (between-group p=0.013). There was no reduction (between-group p=0.094) in HDL levels for those study participants with HDL levels below or above 50 mg/dl at baseline. CRP was not reduced for subjects with levels below 1 mg/L but was reduced by 1.6±1.3 mg/L and returned to the normal levels in most subjects with baseline CRP levels higher than 1 mg/L (between-group p=0.0003). A graphical summary of these data is presented in FIG. 3; before-after dot plots of individual subjects in the control cohort as well as in normal and at-risk subjects in the FMD cohort are presented in FIG. 6.

This post hoc analysis indicates that the FMD had more pronounced effects in at-risk participants than in those subjects who had risk factor values within the normal range, with the exception of HDL. Larger randomized trials are necessary to confirm the results on the efficacy of the FMD in the treatment of patients at risk for diseases.

Voluntary Follow-Up 3-Month after FMD.

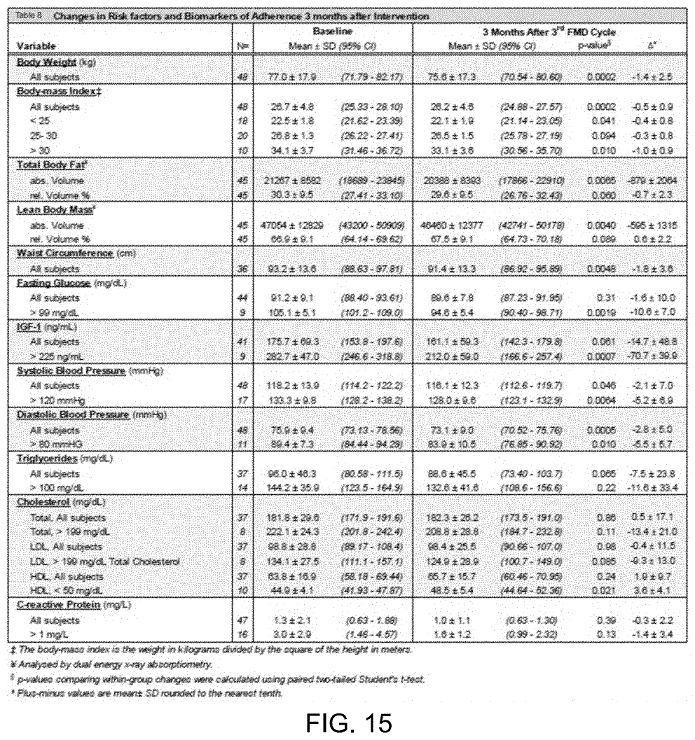

We invited participants to return on a voluntary basis approximately 3 months (actual mean follow up time, 3.2±1.3 months; N=50) after their third and final FMD cycle. In these subjects, the FMD's effects on body weight, BMI, waist circumference, glucose (in at-risk subjects), IGF-1, systolic (in at-risk subjects) and diastolic blood pressure persisted for at least 3 months after the final FMD cycle (Table 8 (FIG. 15))). Subjects with low HDL levels at baseline displayed increased HDL levels at the three months follow-up, while CRP levels remained significantly lower in study participants with baseline CRP levels above 1 mg/L. Notably, some of the at-risk groups include only a few subjects, and thus larger studies are needed to establish long-term effects of the FMD on disease risk factors.

These results indicate that some of the beneficial effects of multiple cycles of the FMD may last for several months. Although subjects were not advised to change their nutrition or exercise regimen after the FMD cycles ended, we cannot rule out that some of the changes after the additional 3 months may be a result of lifestyle changes such as healthier diets and/or improved physical activity after the completion of this trial.

### DISCUSSION

This randomized phase 2 trial indicates that three cycles of a 5-day per month FMD are feasible, safe and effective in reducing body weight, waist circumference and BMI, absolute total body and trunk fat, systolic blood pressure, as well as IGF-1. Metabolic markers such as fasting glucose, triglycerides, CRP, as well as total-, HDL- and LDL-cholesterol, which were within the normal range at baseline, were not significantly affected in the randomized comparison after 3 FMD cycles. After 3 months, subjects from the control arm were crossed over to the FMD intervention. Our post hoc analysis of the aggregated data from all 71 subjects that completed 3 FMD cycles confirmed the effects of the FMD on trunk and total body fat, blood pressure, and IGF-1. A post hoc analysis also allowed us to analyze subjects with elevated risk factors or metabolic markers associated with metabolic syndrome and age-related diseases, such as high BMI, blood pressure, fasting glucose, triglycerides, CRP, cholesterol and IGF-1. The FMD had more pronounced effects on all these markers in at-risk participants than in those subjects who had risk factor values within the normal range, with the exception of HDL. Some of these metabolic markers, namely CRP, systolic/diastolic blood pressure, and serum lipids, have been proposed as markers of biological aging (33). However, other markers affected by the FMD, including IGF-1 and glucose have been strongly implicated in aging and age-related diseases (12, 25, 34).

Study participants were instructed not to alter their lifestyle for the duration of the trial and were allowed to consume food of their choice during the normal diet periods, i.e. subjects were not placed on a pre-specified or calorie-restricted diet. We observed changes that were both positive (total cholesterol and LDL) and negative (HDL) in arm 1 subjects during the control diet period, potentially explained by dietary habit changes in preparation for the FMD, despite no change in weight, BMI, body fat, or lean mass. Similarly, the persistent effects of the FMD three months after study completion that we observed may result from changes in dietary habits and/or physical activity. The composition of the diet tested in this trial was based on the FMD that is known to extend healthspan in mice. Similarly to the study in mice (12), we expect the FMD effects to be mostly independent of an overall caloric restriction, since both groups likely consumed similar levels of calories per month: e.g. estimating a 2000 kilocalorie diet for each of the 25-26 non-restricted days and about 4000 kilocalories for the 5 days of FMD per month, the between group difference in consumed calories is expected to be approximately 10%. In addition, this difference may be overestimated, because it is likely that subjects have an elevated calorie intake after the FMD period, as we have shown for mice (12).) Day 1 of the FMD supplies 4600 kJ (11% protein, 46% fat, 43% carbohydrate), whereas days 2-5 provide 3000 kJ per day (9% protein, 44% fat, 47% carbohydrate); thus fat and complex carbohydrates are the major source of calories in the FMD.

Our studies in cells and mice indicate that both glucose and proteins will interfere with the protective and regenerative effects of fasting (35). Because our previous data indicate that dietary composition can be equally or more important than calorie restriction, it will be important to test the effects of a similarly restricted diet that provides higher proportions of carbohydrates and/or proteins. It remains to be established whether part of the effects of FMD that we observed are mediated by stem cell-based regeneration or rejuvenation, as indicated by our mouse studies (12).

The FMD-induced reduction in serum glucose and IGF-1 is of interest given their role in pro-aging signaling pathways and cancer (24, 36-39). In addition to a marker for insulin resistance and a metabolic input for cancer cells, glucose is associated with cellular sensitization to toxins and senescence (34, 40, 41). Growth hormone receptor deficiency, resulting in reduced IGF-1 levels, is associated with a major reduction in pro-aging signaling, cancer and diabetes in humans (25). The observed reduction in IGF-1 in our study, but not following 6 months of either intermittent energy restriction (IER) (42) or after 6 years of 20% CR (43), is probably related to the long-lasting effects of the low protein/amino acid content of the FMD (average 5 days FMD 11.5% vs. 21% IER or 24% long term CR). In fact, 28 vegans consuming a moderately protein-restricted (10%) diet for about 5 years had reduced IGF-1 levels compared to a group that consumed a chronic 20% calorie restricted diet (43). We also previously showed that IGF-1 levels were positively associated with protein consumption in 2,253 participants of the NHANES cohort (24). Specific ingredients, e.g. high levels of unsaturated fats and micronutrients, may also positively contribute to some of the beneficial effects of the FMD.

It is of note that 25% of the subjects that tested the FMD dropped out of the trial, whereas 10% of the participants opted out of the control arm. This indicates that, despite our efforts to reduce the burden of low calorie/protein diets, adherence to this dietary regimen requires committed study participants. Further, compared to the control diet arm, the FMD arm imposed an additional day-long visit to the clinic, which may have contributed to reduced compliance. Compliance with prescribed therapies, even placebo, may be an identifiable marker for an overall healthy behavior of study participants (44). Thus, this kind of volunteer, who is seeing a benefit and thus not dropping out, could introduce potential bias into the analysis of our trial. The overall comparability at baseline between the control and both FMD arms, as well as the comparable response to the FMD (arm 2 and arm 1 after cross over) suggests no major differences in response for those subjects that completed the trial. Further, those subjects who dropped out of this trial were not different in age or BMI compared to those who completed the trial.

It remains to be established why we experienced a gender difference (82% of dropouts were female). The 25% overall dropout rate (all causes) of study participants before the completion of the 3^{rd} FMD cycle is in the range observed in other trials aimed at evaluating dietary interventions in adults. For example, 16 weeks of dieting in combination with physical exercise yielded a discontinuation rate of approximately 30% (45) and a hypocaloric diet in 28 overweight/obese women resulted in a dropout rate of 40% after 6 months (46). In a trial assessing the effect of intermittent energy/carbohydrate restriction and daily energy restriction on weight loss and metabolic disease risk markers in overweight women, Harvie et al. reported a 23% dropout rate (47). Nonetheless, there are limitations of our trial that should be considered: 1) the relatively small number of subjects in the randomized comparison; 2) despite providing nourishment and calories for the duration of the FMD, we experienced a higher dropout rate during the FMD intervention than in the control arm; 3) the findings that the FMD reduced metabolic markers more effectively in at-risk subjects is based on a non-randomized post hoc analysis of the individual factors in generally healthy participants and thus it needs further evaluation in subjects with diagnosed disease.

Other, less-restrictive diets such as those requiring a very low calorie intake twice a week would impose 8 days per month of a severe restriction compared to the 5 days per month or per several months of a less restrictive intervention tested here (47). Yet an advantage of these diets is that they may not require as much medical supervision as the longer FMD. FMDs or any type of prolonged fasting interventions lasting more than 12 hours, particularly those lasting several days, require supervision, preferably from a healthcare professional familiar with prolonged fasting. Although our results suggest that cycles of the plant-based FMD might be safe for elderly individuals, additional studies are necessary to determine its safety for subjects that are 70 and older.

In summary, and with the limitations outlined above, these results indicate that the periodic FMD cycles are effective in improving the levels of an array of metabolic markers/risk factors associated with poor health and aging and with multiple age-related diseases. As suggested by pre-clinical studies, interventions that promote longevity should also extend healthspan. Further investigations in larger clinical trials focused on subjects with diagnosed metabolic syndrome, diabetes, and cardiovascular diseases as well as subjects at high risk for developing cancer and other age-related diseases are needed.

Methods

Subjects

100 participants without a diagnosed medical condition in the preceding six months were enrolled (clinicaltrials.gov NCT02158897). All participants provided written informed consent and the University of Southern California Institutional Review Board (IRB) approved the protocol. Recruitment of subjects was based on fliers, the clinicaltrials.gov and usc.com websites, and/or word-of-mouth. Because this was a dietary intervention study, it was not possible for participants or all study personnel to be blinded to group assignment. However, study personnel involved in data collection and specimen analysis were blinded to group assignments.

Study Design

Flow of participant enrollment and participation was prepared following the CONSORT standards for randomized clinical trials with crossover design. All data were collected at the USC Diabetes & Obesity Research Institute. Subjects were recruited from April 2013 until July 2015 under protocols approved by the USC IRB (HS-12-00391), based on established inclusion (generally healthy adult volunteers, 18-70 years of age, body mass index: 18.5 and up) and exclusion (any major medical condition or chronic diseases, mental illness, drug dependency, hormone replacement therapy [DHEA, estrogen, thyroid, testosterone], pregnant or nursing female, special dietary requirements or food allergies, alcohol dependency, medications known to affect body weight) criteria. Intention to treat analysis was performed by including all available observations.

Eligible participants were randomly assigned, using a random-number generator, to either arm 1 or arm 2 of the study. All participants completed a health habits questionnaire. Pre-specified outcome measures included safety and feasibility, and evaluation of changes in metabolic risk factors for diabetes and cardiovascular disease and metabolic markers associated with age-related diseases and mortality; these outcomes were measured at baseline, during and after completion of the intervention. Lab examinations included height, weight, body composition (including total and trunk body fat, soft lean tissue, and bone mineral content) measured by dual energy x-ray absorptiometry (DEXA), oscillometric blood pressure measurements and over-night fasting blood draw through venipuncture.

Arm 1 (Control): Participants completed anthropometric measurements and blood collection at enrollment and after 3 months to provide an estimate of non-diet related changes (FIG. 1). Participants were instructed to maintain their regular eating habits. After 3 months, subjects were crossed over to the experimental fasting mimicking diet (FMD) group (FIG. 1).

Arm 2 (Fasting mimicking diet): Participants were instructed to consume the FMD, which was provided in a box, for 5 continuous days, and to return to their normal diet after completion until the next cycle that was initiated approximately 25 days later. Participants completed 3 cycles of this 5-day FMD (FIG. 1). Participants completed baseline and follow-up examinations at the end of the 1^{st} FMD (before resuming normal diet to measure the acute FMD effects) and after a wash out period of 5-7 days of normal caloric intake following the 3^{rd} FMD cycle. An optional follow-up assessment 3 months after the third FMD cycle was offered.

Experimental Fasting Mimicking Diet

The fasting mimicking diet is a plant-based diet designed to attain fasting-like effects on the serum levels of IGF-1, IGFBP1, glucose and ketone bodies while providing both macro- and micronutrients to minimize the burden of fasting and adverse effects (12). Day 1 of the FMD supplies ˜4600 kJ (11% protein, 46% fat, 43% carbohydrate), whereas days 2-5 provide ˜3000 kJ (9% protein, 44% fat, 47% carbohydrate) per day. The FMD comprises proprietary formulations of vegetable-based soups, energy bars, energy drinks, chip snacks, tea, and a supplement providing high levels of minerals, vitamins and essential fatty acids (FIG. 7). All items to be consumed per day were individually boxed to allow the subjects to choose when to eat while avoiding accidentally consuming components of the following day.

Common Terminology Criteria for Adverse Events

Study participants were asked about adverse events at each study visit; events were graded according to the general CTCAE guidelines. See supplementary material for details.

Blood Tests and Serum Markers

Complete metabolic and lipid panels (over-night fasting) were completed at the Clinical Laboratories at the Keck Medical Center of USC and analyzed immediately following the blood draw of each visit. See supplementary material for details.

Statistical Analysis

The primary comparisons of randomized groups involved changes in outcomes observed in the control period of arm 1 vs. the changes observed in the FMD group (arm 2) after completion of 3 FMD cycles. Secondary observational analyses involved (1) comparing the FMD effects in arm 2 (randomized to FMD) vs. arm 1 (receiving FMD after completion of the randomized control period), and (2) summarizing the changes for arms 1 and arm 2 combined after completion of the 1^{st} and 3^{rd} FMD cycles. Changes from baseline were normally distributed. Comparison of changes from baseline within the treatment arms was performed using paired two-tailed Student's t-tests and p-values <0.05 were considered significant. The between-arm comparison of treatment changes from baseline was performed using two-tailed two-sample equal variance t-tests and p-values <0.05 were considered significant. To control for multiple testing, the Benjamini-Hochberg false discovery rate (FDR) method was used. All reported p-values are nominal two-sided p-values; those that met the FDR criteria and remained “significant” at p<0.05 are indicated with an asterisk.

One of the researchers involved in the study generated the random allocation sequence, and enrolled and assigned participants to interventions. But this researcher was not involved in outcome assessments. For this initial randomized trial, the sample size of 100 total subjects was based on detection of a 25% reduction in mean IGF-1, with a two-sided alpha of 0.05 and 70% power. The estimated control group mean (SD) IGF-1 of 194 (97) used published data on males and females, aged 26-40 (48). Statistical analyses were performed on de-identified data. Baseline information and changes from baseline were summarized using mean±standard deviations for subjects randomized to the control (arm 1, N=48) and the diet group (arm 2, N=52). All subjects are included in the arm assigned regardless of treatment adherence (intention to treat); no attempt was made to impute missing values (primarily because if data after completion of the 3rd FMD cycle was not available, other measurement time points were usually unavailable).

In post-hoc subgroup analyses, we compared FMD-control group differences over the randomized trial period (3 FMD cycles vs. control) within high/lower risk subgroups and tested if those treatment effects differed in the higher vs lower risk groups. This subgroup analysis was completed using analysis of variance, with main effects of treatment (FMD, control) and risk group (high, low); the interaction of treatment-by-risk group tested if the randomized FMD effect differed in high vs. low risk groups. In observational analyses of the pre-post FMD changes combining the two treatment arms, pre-post changes in markers within risk subgroups were tested using paired t-test; pre-post changes over risk subgroups were compared using two-sample t-test or analysis of variance.

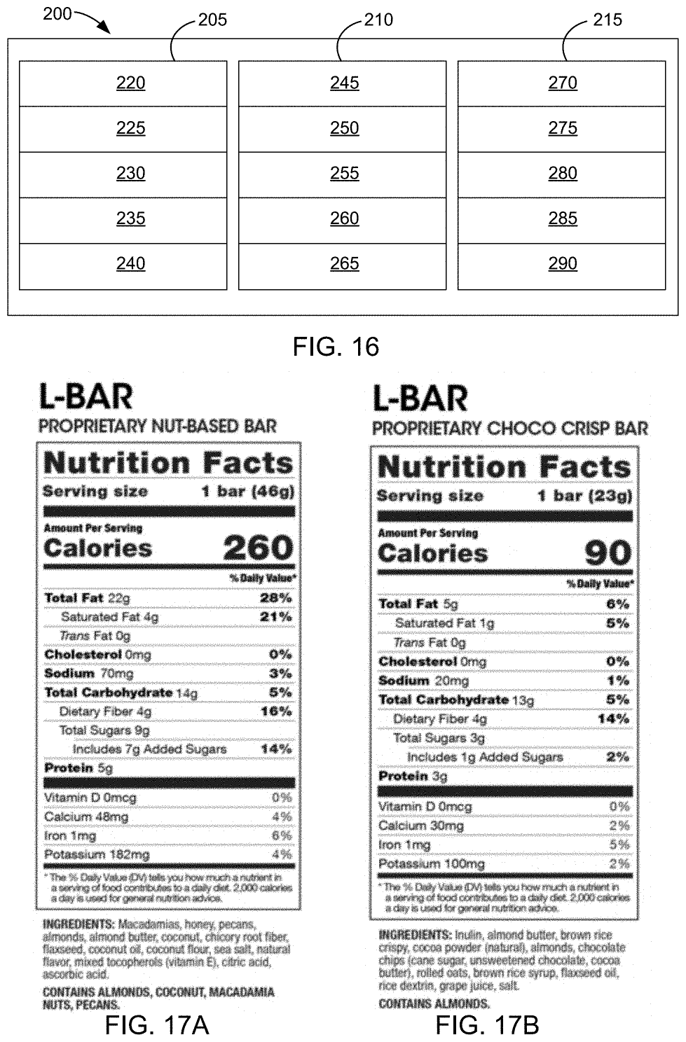

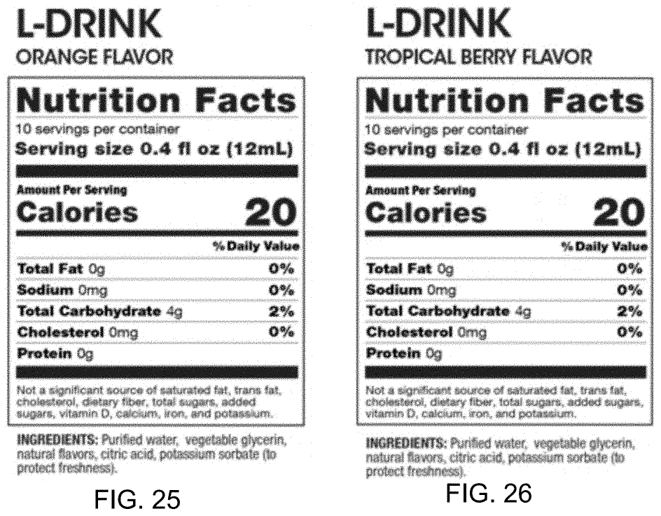

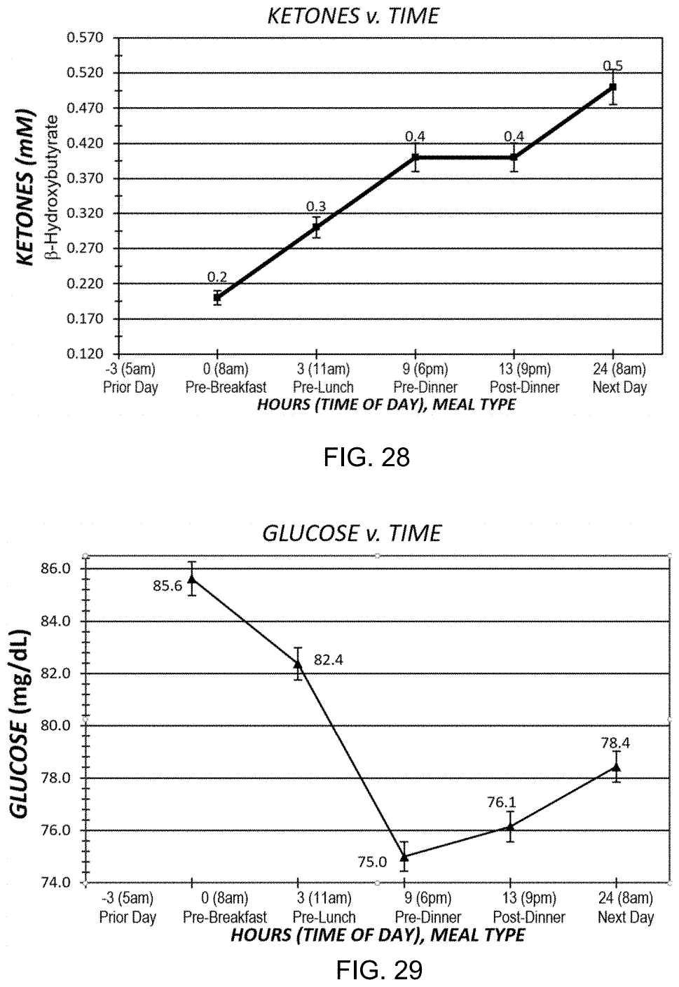

With continuing reference to the preceding materials, data, and figures, attention is now invited also to FIGS. 16 through 29, which reflect further new studies and analyses that were performed using additional variations and modifications of the preceding diet packages and methods of use. These new studies and analyses were directed to single or one-day fasting diet packages and methods of use, and also contemplate use of such FMD packages and methods for fasts having other durations and intermittent fasting uses.

As contemplated herein, the FMD molecular and/or cellular fasting products and methods are enabled by precision-engineered nutrient profiles that sustain the body during fasting, and which are arranged to specifically prevent loss of lean muscle and bone mass, over fasting durations that may span several hours, a single day, a week, and during other periods of time. For example, periodic and intermittent fasting may be accomplished by the FMD packages disclosed herein during single day fasts wherein a subject fasts for one day and then resumes normal feeding the next.

Such intermittent fasting may utilize the disclosed FMD packages for “5-2” fasts wherein a subject eats normally for five days, then fasts for two days using the novel FMD packages of the disclosure (51). A refinement includes use of the new FMD packages during a single fast that alternates with normal eating a first day, followed by fasting the following, second day, and which is repeated for as subsequent days as may be desired or appropriate. In refinements, the described FMD packages are used during single day intermittent fasts wherein eating occurs in a short window of time and fasting is accomplished over longer-periods. These include for example, 2-22, 4-20, 6-18, 8-16, 10-14, and other split-duration intermittent fasts, wherein a subject utilizes the disclosed FMD packages to eat normally during a first short window of time, and fasts during a second window of time of a longer duration than the first (50, 51, 52).

Here, for one example without limitation, a subject engages in an “8-16” intermittent fast, and utilizes the contemplated FMD package to eat normally during a first, short, eight-hour window, while fasting during the second antecedent or subsequent 16-hour window of time, which occurs over a single day. Similar approaches utilize the disclosed one-day fast FMD packages herein for shorter 2, 4, 6, 10 and other eating time periods, and the longer 22, 20, 18, 14, and other fasting time periods (50, 51, 52).

The novel molecular cellular fasting, FMD products of this disclosure enable a subject to benefit from a single day fast and/or an intermittent fast accomplished during a 24-hour period of time. FMDs that incorporate such precision engineered products that have the predetermined nutrient profiles disclosed herein, enable time-restricted and/or intermittent fasts over the 24-hour time period, as well as during fasts performed over hourly, daily, weekly, and other time periods (50, 51, 52).

Such a precision engineered FMD-supplied profile of carbohydrates, protein, fats, and nutrients are precisely adjusted to predetermined ratios and levels. These ratios and levels as described in detail elsewhere herein are engineered to fall below the detection threshold of the nutrient sensors in the cells. This causes the cells of a subject to enter into a true fasting state that is nearly identical to when they are exposed to a water only, behavioral type of fast. The precise formulation of specific ratios and levels of carbohydrates, protein, fats, and nutrients establishes the precision engineered food constituents provided by the FMD and by the FMD portions and packages, which enables sustainable molecular and/or cellular fasting without detrimental consequences.

These studies and analyses revealed unexpected, beneficial effects similar to those already described elsewhere herein, even though the products and methods were constrained to a single or one-day fasting protocol. For example, one such study includes 8 participants, all without a diagnosed medical condition in the preceding six months, which were informally invited to participate in controlled consumption of a one-day fast diet package. The contemplated one-day fast diet package is depicted schematically in FIG. 16.

An exemplary one-day fast diet package 200 (FIG. 16) includes multiple constituents and/or compositions, which may be grouped into meal portions, such as meal portions 205, 210, and/or 215 or others, which may be for example and without limitation be consumed at one time and together, or which may be consumed in meal portions that are spaced apart over time during a single day. Such meal portions may be grouped as a breakfast meal portion 205, a lunch meal portion 210, and/or a dinner meal portion 215 for consumption separately during the contemplated single day fast period of time.

In further arrangements, meal portions 205, 210, and 215 may incorporate discrete and sub-packaged meal items or components or constituents. For example, meal portion 205, which may in one example be a breakfast meal portion, further includes a nut-containing nutrition bar composition 220, a micronutritional vegetable powder composition that incorporates vitamin and mineral supplements 225 (herein also sometimes referred to as an “NR-1” supplement), an algal oil composition 230, and other possible items such as teas or other constituents 235 and 240. These examples also are directed to meal portion 210 including a first soup composition 245, a kale cracker composition 250, and many additional, possibly preferred items such as an olive composition or teas or other constituents 255, 260, and 265.

In another illustrative arrangement of the one-day FMD package, meal portion 215, which may be a dinner meal portion will include a second soup composition 270, one of either the kale cracker composition 275 and/or an olive containing composition 280, a second nut-containing nutrition bar composition 285, and teas and other possibly predetermined items or constituents 290.

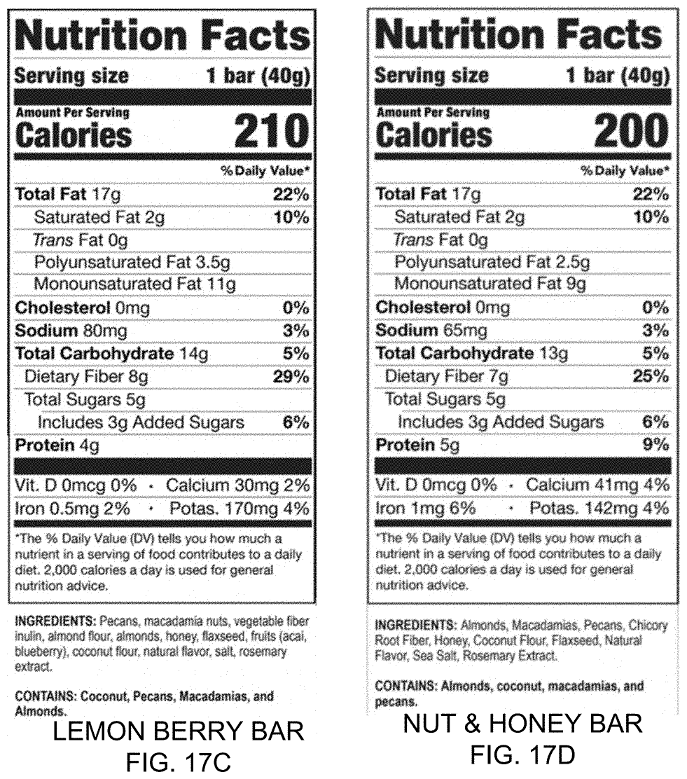

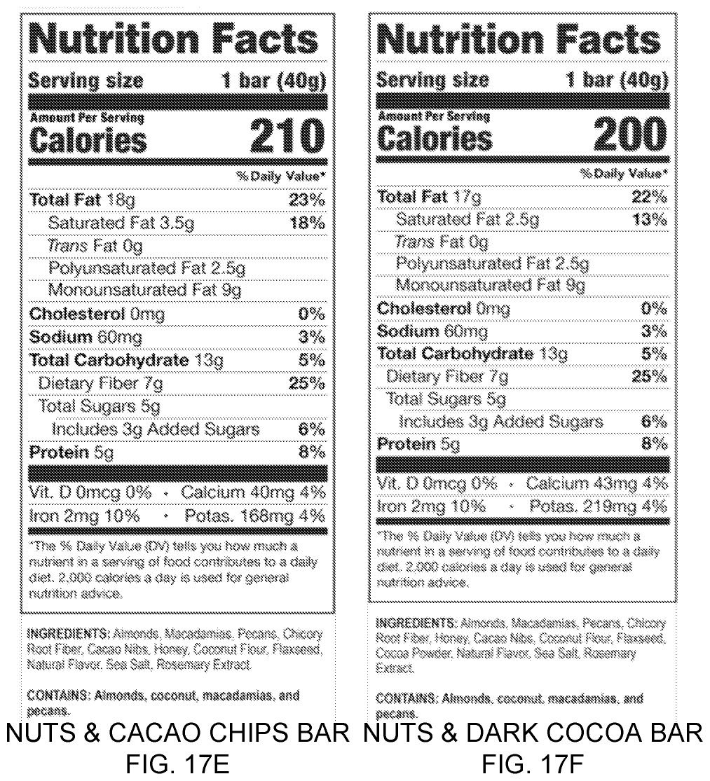

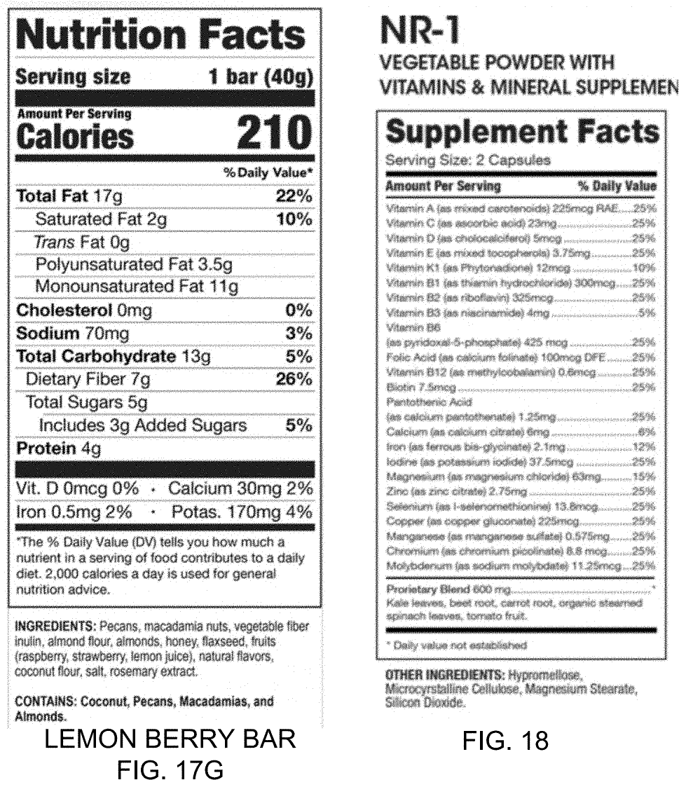

FIGS. 17 through 26 further illustrate many various and interchangeable constituents and/or compositions, which may be utilized in the contemplated one-day fast diet package, and which may be grouped into meal portions as described further below.

One-Day Fast FMD Study Design

Participant enrollment and participation for this one-day fast diet package study was prepared informally for initial analyses. Subjects were recruited and participated during November, 2021 with an informal protocol based on inclusion of four males and four females that are generally healthy, 31 to 56 years of age, and generally known to be without any major medical condition or chronic diseases, mental illness, drug dependency, hormone replacement therapy [DHEA, estrogen, thyroid, testosterone], pregnant or nursing female, special dietary requirements or food allergies, alcohol dependency, or medications known to affect body weight.

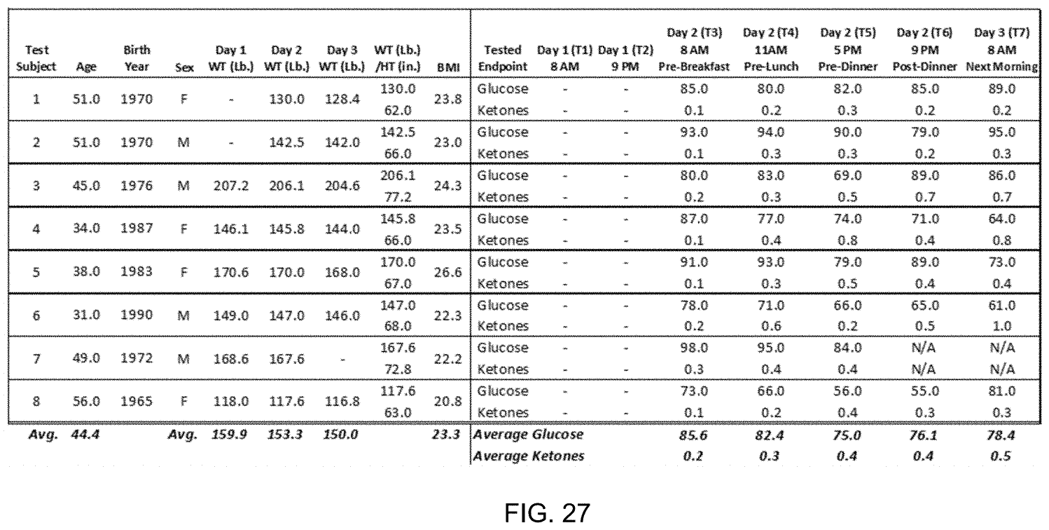

Pre-specified outcome measures during the one-day fast and consumption of the contemplated diet package compositions, included only blood glucose and ketone testing. This testing was accomplished with consumer test equipment that included a Precision Xtra® Blood Glucose & Ketone Monitoring System, available from Abbott at https://abbott.com as SKU or product number 9881465. Each glucose and ketone test utilized this equipment and corresponding blood ketone and glucose test strips that are compatible for use with the Precision Xtra® System. Five test data points were recorded for each participant over a one-day fast test period of time spanning 24 hours. The recorded test data is reflected in FIG. 27, which is described in more detail below.

Informal examinations of each participant included height, weight, and calculated body composition or body mass index (BMI) using participant height and weight and a method published by the United States Centers for Disease Control and Prevention, wherein BMI equals participant weight in pounds divided by the square of height in inches and multiplied by 703. The BMI calculation was accomplished using an average weight for each participant. FIG. 27 reflects the averages that were calculated from participant weight measurements taken before commencing the one-day fast (Day 1), at the completion of the one-day or 24 hour fast (Day 2), and the day after (Day 3).

The participants were instructed to consume the one-day fast FMD meal portions at predetermined times, and no other foods during the 24 hour period of the one-day fast. The one-day fast FMD package was provided with meal portions that grouped the FMD package constituents into three meal portions, one each for breakfast, lunch, and dinner.

As reflected in FIGS. 27, 28, and 29, prior to consuming each of the meal portions, participants each completed five measurements of blood glucose and ketones, during the span of the one-day fast and use of the FMD package.

Experimental One-Day Fasting Mimicking Diet

Similar to previously described variations, the one-day FMD is a plant-based diet designed, among other benefits, to attain fasting-like effects on the serum levels of IGF-1, IGFBP1, glucose and ketone bodies while providing both macro- and micronutrients that minimize the burden and discomfort of fasting, as well as possible adverse effects (12). Compositions of the package are portioned as described herein, and in the accompanying figures, to attain fasting-like effects on serum levels of IGF-1, IGFBL1, glucose, and ketone bodies while providing both macronutrients and micronutrients to minimize the burden of fasting and adverse effects, and without starvation of the subject.

The one-day FMD package comprises proprietary formulations of vegetable-based soups, energy bars, energy drinks, chip snacks, tea, and a supplement providing high levels of minerals, vitamins and essential fatty acids, which items or constituents are described in FIGS. 17A-17G, 18, 19, 20, 21A-21I, and 22 through 26. All items to be consumed during the one day fast per day were discretely portioned and packaged according to the depictions in these noted figures, and grouped into the respective breakfast, lunch, and dinner meal portions as reflected in FIG. 16 and as described in one exemplary arrangement shown below in the “One-Day FMD Meal Schedule” Tables A and B.

These tables reflect two exemplary arrangements that may be selected, of myriad possible contemplated meal schedules. Those knowledgeable in the field should appreciate these schedules may be adjusted using any of the other comparable components and constituents that are described in the noted figures, which can be substituted for each of those items in the illustrative schedule examples. The participants consumed each meal portion only after testing their blood glucose and ketone levels.

TABLE A
One-Day FMD Meal Schedule
MEAL PLAN—ONE-DAY Fasting Mimicking Diet

| | | | |
|---|---|---|---|
| COMPONENTS (meal portions) | BREAKFAST | LUNCH | DINNER |

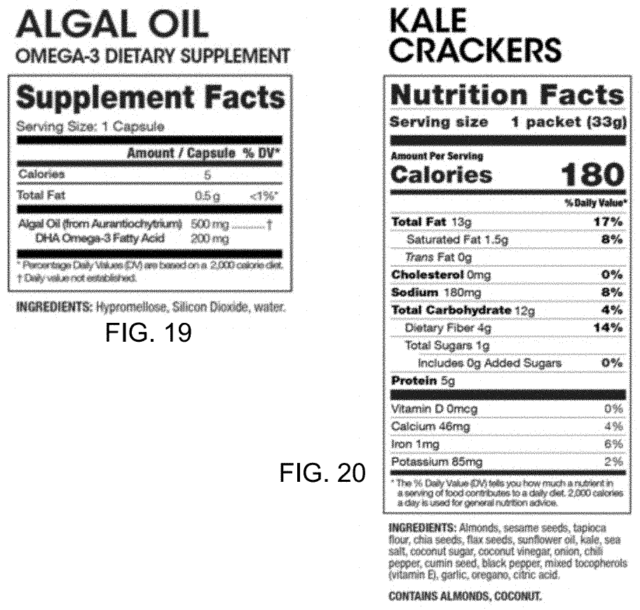

BREAKFAST MEAL PORTION (205)

| | | | |
|---|---|---|---|
| Nut-containing nutrition bar (220) | 1 | — | — |
| (any item of FIGS. 17A-7G) | | | |
| Algal oil (230) (FIG. 19) | 2 | — | — |
| NR-1 (225) (FIG. 18) | 2 | — | — |

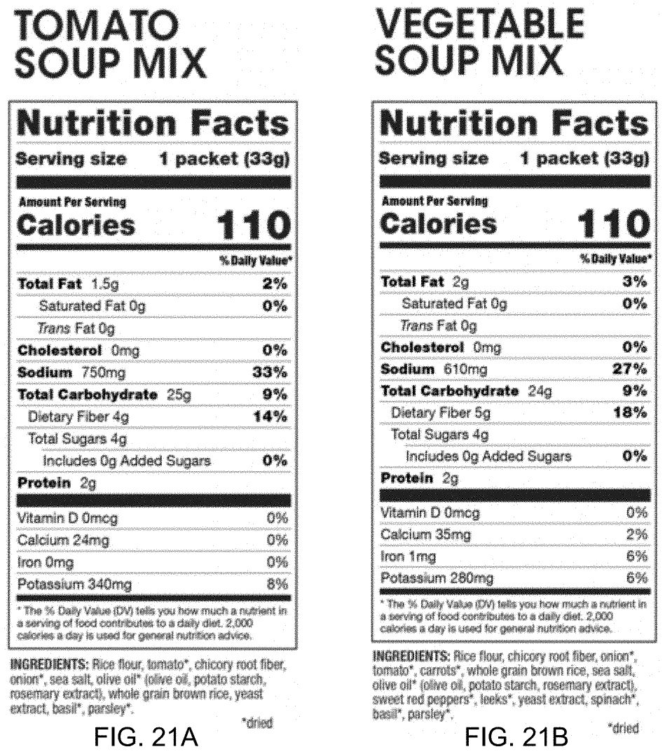

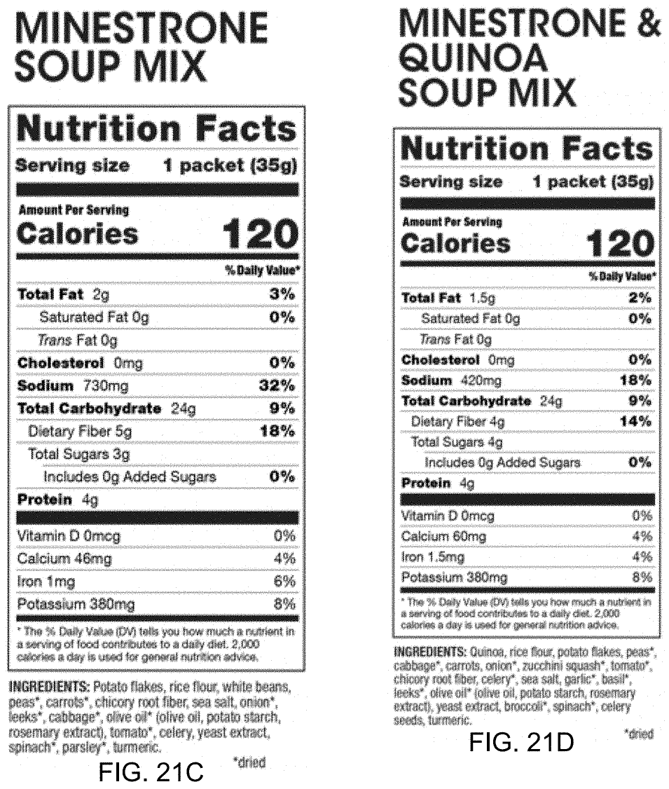

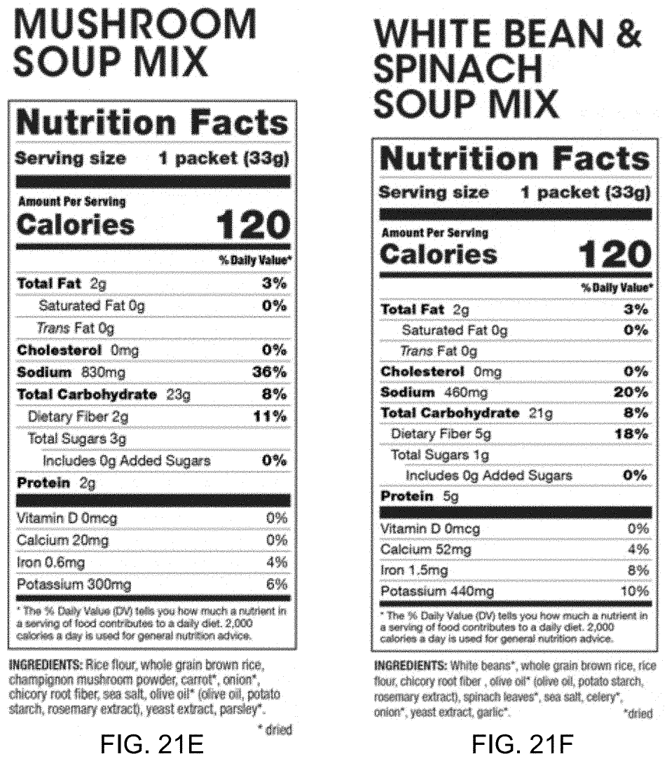

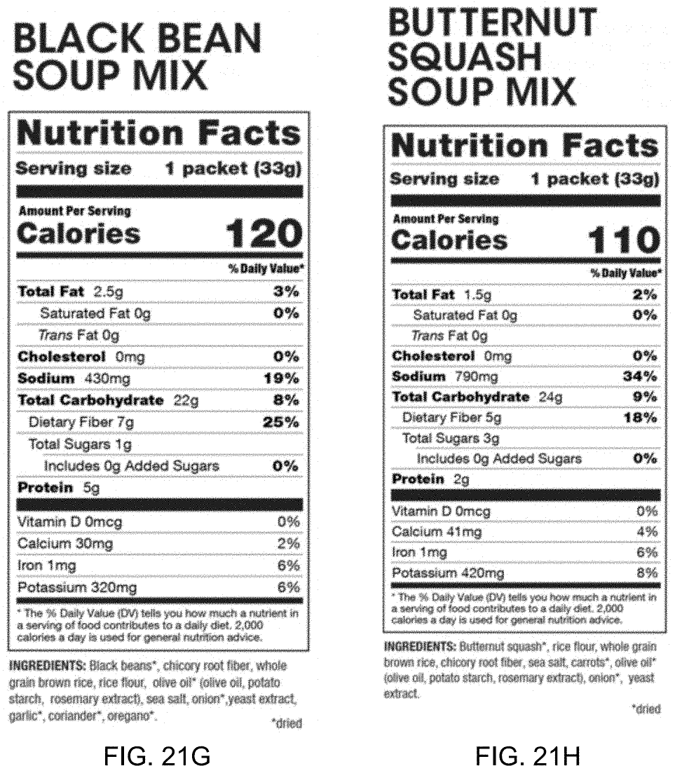

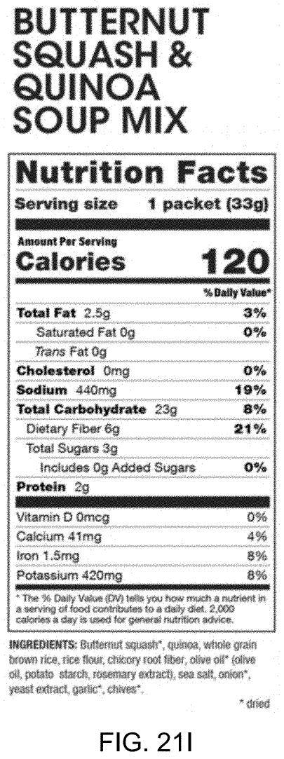

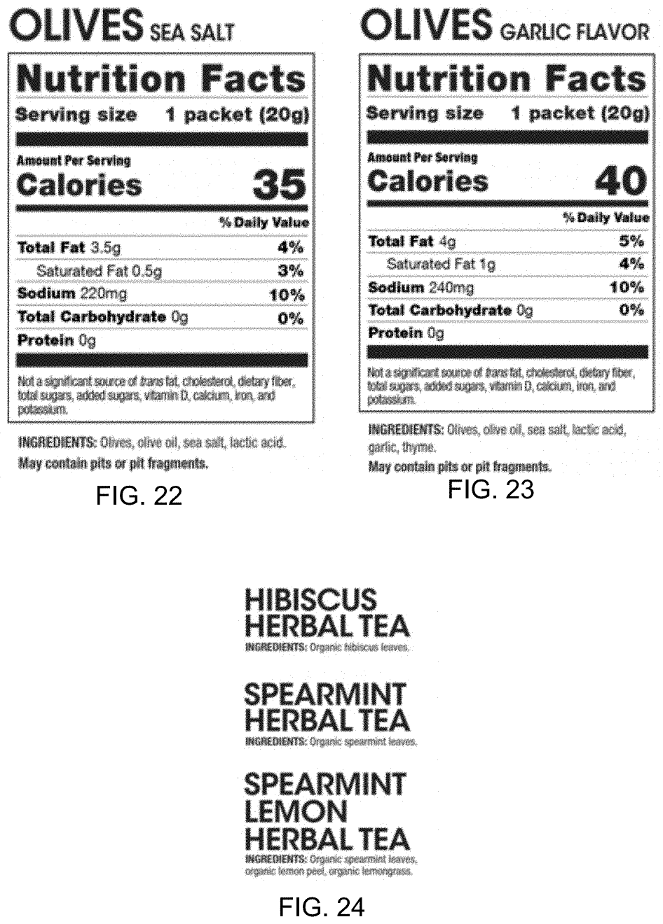

LUNCH MEAL PORTION (210)

| | | | |
|---|---|---|---|
| Tomato soup composition (245) | — | 1 | — |
| (FIGS. 21A-21I) | | | |
| Kale cracker composition (250) | — | ½ (50%) | — |
| (FIG. 20) | | | |
| Olive—containing | — | 1 | — |
| composition (255) | | | |
| (FIGS. 22, 23) | | | |

DINNER MEAL PORTION (215)

| | | | |
|---|---|---|---|
| Butternut squash soup composition | — | — | 1 |
| (270) | | | |
| (FIG. 21H) | | | |
| Kale cracker composition (275) | — | — | ½ (50%) |
| (FIG. 20) | | | |
| Nut—containing nutrition | — | — | 1 |
| bar (285) | | | |
| (FIGS. 17B) | | | |

OPTIONAL—PARTICIPANTS MAY CONSUME ANYTIME

| Tea—Spearmint | Optional (240, 265, 290) (FIG. 24) |
|---|---|
| Tea—Lemon Spearmint | |
| Tea—Hibiscus | |

TABLE B
One-Day FMD Meal Schedule
MEAL PLAN—ONE-DAY Fasting Mimicking Diet

| | | | |
|---|---|---|---|
| COMPONENTS (meal portions) | BREAKFAST | LUNCH | DINNER |

BREAKFAST MEAL PORTION (205)

| | | | |
|---|---|---|---|
| Nut-containing nutrition bar (220) | 1 | — | — |
| (any item of FIGS. 17A-7G) | | | |
| Algal oil (230) (FIG. 19) | 2 | — | — |
| NR-1 (225) (FIG. 18) | 2 | — | — |

LUNCH MEAL PORTION (210)

| | | | |
|---|---|---|---|
| Tomato soup composition (245) | — | 1 | — |
| (FIGS. 21A-21I) | | | |
| Kale cracker composition (250) | — | 1 | — |
| (FIG. 20) | | | |
| Olive—containing composition (255) | — | 1 | — |
| (FIGS. 22, 23) | | | |

DINNER MEAL PORTION (215)

| | | | |
|---|---|---|---|
| Butternut squash soup composition | — | — | 1 |
| (270) | | | |
| (FIG. 21H) | | | |
| Kale cracker composition (275) | — | — | 1 |
| (FIG. 20) | | | |
| Nut—containing nutrition bar (285) | — | — | ½ (50%) |
| (FIGS. 17B) | | | |

OPTIONAL—PARTICIPANTS MAY CONSUME ANYTIME

| Tea—Spearmint | Optional (240, 265, 290) (FIG. 24) |
|---|---|
| Tea—Lemon Spearmint | |
| Tea—Hibiscus | |

It was observed from the test data of the one-day fast, as reflected in FIGS. 27, 28, and 29, that the ketone blood levels beneficially but unexpectedly increased for each participant, while their glucose blood levels decreased. More specifically, it was observed that the average ketone blood level of all participants evidenced ketogenic effects, and increased from 0.2 mM to 0.5 mM over the duration of the 24-hour, one-day fasting period. The average glucose level of all participants decreased from about 85 mg/dL to as low as about 75 mg/dL, while returning to only about 78 mg/dL at the end of the 24-hour fast.

In variations of these one-day fast examples, various arrangements of the meal portions and constituents thereof are contemplated, as schematically represented in FIG. 16 and the preceding meal schedules A and B. For example, one arrangement of a fasting mimicking diet package 200 includes breakfast 205, lunch 210, and dinner 215 meal portions for a one-day fast.

An exemplary breakfast meal portion 205 includes a first nut-containing nutrition bar composition 220 (see, e.g., any of those described in FIGS. 17A-17G), a micronutritional vegetable powder composition 225 including vitamin and mineral supplements (see, e.g., FIG. 18), and an algal oil composition 230 (see, e.g., FIG. 19). An example lunch meal portion 210 includes a first soup composition 245 (see, e.g., one of those reflected in FIGS. 21A-21I) and a kale cracker composition 250 (see, e.g., FIG. 20). An illustrative dinner meal portion 215 includes a second soup composition 270 (see, e.g., any of those described in FIGS. 17A-17G), one of either the kale cracker composition 275 (see, e.g., FIG. 20) or an olive containing composition 280 (see, e.g., one of those of FIGS. 22 and 23), and a second nut-containing nutrition bar composition 285 (also see, e.g., one of those of FIGS. 17A-17G).

A modified FMD package 200 (FIG. 16) also includes tea compositions (see, e.g. FIG. 24) that each include at least one of lemon, hibiscus, and spearmint tea, and combinations thereof and others, which may be consumed any time during the 24-hour period of the one-day fast. In refinements, tea compositions such as those of FIG. 24 may be consumed as a breakfast item 235, 240, a lunch item 255, 260, and 265, and a dinner item 290. In other variations, energy drinks may be consumed as a different breakfast constituent 235, 240, lunch item 255-265, or dinner constituent 290.

Further variations include the first nut-containing nutrition bar 220 containing almonds, macadamias, and pecans with predetermined nutrition profiles of fat, carbohydrates, and proteins (FIGS. 17A and 17C-17G), and/or the algal oil composition having a nutrition profile that includes DHA Omega-3 fatty acid and optionally at least one of aurantiochytrium and schizocatrium algae oil (FIG. 19). The FMD diet package 200 in other adaptations incorporates the second nut-containing nutrition bar composition 270 having a nutrition profiles that includes inulin, almonds, almond butter, brown rice crispy, cocoa powder, chocolate chips, rolled oats, flaxseed oil, rice dextrin, grape juice, and salt (see, e.g., FIG. 17B).

These arrangements also contemplate variations wherein the second nut-containing nutrition bar composition 270 is sized with a portion size that is half of the first nut-containing nutrition bar and includes almonds, macadamias, pecans, honey, flaxseed, coconut flour, and rosemary extract (see, e.g., FIG. 17A). Also, the nut-containing nutrition bars may optionally contain almonds, macadamias, and pecans and may in other modifications contain honey, flaxseed, coconut flour, and rosemary extract (see, e.g., FIGS. 17A and 17C-17G). These examples may be further modified to have the half-sized nut-containing nutrition bars 270 containing almonds, macadamias, and pecans, and/or one or more of chicory root fiber, tocopherols, acai, blueberries, cacao nibs, cocoa powder, raspberries, strawberries, and lemon juice (see, e.g., FIGS. 17A and 17C-17G).

In variations, the first and second FMD nut-containing nutrition bar compositions 220, 285 are formulated to provide from about 90 kcal to about 350 kcal per serving, or between about 90 kcal and 260 kcal per serving (see, e.g., FIGS. 17A, 17B), or optimally between about 200 kcal and 210 kcal per serving (see, e.g., FIGS. 17C-17G).

In refinements, the first and second FMD nutrition bar compositions are precisely formulated to provide about 10 grams to about 35 grams of total fat per serving, and in variations between about 5 grams and 22 grams of total fat per serving. In a further refinement, the first and second FMD nutrition bars are formulated to provide less than about 20 grams of saturated fat per serving and optionally, less than about 5 grams of trans-unsaturated fatty acids (hereafter “trans fat”) (optimally, less than 1 gram of trans fat). Further modifications contemplate the first and second FMD nutrition bars having between about 17 grams and 18 grams of total fat per serving.

Each of these refinements further contemplate the first and second FMD nut-containing nutrition bar compositions having no trans fat, and saturated fat of between about one gram and four grams per serving, and more preferably between about two grams and 3.5 grams per serving. Further modification contemplate each of the first and second nut-containing nutrition bar compositions containing polyunsaturated fat ranging between about 2.5 grams and about 3.5 grams, and monounsaturated fat between about 9 grams and about 11 grams.

In a refinement, each of the first and second FMD nutrition bar compositions is formulated to provide less than about 10 grams of protein per serving. In a further refinement, the first and second FMD nutrition bar compositions are precisely formulated to provide from about one to about 8 grams of protein per serving. In a further refinement, the first and second FMD nut-containing nutrition bar compositions are formulated to provide between about 2 grams and 6 grams of protein per serving, or between about 4 grams and 5 grams of protein per serving.

In still another refinement, each of the first and second FMD nut-containing nutrition bar composition is precisely formulated to provide less than about 30 grams of carbohydrates per serving. In a further refinement, these nutrition bar compositions are formulated to provide between about 8 grams and about 25 grams of carbohydrates per serving. In still other refinements, the first and second FMD nutrition bar compositions are each formulated to provide from about 10 to 18 grams of carbohydrates per serving.

Still other modifications contemplate each FMD nut-containing nutrition bar composition having between about 13 grams and about 14 grams of total carbohydrates per serving. Other arrangements of the first and second FMD nutrition bar compositions provide total sugar between about 3 grams and about 9 grams, or about 5 grams of total sugar per serving. In any of these variations, the first and second FMD nut-containing nutrition bar compositions are precisely formulated to have between about one gram and about 7 grams, or at most about 3 grams of added sugar per serving.

The first and second FMD nutrition bar compositions can be formulated within these limits with any combination of macadamia nuts, honey, pecans, almonds, almond butter, coconut flour, sea salt, mixed tocopherols (vitamin E), citric acid, and ascorbic acid. Refinements also include the first and second nut-containing nutrition bar compositions being precisely formulated within these limits with any combination of inulin, almond butter, brown rice crispy, cocoa powder, almonds, chocolate chips (cane sugar, unsweetened chocolate, cocoa butter), rolled oats, brown rice syrup, flaxseed oil, rice dextrin, grape juice, and salt.

The one-day fast FMD packages 200 also include the micronutritional vegetable powder with vitamin and mineral supplements composition 225 containing Vit A, Vit C, Ca, Fe, Vit D3, Vit E, Vit K, Vit B1, Vit B2, Vit B3, Vit B5, Vit B6, Vit B7, Vit B9, Vit B12, Cr, Cu, I, Mg, Mn, Mo, Se, and Zn (see, e.g., FIG. 18). Similarly, it is optionally preferred that the micronutritional vegetable powder with vitamin and mineral supplements composition 225 contains ascorbic acid, beet root powder, beta carotene, calcium carbonate, carrots, cholecaliciferol, chromium picolinate, collard leaf powder, cupric sulfate, cyanocobalamin, Dl-alpha tocopherol acetate, ferrous fumarate, folic acid, kale leaf, magnesium stearate, manganese sulfate, niacinamide, pantothenic acid, phytonadione, potassium iodine, pyriodoxine HCl, riboflavin, sodium molybdate, sodium selenate, spinach, thiamine mononitrate, tomatoes, tribasic calcium phosphate, and zinc oxide (FIG. 18).

The micronutritional vegetable powder with vitamin and mineral supplements composition 225 also otherwise may include, for further example, Vit A, Vit C, Vit D, Vit E, Vit K 1, Vit B 1, Vit B2, Vit B3, Vit B6, Vit B12, folic acid, biotin, pantothenic acid, calcium, iron, iodine, magnesium, zinc, selenium, copper, manganese, chromium, molybdenum, kale leaves, beet root, carrot root, spinach leaves, and tomato (FIG. 18).

Any of the one-day fast FMD packages 200 also are arranged to have the kale cracker composition 250 to include almonds, kale, sesame seeds, and tapioca flour, and/or almonds, kale, sesame seeds, tapioca flour, chia seeds, flax seeds, sunflower oil, salt, coconut sugar and vinegar, onion, chili pepper, cumin seed, black pepper, garlic, tocopherols, oregano, and citric acid (see, e.g., FIG. 20).

In a refinement, each FMD soup composition, such as for example soup compositions 245 and 270, is formulated to provide from about 80 kcal to 150 kcal per serving, and optionally between about 110 kcal and 120 kcal (see, e.g. FIGS. 21A-21I). In the context of formulations, “provide” also means “contains” and “includes.” In modifications, each FMD soup is formulated to provide about 1 to 5 grams of total fat per serving, and optionally between about 1.5 grams and 2.5 grams of total fat per serving. In a further refinement, each FMD soup is formulated to provide less than about one gram of saturated fat per serving and less than about 5 grams of trans fat (optimally, less than one gram of trans fat). Modifications include such FMD soups to have substantially no saturated or trans fat.

In a refinement, each FMD soup composition is precisely formulated to provide less than about 10 grams of protein per serving. In a further refinement, each FMD soup is formulated to provide from about 1 to 8 grams of protein per serving. In a further refinement, each FMD soup is formulated to provide from about 2 to 6 grams of protein per serving, and optimally between about 2 and 5 grams of protein per serving.

In other refinements, each FMD soup is precision formulated to provide less than about 40 grams of carbohydrates per serving. In a further refinement, each FMD soup is formulated to provide from about 10 to 35 grams of carbohydrates per serving. In still another variation, each FMD soup is formulated to provide from about 20 to 30 grams, and more preferably between about 22 and 25 grams of carbohydrates per serving. In any of the contemplated precision engineered FMD soup formulations, further modifications are directed to carbohydrate total sugar content limited to between about 1 and 4 grams per serving, and optimally substantially no added sugars.

The FMD soups can be formulated within these exemplary limits from any combination of components selected from the group consisting of black beans, butternut squash, quinoa, tomatoes, mushrooms, white beans (e.g., great northern beans), brown beans, spinach, green tea extract, rice flour, onions, brown rice powder, carrots, inulin, leeks, olive oil, cabbage, potatoes, olives, peas, pumpkin, maltodextrin, and celery, chicory root fiber, sea salt, yeast, basil, parsley, garlic, rosemary extract, coriander, oregano, potato starch, potato flakes, zucchini squash, turmeric.

In refinements, the FMD soups can also be precisely formulated within these limits from a first component selected from the group consisting of black beans, butternut squash, quinoa, tomatoes, mushrooms, white beans (e.g., great northern beans), brown beans, spinach, and combinations thereof and a second component selected from the group consisting of green tea extract, rice flour, onions, brown rice powder, carrots, inulin, leeks, olive oil, cabbage, potatoes, olives, peas, pumpkin, maltodextrin, and celery, chicory root fiber, sea salt, yeast, basil, parsley, garlic, rosemary extract, coriander, oregano, potato starch, potato flakes, zucchini squash, turmeric, and combinations thereof. Typically, the FMD soups are provided as a powder that can be combined with water to form the soup, typically, with heating.

Exemplary FMD soups include for example without limitation, vegetable soups, quinoa-containing minestrone soups, mushroom-containing soup, tomato-containing soup composition, bean-containing minestrone soup composition, pumpkin soup composition, white bean and spinach soup, back bean soup, butternut squash soup, butternut squash and quinoa soup, and a vegetable broth. One example of a vegetable soup composition includes onions, tomatoes, spinach, green tree extract, optionally rice flour, optionally brown rice powder, optionally carrots, leeks, and optionally inulin. An example of a quinoa-containing minestrone soup composition includes quinoa, green tea extract, optionally olive oil, optionally cabbage, optionally potatoes, optionally rice flour, and optionally tomatoes and optionally no turmeric.

A vegetable soup composition example includes carrots, inulin, leeks, onions and rice flour. A specific example of a mushroom-containing soup composition includes mushrooms, green tea extract, optionally brown rice powder, optionally carrots, and optionally inulin. A specific example of a mushroom-containing soup composition includes carrots, inulin, mushrooms, onions, and rice flour.

A specific example of a tomato-containing soup composition includes tomatoes, green tea extract, optionally inulin, and optionally onions. A different tomato-containing soup example composition includes tomatoes, inulin, olives, onions, potatoes, and rice flour. A specific example of a quinoa-containing minestrone soup composition includes quinoa, green tea extract, optionally olive oil, optionally cabbage, optionally potatoes, optionally rice flour, and optionally tomatoes and optionally no turmeric. A refinement of a quinoa-containing minestrone soup composition contains quinoa, green tea extract, optionally olive oil, optionally cabbage, and optionally potatoes, optionally rice flour, and optionally tomatoes and optionally no turmeric.

An exemplary bean-containing minestrone soup composition includes white beans (e.g., great northern beans), great tea extract, optionally cabbage, and optionally potatoes. In a refinement, the bean-containing minestrone soup composition includes brown beans, carrots, peas, potato, and rice flour. An example of a pumpkin soup composition includes pumpkin, green tree extract, optionally rice flour, optionally carrots, and optionally brown rice powder. A specific example of a first vegetable broth includes carrots, maltodextrin, celery, spinach, and tomatoes. Another example of a vegetable broth includes carrots, maltodextrin, celery, spinach, and tomatoes.

A white bean and spinach soup exemplary composition includes white beans, whole grain brown rice, rice flour, chicory root fiber, olive oil, spinach leaves, sea salt, celery, onion, yeast extract, and garlic. A specific example of a black bean soup composition includes black beans, chicory root fiber, whole grain brown rice, olive oil, potato starch, rosemary extract, sea salt, onion, yeast extract, garlic, coriander, and oregano.

A specific example of a butternut squash composition includes butternut squash, rice flour, whole grain brown rice, chicory root fiber, sea salt, carrots, olive oil, potato starch, rosemary extract, onion, and yeast extract. A specific example of a butternut squash and quinoa composition includes butternut squash, quinoa, whole grain brown rice, rice flour, chicory root fiber, olive oil, potato starch, rosemary extract, sea salt, onion, yeast extract, garlic, and chives.

Still more exemplary arrangements of the one-day fast FMD package 200 of FIG. 16 incorporate the first and second soup compositions to each include at least rice flour, chicory root fiber, onion, olive oil, and yeast extract. These modifications may also otherwise include the first and second soup compositions 245, 270 to incorporate rice flour, chicory root fiber, onion, olive oil, salt, and yeast extract, and/or one or more of basil, parsley, whole grain brown rice, sweet red peppers, leeks, spinach, cabbage, tomato, celery, turmeric, quinoa, potato flakes, peas, carrots, zucchini squash, broccoli, celery seeds, mushroom powder, white beans, black beans, garlic, coriander, oregano, butternut squash, and chives.

The one-day FMD also contemplates that the first and second soup compositions in modified variations will each include rice flour, chicory root fiber, onion, olive oil, salt, and yeast extract, and wherein each of the first and second soup compositions incorporates one of:

(a) mushroom soup constituents that include parsley, whole grain brown rice, rice flour, carrots, and mushroom powder,

(b) tomato soup constituents that include tomato, basil, parsley, and whole grain brown rice,

(c) vegetable soup constituents including basil, parsley, whole grain brown rice, sweet red peppers, leeks, spinach, tomato, and carrots,

(d) minestrone soup constituents, which include parsley, leeks, spinach, cabbage, tomato, celery, turmeric, potato flakes, peas, carrots, and white beans,

(e) minestrone soup constituents having quinoa, basil, parsley, whole grain brown rice, leeks, spinach, cabbage, tomato, celery, turmeric, potato flakes, peas, carrots, zucchini squash, broccoli, celery seeds, garlic,

(f) white bean and spinach soup constituents that include whole grain brown rice, spinach, celery, white beans, and garlic,

(g) black bean soup constituents that include whole grain brown rice, black beans, garlic, coriander, and oregano,

(h) butternut squash soup constituents that include whole grain brown rice, carrots, butternut squash, and chives, and

(i) butternut squash and quinoa soup constituents that include whole grain brown rice, quinoa, butternut squash, garlic, and chives.

Each or any of the various arrangements of prior-described multi-day FMD packages 10, as well as the contemplated one-day fast FMD packages 200 further may be adapted wherein the combination of the breakfast, lunch, and dinner meal portions provide in total 75% or less of a daily recommended caloric intake for a subject. In another variation, the combination of the breakfast, lunch, and dinner meal portions provide 50% or less of a daily recommended caloric intake for a subject. Further exemplary modifications are directed to the combination of the breakfast, lunch, and dinner meal portions providing 25% or less of a daily recommended caloric intake for a subject.

In a refinement, the one-day fast FMD package 200 is precisely formulated to provide between about 500 kcal and about 1500 kcal per package over the aggregate of the meal plan schedules and meal portions described herein. Further variations are directed to the one-day fast FMD package 200 formulated precisely to contain between about 740 kcal and about 1140 kcal in aggregate per package. Modifications also include the one-day fast FMD package 200 precision engineered to have between 910 kcal and 945 kcal per package and in aggregate of the meal portions incorporated therein. Each of the many contemplated variations of formulations are contemplated for use with the various types of intermittent fasting and/or time-restricted fasting using the contemplated one-day FMD packages 200 described herein.

Other examples of one-day fast FMD packages or prior-described FMD packages include the combination of the breakfast, lunch, and dinner meal portions provide per package 200 and in aggregate at least about 50 grams of fat or at least about 30 grams of fat, carbohydrates including less than about 20 grams of sugar, and at least about 20 grams of protein. Variations are also contemplated wherein the combination of the breakfast, lunch, and dinner meal portions per package 200 provide in aggregate between about 50 grams and about 60 grams of fat, carbohydrates including between about 10 grams and about 20 grams of sugar, and between about 20 grams and about 30 grams of protein. Still other modifications include the combination of the breakfast, lunch, and dinner meal portions adapted to provide less than about 60 grams of fat, carbohydrates including less than about 20 grams of sugar, and less than about 30 grams of protein.

Combinations of the breakfast, lunch, and dinner meal portions also contemplate providing between 70% and 80% of a daily recommended fat intake for a subject, between 25% and 40% of a daily recommended sugar intake for the subject, and between 25 grams and 30 grams of protein. Modified versions of the one-day fast FMD package 200 may have the combination of the breakfast, lunch, and dinner meal portions formulated as described herein to provide less than 80% of a daily recommended fat intake for a subject, less than 40% of a daily recommended sugar intake for the subject, and less than about 30 grams of protein.

In a refinement, the one-day fast FMD package and constituent combination of the breakfast, lunch, and dinner meal portions 205, 210, 215 are consumed by a subject for only one day per week for at least 30 days, or four weeks, or a month, and for one-day per week over longer periods of time. In further refinements, the one-day-fast FMD packages 200 are consumed by a subject that fast intermittently and/or restricts eating to certain time periods while fasting before and after such FMD eating time periods. Other variations include the subject consuming the one-day fast FMD package 200 during two days per week, while eating normally during the preceding and/or subsequent 5 days of the week, which is sometimes referred to as a 5-2 fast (51).

Each of the various FMD packages, including the one-day fast FMD package, also contemplate various methods of use as described in more detail elsewhere herein. In a refinement, the FMD can also modified to be a low sodium diet that provides less than 1000 mg of sodium chloride per day. For further examples, the one-day fast FMD package may be utilized for a method for inducing differential effects on disease factors and markers associated with aging, which includes administering the one-day fast FMD package to a subject. In this method, the disease factors and marking are and/or may be insulin-like growth factor-1, blood glucose, systolic blood pressure, diastolic blood pressure cholesterol, CRP, triglycerides, or abdominal/visceral fats.

Other variations of methods are available and which use any of the variously described one-day FMD package arrangements, and may also be directed to promoting and inducing stem-cell based regeneration of multiple organs and systems. Here too, the method includes administering one of the exemplary, one-day fast FMD packages to a subject in need thereof. Also contemplated herein is a method of using the one-day fast FMD packages wherein the stem-cell based regeneration of multiple organs and systems includes neurogenesis, hematopoiesis, or promotion of pancreatic beta-cells.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

1. Healthline, https://www.healthline.com/health/ketonuria#causes, Noreen Iftikhar, M D.
2. C. Ward, “Ketone Body Metabolism”. Diapedia. https://web.archive.org/web/20181111193826/https://www.diapedia.org/metab olism-and-hormones/51040851169/ketone-body-metabolism. (2015).
3. Lori Laffel, “Ketone bodies: a review of physiology, pathophysiology and application of monitoring to diabetes”. Diabetes/Metabolism Research and Reviews. 15 (6): 412-426. (November 1999).
4. M. P. Mattson, K. Moehl, N. Ghena, M. Schmaedick, A. Cheng, “Intermittent metabolic switching, neuroplasticity and brain health”. Nature Reviews. Neuroscience. 19 (2): 63-80. (2018).
5. Eric C. Westman, Justin Tondt, Emily Maguire, William S. Yancy, “Implementing a low-carbohydrate, ketogenic diet to manage type 2 diabetes mellitus”. Expert Review of Endocrinology & Metabolism. 13 (5): 263-272. (15 Sep. 2018).
6. Ketogenic diet improves metabolic syndrome in multiple ways, https://www.diabetes.co.uk/news/2017/dec/ketogenic-diet-improves-metabolic-syndrome-in-multiple-ways-99064712.html, (18 Dec. 2017).
7. Victoria M.Gershuni, Stephanie L. Yan, Valentina Medici, “Nutritional Ketosis for Weight Management and Reversal of Metabolic Syndrome”. Current Nutrition Reports. 7 (3): 97-106. (20 Aug. 2018)/8.
8. K. G. Alberti et al., Harmonizing the metabolic syndrome: a joint interim statement of the International Diabetes Federation Task Force on Epidemiology and Prevention; National Heart, Lung, and Blood Institute; American Heart Association; World Heart Federation; International Atherosclerosis Society; and International Association for the Study of Obesity. Circulation 120, 1640 (Oct. 20, 2009).
9. E. S. Ford, W. H. Giles, W. H. Dietz, Prevalence of the metabolic syndrome among US adults: findings from the third National Health and Nutrition Examination Survey. Jama 287, 356 (Jan. 16, 2002).
10. A. S. Gami et al., Metabolic syndrome and risk of incident cardiovascular events and death: a systematic review and meta-analysis of longitudinal studies. Journal of the American College of Cardiology 49, 403 (Jan. 30, 2007).
11. I. Y. Choi et al., A Diet Mimicking Fasting Promotes Regeneration and Reduces Autoimmunity and Multiple Sclerosis Symptoms. Cell reports 15, 2136 (Jun. 7, 2016).
12. S. Brandhorst et al., A Periodic Diet that Mimics Fasting Promotes Multi-System Regeneration, Enhanced Cognitive Performance, and Healthspan. Cell metabolism 22, 86 (Jul. 7, 2015).
13. V. D. Longo, S. Panda, Fasting, Circadian Rhythms, and Time-Restricted Feeding in Healthy Lifespan. Cell metabolism 23, 1048 (Jun. 14, 2016).
14. A. J. Bruce-Keller, G. Umberger, R. McFall, M. P. Mattson, Food restriction reduces brain damage and improves behavioral outcome following excitotoxic and metabolic insults. Ann Neurol 45, 8 (January, 1999).
15. A. L. Hartman, J. E. Rubenstein, E. H. Kossoff, Intermittent fasting: a “new” historical strategy for controlling seizures? Epilepsy research 104, 275 (May, 2013).
16. H. Muller, F. W. de Toledo, K. L. Resch, Fasting followed by vegetarian diet in patients with rheumatoid arthritis: a systematic review. Scandinavian journal of rheumatology 30, 1 (2001).
17. V. D. Longo, M. P. Mattson, Fasting: Molecular Mechanisms and Clinical Applications. Cell metabolism 19, 181 (Feb. 4, 2014).
18. C.-W. Cheng et al., Prolonged Fasting Reduces IGF-1/PKA to Promote Hematopoietic-Stem-Cell-Based Regeneration and Reverse Immunosuppression. Cell Stem Cell 14, 810 (6/5/2014).
19. W. E. Sonntag et al., Pleiotropic effects of growth hormone and insulin-like growth factor (IGF)-1 on biological aging: inferences from moderate caloric-restricted animals. The journals of gerontology. Series A, Biological sciences and medical sciences 54, B521 (December, 1999).
20. Y. Ikeno, R. T. Bronson, G. B. Hubbard, S. Lee, A. Bartke, Delayed occurrence of fatal neoplastic diseases in ames dwarf mice: correlation to extended longevity. The journals of gerontology. Series A, Biological sciences and medical sciences 58, 291 (April, 2003).
21. K. Flurkey, J. Papaconstantinou, R. A. Miller, D. E. Harrison, Lifespan extension and delayed immune and collagen aging in mutant mice with defects in growth hormone production. Proceedings of the National Academy of Sciences of the United States of America 98, 6736 (Jun. 5, 2001).
22. S. E. Dunn et al., Dietary restriction reduces insulin-like growth factor 1 levels, which modulates apoptosis, cell proliferation, and tumor progression in p53-deficient mice. Cancer research 57, 4667 (Nov. 1, 1997).
23. M. S. Bonkowski et al., Disruption of growth hormone receptor prevents calorie restriction from improving insulin action and longevity. PloS one 4, e4567 (2009).
24. M. E. Levine et al., Low protein intake is associated with a major reduction in IGF-1, cancer, and overall mortality in the 65 and younger but not older population. Cell metabolism 19, 407 (Mar. 4, 2014).
25. J. Guevara-Aguirre et al., Growth hormone receptor deficiency is associated with a major reduction in pro-aging signaling, cancer, and diabetes in humans. Sci Transl Med 3, 70ra13 (Feb. 16, 2011).
26. M. W. Gillman, Developmental origins of health and disease. The New England journal of medicine 353, 1848 (Oct. 27, 2005).
27. L. Fontana, B. K. Kennedy, V. D. Longo, D. Seals, S. Melov, Medical research: treat ageing. Nature 511, 405 (Jul. 24, 2014).
28. M. Nayor, R. S. Vasan, Recent Update to the US Cholesterol Treatment Guidelines: A Comparison With International Guidelines. Circulation 133, 1795 (May 3, 2016).
29. Diagnosis and classification of diabetes mellitus. Diabetes care 37 Suppl 1, S81 (January, 2014).
30. M. Miller et al., Triglycerides and cardiovascular disease: a scientific statement from the American Heart Association. Circulation 123, 2292 (May 24, 2011).
31. T. A. Pearson et al., Markers of inflammation and cardiovascular disease: application to clinical and public health practice: A statement for healthcare professionals from the Centers for Disease Control and Prevention and the American Heart Association. Circulation 107, 499 (Jan. 28, 2003).
32. M. N. Pollack, Insulin, insulin-like growth factors, insulin resistance, and neoplasia. The American journal of clinical nutrition 86, s820 (September, 2007).
33. M. E. Levine, Modeling the rate of senescence: can estimated biological age predict mortality more accurately than chronological age? The journals of gerontology. Series A, Biological sciences and medical sciences 68, 667 (June, 2013).
34. L. Fontana, L. Partridge, V. D. Longo, Extending healthy life span—from yeast to humans. Science 328, 321 (Apr. 16, 2010).
35. S. Brandhorst, M. Wei, S. Hwang, T. E. Morgan, V. D. Longo, Short-term calorie and protein restriction provide partial protection from chemotoxicity but do not delay glioma progression. Experimental gerontology, (Feb. 21, 2013).
36. A. G. Renehan et al., Insulin-like growth factor (IGF)-1, IGF binding protein-3, and cancer risk: systematic review and meta-regression analysis. Lancet 363, 1346 (Apr. 24, 2004).
37. J. M. Chan et al., Insulin-like growth factor-1 (IGF-1) and IGF binding protein-3 as predictors of advanced-stage prostate cancer. Journal of the National Cancer Institute 94, 1099 (Jul. 17, 2002).
38. N. E. Allen et al., A prospective study of serum insulin-like growth factor-1 (IGF-I), IGF-II, IGF-binding protein-3 and breast cancer risk. British journal of cancer 92, 1283 (Apr. 11, 2005).
39. O. Fletcher et al., Polymorphisms and circulating levels in the insulin-like growth factor system and risk of breast cancer: a systematic review. Cancer epidemiology, biomarkers & prevention: a publication of the American Association for Cancer Research, cosponsored by the American Society of Preventive Oncology 14, 2 (January, 2005).
40. K. Rapp et al., Fasting blood glucose and cancer risk in a cohort of more than 140,000 adults in Austria. Diabetologia 49, 945 (May, 2006).
41. T. Stocks et al., Blood glucose and risk of incident and fatal cancer in the metabolic syndrome and cancer project (me-can): analysis of six prospective cohorts. PLoS Med 6, e1000201 (December, 2009).
42. M. N. Harvie et al., The effects of intermittent or continuous energy restriction on weight loss and metabolic disease risk markers: a randomized trial in young overweight women. International journal of obesity 35, 714 (May, 2011).
43. L. Fontana, E. P. Weiss, D. T. Villareal, S. Klein, J. O. Holloszy, Long-term effects of calorie or protein restriction on serum IGF-1 and IGFBP-3 concentration in humans. Aging cell 7, 681 (October, 2008).
44. R. D. Hays et al., The impact of patient adherence on health outcomes for patients with chronic disease in the Medical Outcomes Study. Journal of behavioral medicine 17, 347 (August, 1994).
45. T. P. Wycherley et al., A high-protein diet with resistance exercise training improves weight loss and body composition in overweight and obese patients with type 2 diabetes. Diabetes care 33, 969 (May, 2010).
46. D. Florakis et al., Effect of hypocaloric diet plus sibutramine treatment on hormonal and metabolic features in overweight and obese women with polycystic ovary syndrome: a randomized, 24-week study. International journal of obesity 32, 692 (April, 2008).
47. M. Harvie et al., The effect of intermittent energy and carbohydrate restriction v. daily energy restriction on weight loss and metabolic disease risk markers in overweight women. The British journal of nutrition 110, 1534 (October, 2013).
48. G. Brabant et al., Serum insulin-like growth factor 1 reference values for an automated chemiluminescence immunoassay system: results from a multicenter study. Hormone research 60, 53 (2003).
49. www.census.gov
50. C. Patikorn et al., Intermittent Fasting and Obesity-Related Health Outcomes, An Umbrella Review of Meta-analyses of Randomized Clinical Trials. JAMA Network Open 2021; 4 (12:e2139558 (Dec. 17, 2021).
51. P. Hajek et al., A Randomized Controlled Trial of the 5:2 Diet. PLOS ONE16(11):e0258853 (Nov. 17, 2021).
52. R. Schithel et al., Effects of intermittent and continuous calorie restriction on body weight and metabolism over 50 wk: a randomized controlled trial. American J. Clinical Nutrition 2018; 108:933-945 (2018).

1. A fasting mimicking diet package providing breakfast, lunch, and dinner meal portions for a one-day fast, the fasting mimicking diet package comprising:
a breakfast meal portion that includes a first nut-containing nutrition bar composition, a micronutritional vegetable powder composition including vitamin and mineral supplements, and an algal oil composition;
a lunch meal portion that includes a first soup composition and a kale cracker composition; and
a dinner meal portion including a second soup composition, one of either the kale cracker composition or an olive containing composition, and a second nut containing nutrition bar composition.

2. A fasting mimicking diet package according to claim 1 that further includes tea compositions that each include at least one of lemon, hibiscus, and spearmint.

3. A fasting mimicking diet package according to claim 1 wherein:
the first nut-containing nutrition bar composition contains almonds, macadamias, and pecans; and
the algal oil composition includes DHA Omega-3 fatty acid and at least one of aurantiochytrium and schizocatrium algae oil.

4. A fasting mimicking diet package according to claim 1 wherein:
the second nut-containing nutrition bar composition contains inulin, almonds, almond butter, brown rice crispy, cocoa powder, chocolate chips, rolled oats, flaxseed oil, rice dextrin, grape juice, and salt.

5. A fasting mimicking diet package according to claim 1 wherein:
the second nut-containing nutrition bar composition is sized with a portion size that is half of the first nut containing nutrition bar composition and includes almonds, macadamias, pecans, honey, flaxseed, coconut flour, and rosemary extract.

6. A fasting mimicking diet package according to claim 1 wherein:
the nut-containing nutrition bar compositions contain almonds, macadamias, and pecans; and
also contains honey, flaxseed, coconut flour, and rosemary extract.

7. A fasting mimicking diet package according to claim 1 wherein:
the nut-containing nutrition bar compositions contain almonds, macadamias, and pecans; and
one or more of chicory root fiber, tocopherols, acai, blueberries, cacao nibs, cocoa powder, raspberries, strawberries, and lemon juice.

8. A fasting mimicking diet package according to claim 1 wherein:
the micronutritional vegetable powder with vitamin and mineral supplements composition contains Vit A, Vit C, Ca, Fe, Vit D3, Vit E, Vit K, Vit B1, Vit B2, Vit B3, Vit B5, Vit B6, Vit B7, Vit B9, Vit B12, Cr, Cu, I, Mg, Mn, Mo, Se, and Zn.

9. A fasting mimicking diet package according to claim 1 wherein:
the micronutritional vegetable powder with vitamin and mineral supplements composition contains ascorbic acid, beet root powder, beta carotene, calcium carbonate, carrots, cholecaliciferol, chromium picolinate, collard leaf powder, cupric sulfate, cyanocobalamin, Dl-alpha tocopherol acetate, ferrous fumarate, folic acid, kale leaf, magnesium stearate, manganese sulfate, niacinamide, pantothenic acid, phytonadione, potassium iodine, pyriodoxine HCl, riboflavin, sodium molybdate, sodium selenate, spinach, thiamine mononitrate, tomatoes, tribasic calcium phosphate, and zinc oxide.

10. A fasting mimicking diet package according to claim 1 wherein:
the micronutritional vegetable powder with vitamin and mineral supplements composition includes Vit A, Vit C, Vit D, Vit E, Vit K1, Vit B1, Vit B2, Vit B3, Vit B6, Vit B12, folic acid, biotin, pantothenic acid, calcium, iron, iodine, magnesium, zinc, selenium, copper, manganese, chromium, molybdenum, kale leaves, beet root, carrot root, spinach leaves, and tomato.

11. A fasting mimicking diet package according to claim 1 wherein:
the kale cracker composition includes almonds, kale, sesame seeds, and tapioca flour.

12. A fasting mimicking diet package according to claim 1 wherein:
the kale cracker composition includes almonds, kale, sesame seeds, tapioca flour, chia seeds, flax seeds, sunflower oil, salt, coconut sugar and vinegar, onion, chili pepper, cumin seed, black pepper, garlic, tocopherols, oregano, and citric acid.

13. A fasting mimicking diet package according to claim 1 wherein:
the first and second soup compositions include rice flour, chicory root fiber, onion, olive oil, and yeast extract.

14. A fasting mimicking diet package according to claim 1 wherein:
the first and second soup compositions include rice flour, chicory root fiber, onion, olive oil, salt, and yeast extract; and
one or more of basil, parsley, whole grain brown rice, sweet red peppers, leeks, spinach, cabbage, tomato, celery, turmeric, quinoa, potato flakes, peas, carrots, zucchini squash, broccoli, celery seeds, mushroom powder, white beans, black beans, garlic, coriander, oregano, butternut squash, and chives.

15. A fasting mimicking diet package according to claim 1 wherein:
the first and second soup compositions each include rice flour, chicory root fiber, onion, olive oil, salt, and yeast extract; and
wherein each of the soup compositions include one of:
mushroom soup constituents that include parsley, whole grain brown rice, rice flour, carrots, and mushroom powder;
tomato soup constituents that include tomato, basil, parsley, and whole grain brown rice;
vegetable soup constituents that include basil, parsley, whole grain brown rice, sweet red peppers, leeks, spinach, tomato, and carrots;
minestrone soup constituents that include parsley, leeks, spinach, cabbage, tomato, celery, turmeric, potato flakes, peas, carrots, and white beans;
minestrone soup constituents that include quinoa, basil, parsley, whole grain brown rice, leeks, spinach, cabbage, tomato, celery, turmeric, potato flakes, peas, carrots, zucchini squash, broccoli, celery seeds, garlic;
white bean and spinach soup constituents that include whole grain brown rice, spinach, celery, white beans, and garlic;
black bean soup constituents that include whole grain brown rice, black beans, garlic, coriander, and oregano;
butternut squash soup constituents that include whole grain brown rice, carrots, butternut squash, and chives; and
butternut squash and quinoa soup constituents that include whole grain brown rice, quinoa, butternut squash, garlic, and chives.

16. The fasting mimicking diet package of claim 1 wherein the combination of the breakfast, lunch, and dinner meal portions provide in total 75% or less of a daily recommended caloric intake for a subject.

17. The fasting mimicking diet package of claim 1 wherein the combination of the breakfast, lunch, and dinner meal portions provide 50% or less of a daily recommended caloric intake for a subject.

18. The fasting mimicking diet package of claim 1 wherein the combination of the breakfast, lunch, and dinner meal portions provide 25% or less of a daily recommended caloric intake for a subject.

19. The fasting mimicking diet package of claim 1 wherein the combination of the breakfast, lunch, and dinner meal portions provide at least 50 grams of fat, less than 20 grams of sugar, and at least 20 grams of protein.

20. The fasting mimicking diet package of claim 1 wherein the combination of the breakfast, lunch, and dinner meal portions provide between 50 grams and 60 grams of fat, between 10 grams and 20 grams of sugar, and between 20 grams and 30 grams of protein.

21. The fasting mimicking diet package of claim 1 wherein the combination of the breakfast, lunch, and dinner meal portions provide less than 60 grams of fat, less than 20 grams of sugar, and less than 30 grams of protein.

22. The fasting mimicking diet package of claim 1 wherein the combination of the breakfast, lunch, and dinner meal portions provide between 70% and 80% of a daily recommended fat intake for a subject, between 25% and 40% of a daily recommended sugar intake for the subject, and between 25 grams and 30 grams of protein.

23. The fasting mimicking diet package of claim 1 wherein the combination of the breakfast, lunch, and dinner meal portions provide less than 80% of a daily recommended fat intake for a subject, less than 40% of a daily recommended sugar intake for the subject, and less than 30 grams of protein.

24. The fasting mimicking diet package of claim 1 wherein the combination of the breakfast, lunch, and dinner meal portions are provided to a subject during at least one time period of: (a) an intermittent fast during a 24-hour timespan, (b) one day per week for four weeks, and (c) a 5-2 fast.

25. A method for inducing differential effects on disease factors and markers associated with aging, the method comprising administering the fast mimicking diet of claim 1 to a subject in need thereof.

26. The method of claim 25 wherein the disease factors and marking are insulin-like growth factor-1, blood glucose, systolic blood pressure, diastolic blood pressure cholesterol, CRP, triglycerides, or abdominal/visceral fats.

27. A method for promoting and inducing stem-cell based regeneration of multiple organs and systems, the method comprising administering the fast mimicking diet of claim 1 to a subject in need thereof.

28. The method of claim 27 wherein the stem-cell based regeneration of multiple organs and systems includes neurogenesis, hematopoiesis, or promotion of pancreatic beta-cells.

29. A fasting mimicking diet package providing meal portions for a one-day fast, the fasting mimicking diet package comprising:
a first nut-containing nutrition bar composition;
a micronutritional vegetable powder composition including vitamin and mineral supplements;
an algal oil composition;
a first soup composition;
a kale cracker composition;
a second soup composition;
an olive containing composition; and
a second nut-containing nutrition bar composition.

30. A fasting mimicking diet package according to claim 29 that further includes tea compositions that each include at least one of lemon, hibiscus, and spearmint.

31. A fasting mimicking diet package according to claim 29 wherein:
the first nut-containing nutrition bar composition contains almonds, macadamias, and pecans; and
the algal oil composition includes DHA Omega-3 fatty acid and at least one of aurantiochytrium and schizocatrium algae oil.

32. A fasting mimicking diet package according to claim 29 wherein:
the second nut-containing nutrition bar composition contains inulin, almonds, almond butter, brown rice crispy, cocoa powder, chocolate chips, rolled oats, flaxseed oil, rice dextrin, grape juice, and salt.

33. A fasting mimicking diet package according to claim 29 wherein:
the second nut-containing nutrition bar composition is sized with a portion size that is half of the first nut-containing nutrition bar and includes almonds, macadamias, pecans, honey, flaxseed, coconut flour, and rosemary extract.

34. A fasting mimicking diet package according to claim 29 wherein:
the nut-containing nutrition bar compositions contain almonds, macadamias, and pecans; and
also contains honey, flaxseed, coconut flour, and rosemary extract.

35. A fasting mimicking diet package according to claim 29 wherein:
the nut-containing nutrition bar compositions contain almonds, macadamias, and pecans; and
one or more of chicory root fiber, tocopherols, acai, blueberries, cacao nibs, cocoa powder, raspberries, strawberries, and lemon juice.

36. A fasting mimicking diet package according to claim 29 wherein:
the micronutritional vegetable powder with vitamin and mineral supplements composition contains Vit A, Vit C, Ca, Fe, Vit D3, Vit E, Vit K, Vit B1, Vit B2, Vit B3, Vit B5, Vit B6, Vit B7, Vit B9, Vit B12, Cr, Cu, I, Mg, Mn, Mo, Se, and Zn.

37. A fasting mimicking diet package according to claim 29 wherein:
the micronutritional vegetable powder with vitamin and mineral supplements composition contains ascorbic acid, beet root powder, beta carotene, calcium carbonate, carrots, cholecaliciferol, chromium picolinate, collard leaf powder, cupric sulfate, cyanocobalamin, Dl-alpha tocopherol acetate, ferrous fumarate, folic acid, kale leaf, magnesium stearate, manganese sulfate, niacinamide, pantothenic acid, phytonadione, potassium iodine, pyriodoxine HCl, riboflavin, sodium molybdate, sodium selenate, spinach, thiamine mononitrate, tomatoes, tribasic calcium phosphate, and zinc oxide.

38. A fasting mimicking diet package according to claim 29 wherein:
the micronutritional vegetable powder with vitamin and mineral supplements composition includes Vit A, Vit C, Vit D, Vit E, Vit K1, Vit B1, Vit B2, Vit B3, Vit B6, Vit B12, folic acid, biotin, pantothenic acid, calcium, iron, iodine, magnesium, zinc, selenium, copper, manganese, chromium, molybdenum, kale leaves, beet root, carrot root, spinach leaves, and tomato.

39. A fasting mimicking diet package according to claim 29 wherein:
the kale cracker composition includes almonds, kale, sesame seeds, and tapioca flour.

40. A fasting mimicking diet package according to claim 29 wherein:
the kale cracker composition includes almonds, kale, sesame seeds, tapioca flour, chia seeds, flax seeds, sunflower oil, salt, coconut sugar and vinegar, onion, chili pepper, cumin seed, black pepper, garlic, tocopherols, oregano, and citric acid.

41. A fasting mimicking diet package according to claim 29 wherein:
the first and second soup compositions include rice flour, chicory root fiber, onion, olive oil, and yeast extract.

42. A fasting mimicking diet package according to claim 29 wherein:
the first and second soup compositions include rice flour, chicory root fiber, onion, olive oil, salt, and yeast extract; and
one or more of basil, parsley, whole grain brown rice, sweet red peppers, leeks, spinach, cabbage, tomato, celery, turmeric, quinoa, potato flakes, peas, carrots, zucchini squash, broccoli, celery seeds, mushroom powder, white beans, black beans, garlic, coriander, oregano, butternut squash, and chives.

43. A fasting mimicking diet package according to claim 29 wherein:
the first and second soup compositions each include rice flour, chicory root fiber, onion, olive oil, salt, and yeast extract; and
wherein each of the first and second soup compositions include one of:
mushroom soup constituents that include parsley, whole grain brown rice, rice flour, carrots, and mushroom powder;
tomato soup constituents that include tomato, basil, parsley, and whole grain brown rice;
vegetable soup constituents that include basil, parsley, whole grain brown rice, sweet red peppers, leeks, spinach, tomato, and carrots;
minestrone soup constituents that include parsley, leeks, spinach, cabbage, tomato, celery, turmeric, potato flakes, peas, carrots, and white beans;
minestrone soup constituents that include quinoa, basil, parsley, whole grain brown rice, leeks, spinach, cabbage, tomato, celery, turmeric, potato flakes, peas, carrots, zucchini squash, broccoli, celery seeds, garlic;
white bean and spinach soup constituents that include whole grain brown rice, spinach, celery, white beans, and garlic;
black bean soup constituents that include whole grain brown rice, black beans, garlic, coriander, and oregano;
butternut squash soup constituents that include whole grain brown rice, carrots, butternut squash, and chives; and
butternut squash and quinoa soup constituents that include whole grain brown rice, quinoa, butternut squash, garlic, and chives.

44. The fasting mimicking diet package of claim 29 wherein the combination of the meal portions provide in total 75% or less of a daily recommended caloric intake for a subject.

45. The fasting mimicking diet package of claim 29 wherein the combination of the meal portions provide 50% or less of a daily recommended caloric intake for a subject.

46. The fasting mimicking diet package of claim 29 wherein the combination of the meal portions provide 25% or less of a daily recommended caloric intake for a subject.

47. The fasting mimicking diet package of claim 29 wherein the combination of the meal portions provide at least 50 grams of fat, less than 20 grams of sugar, and at least 20 grams of protein.

48. The fasting mimicking diet package of claim 29 wherein the combination of the meal portions provide between 50 grams and 60 grams of fat, between 10 grams and 20 grams of sugar, and between 20 grams and 30 grams of protein.

49. The fasting mimicking diet package of claim 29 wherein the combination of the meal portions provide less than 60 grams of fat, less than 20 grams of sugar, and less than 30 grams of protein.

50. The fasting mimicking diet package of claim 29 wherein the combination of the meal portions provide between 70% and 80% of a daily recommended fat intake for a subject, between 25% and 40% of a daily recommended sugar intake for the subject, and between 25 grams and 30 grams of protein.

51. The fasting mimicking diet package of claim 29 wherein the combination of the meal portions provide less than 80% of a daily recommended fat intake for a subject, less than 40% of a daily recommended sugar intake for the subject, and less than 30 grams of protein.

52. The fasting mimicking diet package of claim 29 wherein the combination of the meal portions are provided to a subject during at least one time period of: (a) an intermittent fast during a 24-hour timespan, (b) one day per week for four weeks, and (c) a 5-2 fast. (ORIGINAL)

53. A method for inducing differential effects on disease factors and markers associated with aging, the method comprising administering the fast mimicking diet of claim 29 to a subject in need thereof.

54. The method of claim 53 wherein the disease factors and marking are insulin-like growth factor-1, blood glucose, systolic blood pressure, diastolic blood pressure cholesterol, CRP, triglycerides, or abdominal/visceral fats.

55. A method for promoting and inducing stem-cell based regeneration of multiple organs and systems, the method comprising administering the fast mimicking diet of claim 29 to a subject in need thereof.

56. The method of claim 55 wherein the stem-cell based regeneration of multiple organs and systems includes neurogenesis, hematopoiesis, or promotion of pancreatic beta-cells.

57. A fasting mimicking diet package providing breakfast, lunch, and dinner meal portions for a one-day fast, the fasting mimicking diet package comprising:
a first nut-containing nutrition bar composition;
a micronutritional vegetable powder composition including vitamin and mineral supplements;
an algal oil composition;
a first soup composition;
a kale cracker composition;
a second soup composition;
an olive containing composition;
a second nut-containing nutrition bar composition; and
wherein predetermined compositions are grouped into one or more of a breakfast, a lunch, and a dinner meal portion.

58. A fasting mimicking diet package according to claim 57 that further includes tea compositions that each include at least one of lemon, hibiscus, and spearmint.

59. A fasting mimicking diet package according to claim 57 wherein:
the first nut-containing nutrition bar composition contains almonds, macadamias, and pecans; and
the algal oil composition includes DHA Omega-3 fatty acid and at least one of aurantiochytrium and schizocatrium algae oil.

60. A fasting mimicking diet package according to claim 57 wherein:
the second nut-containing nutrition bar composition contains inulin, almonds, almond butter, brown rice crispy, cocoa powder, chocolate chips, rolled oats, flaxseed oil, rice dextrin, grape juice, and salt.

61. A fasting mimicking diet package according to claim 57 wherein:
the second nut-containing nutrition bar composition is sized with a portion size that is half of the first nut-containing nutrition bar and includes almonds, macadamias, pecans, honey, flaxseed, coconut flour, and rosemary extract.

62. A fasting mimicking diet package according to claim 57 wherein:
the nut-containing nutrition bar compositions contain almonds, macadamias, and pecans; and
also contains honey, flaxseed, coconut flour, and rosemary extract.

63. A fasting mimicking diet package according to claim 57 wherein:
the nut-containing nutrition bar compositions contain almonds, macadamias, and pecans; and
one or more of chicory root fiber, tocopherols, acai, blueberries, cacao nibs, cocoa powder, raspberries, strawberries, and lemon juice.

64. A fasting mimicking diet package according to claim 57 wherein:
the micronutritional vegetable powder with vitamin and mineral supplements composition contains Vit A, Vit C, Ca, Fe, Vit D3, Vit E, Vit K, Vit B1, Vit B2, Vit B3, Vit B5, Vit B6, Vit B7, Vit B9, Vit B12, Cr, Cu, I, Mg, Mn, Mo, Se, and Zn.

65. A fasting mimicking diet package according to claim 57 wherein:
the micronutritional vegetable powder with vitamin and mineral supplements composition contains ascorbic acid, beet root powder, beta carotene, calcium carbonate, carrots, cholecaliciferol, chromium picolinate, collard leaf powder, cupric sulfate, cyanocobalamin, Dl-alpha tocopherol acetate, ferrous fumarate, folic acid, kale leaf, magnesium stearate, manganese sulfate, niacinamide, pantothenic acid, phytonadione, potassium iodine, pyriodoxine HCl, riboflavin, sodium molybdate, sodium selenate, spinach, thiamine mononitrate, tomatoes, tribasic calcium phosphate, and zinc oxide.

66. A fasting mimicking diet package according to claim 57 wherein:
the micronutritional vegetable powder with vitamin and mineral supplements composition includes Vit A, Vit C, Vit D, Vit E, Vit K1, Vit B1, Vit B2, Vit B3, Vit B6, Vit B12, folic acid, biotin, pantothenic acid, calcium, iron, iodine, magnesium, zinc, selenium, copper, manganese, chromium, molybdenum, kale leaves, beet root, carrot root, spinach leaves, and tomato.

67. A fasting mimicking diet package according to claim 57 wherein:
the kale cracker composition includes almonds, kale, sesame seeds, and tapioca flour.

68. A fasting mimicking diet package according to claim 57 wherein:
the kale cracker composition includes almonds, kale, sesame seeds, tapioca flour, chia seeds, flax seeds, sunflower oil, salt, coconut sugar and vinegar, onion, chili pepper, cumin seed, black pepper, garlic, tocopherols, oregano, and citric acid.

69. A fasting mimicking diet package according to claim 57 wherein:
the first and second soup compositions include rice flour, chicory root fiber, onion, olive oil, and yeast extract.

70. A fasting mimicking diet package according to claim 57 wherein:
the first and second soup compositions include rice flour, chicory root fiber, onion, olive oil, salt, and yeast extract; and
one or more of basil, parsley, whole grain brown rice, sweet red peppers, leeks, spinach, cabbage, tomato, celery, turmeric, quinoa, potato flakes, peas, carrots, zucchini squash, broccoli, celery seeds, mushroom powder, white beans, black beans, garlic, coriander, oregano, butternut squash, and chives.

71. A fasting mimicking diet package according to claim 57 wherein:
the first and second soup compositions each include rice flour, chicory root fiber, onion, olive oil, salt, and yeast extract; and
wherein each of the soup compositions include one of:
mushroom soup constituents that include parsley, whole grain brown rice, rice flour, carrots, and mushroom powder;
tomato soup constituents that include tomato, basil, parsley, and whole grain brown rice;
vegetable soup constituents that include basil, parsley, whole grain brown rice, sweet red peppers, leeks, spinach, tomato, and carrots;
minestrone soup constituents that include parsley, leeks, spinach, cabbage, tomato, celery, turmeric, potato flakes, peas, carrots, and white beans;
minestrone soup constituents that include quinoa, basil, parsley, whole grain brown rice, leeks, spinach, cabbage, tomato, celery, turmeric, potato flakes, peas, carrots, zucchini squash, broccoli, celery seeds, garlic;
white bean and spinach soup constituents that include whole grain brown rice, spinach, celery, white beans, and garlic;
black bean soup constituents that include whole grain brown rice, black beans, garlic, coriander, and oregano;
butternut squash soup constituents that include whole grain brown rice, carrots, butternut squash, and chives; and
butternut squash and quinoa soup constituents that include whole grain brown rice, quinoa, butternut squash, garlic, and chives.

72. The fasting mimicking diet package of claim 57 wherein the combination of the breakfast, lunch, and dinner meal portions provide in total 75% or less of a daily recommended caloric intake for a subject.

73. The fasting mimicking diet package of claim 57 wherein the combination of the breakfast, lunch, and dinner meal portions provide 50% or less of a daily recommended caloric intake for a subject.

74. The fasting mimicking diet package of claim 57 wherein the combination of the breakfast, lunch, and dinner meal portions provide 25% or less of a daily recommended caloric intake for a subject.

75. The fasting mimicking diet package of claim 57 wherein the combination of the breakfast, lunch, and dinner meal portions provide at least 50 grams of fat, less than 20 grams of sugar, and at least 20 grams of protein.

76. The fasting mimicking diet package of claim 57 wherein the combination of the breakfast, lunch, and dinner meal portions provide between 50 grams and 60 grams of fat, between 10 grams and 20 grams of sugar, and between 20 grams and 30 grams of protein.

77. The fasting mimicking diet package of claim 57 wherein the combination of the breakfast, lunch, and dinner meal portions provide less than 60 grams of fat, less than 20 grams of sugar, and less than 30 grams of protein.

78. The fasting mimicking diet package of claim 57 wherein the combination of the breakfast, lunch, and dinner meal portions provide between 70% and 80% of a daily recommended fat intake for a subject, between 25% and 40% of a daily recommended sugar intake for the subject, and between 25 grams and 30 grams of protein.

79. The fasting mimicking diet package of claim 57 wherein the combination of the breakfast, lunch, and dinner meal portions provide less than 80% of a daily recommended fat intake for a subject, less than 40% of a daily recommended sugar intake for the subject, and less than 30 grams of protein.

80. The fasting mimicking diet package of claim 57 wherein the combination of the breakfast, lunch, and dinner meal portions are provided to a subject during at least one time period of: (a) an intermittent fast during a 24-hour timespan, (b) one day per week for four weeks, and (c) a 5-2 fast.

81. A method for inducing differential effects on disease factors and markers associated with aging, the method comprising administering the fast mimicking diet of claim 57 to a subject in need thereof.

82. The method of claim 81 wherein the disease factors and marking are insulin-like growth factor-1, blood glucose, systolic blood pressure, diastolic blood pressure cholesterol, CRP, triglycerides, or abdominal/visceral fats.

83. A method for promoting and inducing stem-cell based regeneration of multiple organs and systems, the method comprising administering the fast mimicking diet of claim 57 to a subject in need thereof.

84. The method of claim 83 wherein the stem-cell based regeneration of multiple organs and systems includes neurogenesis, hematopoiesis, or promotion of pancreatic beta-cells.
